(19) United States
(12) Patent Application Publication
(10) Pub. No.: US 2003/0190565 A1
(43) Pub. Date: Oct. 9, 2003

(54) Heat developable image recording material

(76) Inventors: Itsuo Fujiwara, Kanagawa (JP); Seiichi Yamamoto, Kanagawa (JP); Takayoshi Oyamada, Kanagawa (JP)

Correspondence Address: Michael P. Eddy, Apartment #412-North, 2111 Jefferson Davis Highway, Arlington, VA, 22202, US

(21) Appl. No.: 10/278,777

(22) Filed: Oct. 24, 2002

(30) Foreign Application Priority Data
Oct. 26, 2001 (JP) 2001-329077
Feb. 7, 2002 (JP) 2002-31097

(51) Int. Cl. G03C 1/34; G03C 1/498

(52) U.S. Cl. 430/610; 430/620; 430/614; 430/611

(57) ABSTRACT

A heat developable image recording material including a photosensitive silver halide, a reducing agent for silver ions, a binder and non-photosensitive organic acid silver salt particles on one side of the surface of a substrate. A content of silver behenate in the non-photosensitive organic acid silver salt particles is 90 mol % to 100 mol %, and at least one kind of mercapto compound is contained in a surface of the substrate at the same side as a layer having the photosensitive silver halide. The heat developable image recording material includes a compound represented by following the general formula (1) wherein, R²¹, R²² and R²³ each independently represent a substituted or non-substituted alkyl group. When R21, R²² or R²³ have a substituent, the substituent is a halogen atom etc. The non-photosensitive organic particles are prepared from organic acids including at least behenic acid and erucic acid, and a content of the erucic acid is 0.000001 mol % to 0.4 mol %.

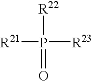

### BACKGROUND OF THE INVENTION

1. Field of the Invention

The present invention relates to a heat developable photosensitive image recording material (simply referred to as a heat developable photosensitive material hereinafter).

2. Description of the Related Art

Reduction of the amount of waste after development and fixing of films for medical diagnostics and photographic printing has been strongly demanded in recent years in view of environmental preservation and for saving work spaces. Accordingly, technologies related to heat developable photosensitive materials are urgently required for providing films for medical diagnosis and photographic printing, by which efficient exposure is possible using a laser image setter or laser imager to form clear images with high resolution and sharpness. No liquid chemicals are needed for development and fixing when the heat developable photosensitive material is used, making it possible to supply to customers a heat development system that is more simple and friendly to the environment.

While similar advantages are required for general purpose image forming materials, cold black-tone images are particularly preferred as images for use in medical diagnosis considering suitability for easy diagnosis, since a high image quality with excellent sharpness and granular properties is necessary for attaining required fine depiction. Although various hard copy systems taking advantage of pigments and dyes, such as ink-jet printers and electrophotographic systems, are commercially available today, none of them are satisfactory as output systems for obtaining medical images.

Examples of such heat image forming systems are disclosed in U.S. Pat. Nos. 3,152,904 and 3,457,075, and described in “Thermally Processed Silver Systems”, Imaging Processes and Materials, Neblette Vol. 8, ed. by J. Sturge, V. Walworth and A. Shepp, Capter 9, p. 279, 1989. Generally speaking, the heat developable photosensitive material comprises a photosensitive layer in which a catalytic activity amount of photocatalyst (for example, silver halide), a reducing agent, a silver salt capable of being reduced (for example, an organic silver salt) and if necessary, a chromatone controlling agent that controls tone of silver, are dispersed in a binder matrix. The heat developable photosensitive material is heated at a high temperature (for example, 80° C.) after image exposure, and a black silver image is formed by an oxidation-reduction reaction between the silver salt capable of being reduced (functions as an oxidizing agent) and a reducing agent. The oxidation-reduction reaction is accelerated by a catalytic action of latent images of silver halide generated by exposure. Consequently, the black silver image is formed in the exposed area. These procedures have been disclosed in many references such as U.S. Pat. No. 2,910,377 and Japanese Patent Application Publication (JP-B) No. 43-4924, and a medical image forming system named as Fuji Medical Dry Imager FM-DPL using the heat developable photosensitive material is sold.

As a characteristic of photosensitive silver halide, is featured in that, it is necessary to increase the number of the silver halide particles in order to increase the maximum density although silver halide serves as a initiation point in the heat development process. Accordingly, although it is necessary to reduce the size of the silver halide particle and increase the number of particles while compensating its sensitivity by applying chemical sensitization, it was a problem that preservative property of row photosensitive materials are deteriorated and sensitivity decreases during preservation.

Since organic silver halides or the like in the heat developable photosensitive material using the organic silver salt are not fixed, the organic silver salt has a potential to develop silver images even after forming the silver image by light/heat. Such excess images do not naturally appear under a usual condition of use. However, when the preservation conditions are very severe for the heat developable photosensitive material, for example when processed films are placed in a vehicle for transportation or the like in summer, troubles such as color changes throughout the film or transfer of characters printed on a bag as a container of the film onto the film may occur.

Furthermore, while increasing the content of silver behenate is described in Japanese Patent Application Laid-Open (JP-A) No. 11-271920, the preservative property of the images are desired to be further improved considering the shape of the particles described in the patent publication.

The method for producing the heat image forming system taking advantage of the organic silver salt include a method for applying a solution containing the organic silver salt, and a method for applying an application fluid containing an the organic silver salt and an aqueous dispersion of polymer fine particles as a main binder followed by drying. The production facilities become simple in the latter method since no step of solvent recovery or the like is required, and therefore the method is advantageous for mass-production.

However, the commercially available heat developable photosensitive materials involve the problem in the image preserving property that causes fogging by light and heat after development. Accordingly, the photosensitive materials are required be improved since they should be carefully handled not to be exposed to light and heat for a long period of time.

### SUMMARY OF THE INVENTION

Accordingly, an object of the present invention for solving the foregoing problems is to provide a heat developable image recording material having a high sensitivity and maximum density while being excellent in preservative property of raw materials.

Another object of the invention is to provide a heat developable photosensitive material having a low minimum density (Dₘᵢₙ) and being excellent in preservative property of images.

A further different object of the invention is to provide a heat developable photosensitive material that has small increment of fogging by light and heat after development, and does not require careful handling against light and heat, or that is excellent in the image preservation property.

The invention for achieving the above objects will be explained as follows.

In a first aspect, the invention is as follows.

1) A heat developable image recording material comprising a photosensitive silver halide, a reducing agent for silver ions, a binder and non-photosensitive organic silver salt particles on one side of the surface of a substrate, wherein the content of silver behenate in the non photosensitive organic silver salt particles is 90 mol % to 100 mol %, and at least one kind of mercapto compounds is contained in a surface of the substrate at the same side as a layer having photosensitive silver halide.

2) A heat developable image recording material, wherein at least one kind of the mercapto compounds may be contained in the layer containing the photosensitive silver halide.

3) A heat developable image recording material, wherein the mercapto compound is represented by the following general formula (1):

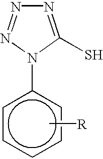

(in the general formula (1), R represents a hydrogen atom, an alkyl group, an aralkyl group, an alkoxy group, an alkyl or aryl substituted amino group, an amide group, a sulfonamide group, an ureide group, an urethane group, an aryloxy group, a sulfamoyl group, a carbamoyl group, an aryl group, an alkylthio group, an arylthio group, a hydroxyl group, an alkylcarbonyl group, a halogen atom, a cyano group or a phosphoramide group).

4) A heat developable image recording material, wherein the content of silver behenate in the non-photosensitive organic silver salt particles is 94 mol % to 100 mol %.

5) A heat developable image recording material, wherein the content of silver behenate in the non-photosensitive organic silver salt particles is 96 mol % to 100 mol %.

6) A heat developable image recording material, wherein the content of silver stearate in the non-photosensitive organic silver salt particles is 1 mol % or less.

7) A heat developable image recording material, wherein the content of silver arachidinate in the non-photosensitive organic silver salt particles is 6 mol % or less.

8) A heat developable image recording material, wherein the reducing agent for the silver ions is represented by the following general formula (2):

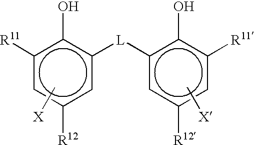

(in the general formula (2), R¹¹ and R^{11′} independently represent an alkyl group with a carbon number of 1 to 20; R¹² and R^{12′} independently represent a hydrogen atom or a substituent capable of substituting to a benzene ring; L represents a —S— group or —CHR¹³— group; R¹³ represents a hydrogen atom or an alkyl group with a carbon number of 1 to 20; and X and X′ independently represent a hydrogen atom or a substituent capable of substituting to a benzene ring).

9) A heat developable image recording material, wherein the non-photosensitive organic silver salt particles are prepared by adding a solution containing silver ions and a solution of an organic acid alkali metal salt or suspension thereof into sealed mixing means.

10) A heat developable image recording material, wherein the non-photosensitive organic silver salt particles are desalted by an ultrafiltration method.

In a second aspect, the invention is as follows.

11) A heat developable photosensitive material comprising at least one kind of photosensitive silver halide, a reducing agent for silver ions, a binder and non-photosensitive organic silver salt particles on one side of the surface of a substrate, wherein the content of silver behenate in the non-photosensitive organic silver salt particles is 90 mol % to 100 mol %, the photosensitive material comprising a compound represented by the following general formula (3):

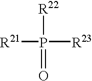

(in the general formula (3), R²¹, R²² and R²³ each independently represent a substituted or non-substituted alkyl group, aryl group, alkoxy group, aryloxy group, amino group or heterocyclic group; the substituent when R²¹, R²² and R²³ have the substituent comprises a halogen atom, an alkyl group, an aryl group, an alkoxy group, an amino group, an acyl group, an acyloxy group, an alkylthio group, an arylthio group, a sulfonamide group, an acyloxy group, an oxycarbonyl group, a carbamoyl group, a sulfamoyl group, a sulfonyl group or a phosphoryl group).

12) A heat developable photosensitive material, wherein the content of silver stearate in the non-photosensitive organic silver salt particles is 1 mol % or less.

13) A heat developable photosensitive material, wherein the content of silver arachidate in the non-photosensitive organic silver salt particles is 6 mol % or less.

14) A heat developable photosensitive material, wherein the content of silver behenate is 95 mol % to 100 mol %.

15) A heat developable photosensitive material, wherein the content of silver behenate is 97 mol % to 100 mol %.

16) A heat developable photosensitive material, wherein the non-photosensitive organic silver salt particles are prepared at a reaction temperature of 60° C. or less.

17) A heat developable photosensitive material, wherein the non-photosensitive organic acid silver salt particles are prepared by adding a silver nitrate solution, and a solution of an organic acid alkali metal salt or suspension thereof into a sealed mixing vessel.

18) A heat developable photosensitive material, wherein the non-photosensitive organic silver salt particles are desalted by an ultra-filtration method.

In a third aspect, the invention is as follows.

19) A heat developable photosensitive material comprising photosensitive silver halide, a reducing agent for silver ions, a binder and non-photosensitive organic silver salt particles on one side of the surface of a substrate, wherein the non-photosensitive organic silver salt particles are prepared from organic acids containing at least behenic acid and erucic acid, and the content of the erucic acid is 0.000001 mol % to 0.4 mol % relative to behenic acid.

20) A heat developable photosensitive material, wherein the content of the erucic acid is 0.00001 mol % to 0.1 mol % relative to behenic acid.

21) A heat developable photosensitive material, wherein the content of the behenic acid is 50 mol % to 99.99 mol % relative to the organic acids.

22) A heat developable photosensitive material, wherein the content of the behenic acid is 90 mol % to 99.99 mol % relative to the organic acids.

23) A heat developable photosensitive material, wherein the content of the behenic acid is 95 mol % to 99.99 mol % relative to the organic acids.

24) A heat developable photosensitive material, wherein the amount of silver contained in the heat developable photosensitive material is 0.1 g/m² to 5.0 g/m² as measured on the basis of an amount of silver atoms.

### BRIEF DESCRIPTION OF THE DRAWING

FIG. 1 shows one embodiment of an apparatus for producing non-photosensitive organic silver halide to be used in the present invention.

### DESCRIPTION OF THE PREFERRED EMBODIMENTS

A heat developable image recording material according to a first aspect of the invention will be described in detail hereinafter.

The heat developable image recording material of the invention comprises at least one of photosensitive silver halide, a reducing agent for silver ions, a binder and non-photosensitive organic silver salt particles on one side of the surface of a substrate. The content of silver behenate in the non-photosensitive organic silver salt particles is 90 mol % to 100 mol %, and at least one kind of mercapto compounds is contained in a surface of the substrate at the same side as a layer having the photosensitive silver halide.

The non-photosensitive organic silver salt and non-photosensitive organic silver salt particles to be used in the invention will be described hereinafter.

Although the non-photosensitive organic silver salt (may be simply referred to as “organic silver salt” hereinafter) used in the invention is relatively stable to light, silver images are formed by heating at 80° C. or more in the presence of an exposed photo-catalyst (an latent image of photosensitive silver halide or the like) and a reducing agent. The organic silver salt may be arbitrary organic substance containing a source capable of reducing silver ions. These non-photosensitive organic silver salts are described in JP-A Nos. 06-130543, 08-314078 and 09-127643, paragraph Nos. 0048 to 0049 in JP-A No. 10-62899, JP-A Nos. 10-94074 and 10-94075, L24/P18 to L37/p24 in EP No. 080376A1, EP Nos. 0962812A1 and 1004930A2, JP-A Nos. 11-349591, 2000-7683, 2000-72711, 2000-112057 and 2000-155383.

The particularly preferable organic silver salts in the invention are silver salts of long chain aliphatic carboxylic acids (with a carbon number of 10 to 30, preferably 15 to 28). Examples of the preferable organic silver salts include silver behenate, silver arachidate, silver stearate and a mixture thereof. In the invention, the content of silver behenate is 90 mol % or more, preferably 94 mol % or more and particularly 96 mol % or more for obtaining a silver salt of an organic acid excellent in preservative property of raw materials.

The content of silver stearate is preferably 1 mol % or less because this content permits a silver salt with an excellent preservative property to be obtained. The content is preferably 0.5 mol % or less, and particularly with substantially no content of the silver salt.

The content of silver arachidate is preferably 6 mol %, and more preferably 3 mol % or less in order to obtain a silver salt of an organic acid having an excellent preservative property.

The shape of the organic silver salt to be used in the invention preferably has an aspect ratio of 1 to 9 in order to prevent the particles from being broken to consequently attain a good preservative property of images.

Lepidoblastic organic silver salts, and the aspect ratio thereof are defined as follows in the invention. The organic silver salt is observed under an electron microscope, and the shape of the organic silver salt particle is approximated by a rectangular parallelepiped. The edges of the rectangular parallelepiped are defined as “a”, “b” and “c” (“b” and “c” may be the same length) in the order of smallness of the length. Values of “x” and “y” are determined using the shorter two length “a” and “b” from the following equation:

x=b/a and

y=c/b

The values of “x” and “y” are determined with respect to about 200 particles, and mean values (xₘₑₐₙ and yₘₑₐₙ) of “x” and “y” are calculated. The lepidoblastic particle is defined to satisfy the relation of 30≧Xₘₑₐₙ≧1.5. Preferably, xₘₑₐₙ satisfies the relation of 30≧Xₘₑₐₙ≧1.5, and more preferably satisfies the relation of 20≧Xₘₑₐₙ≧2.0. Needle like particles are defined, on the other hand, satisfy the relation of 1≦Xₘₑₐₙ<1.5. The mean value of y (yₘₑₐₙ) is defined to be an aspect ratio. The organic silver salt particle of the invention has an aspect ratio of 1 to 9, preferably 1 to 6, and more preferably 1 to 3.

In the lepidoblastic particle, the value “a” is considered to be the thickness of a plate-like particle with a major plane with the edge length of “b” and “c”. The mean value of “a” is preferably 0.01 μm to 0.23 μm and more preferably 0.1 μm to 0.20 μm.

The ratio of (equivalent-circle diameter of particle)/“a” is defined as the aspect ratio of the lepidoblastic particle. The aspect ratio of the lepidoblastic particle of the invention is 1.1 to 30. Adjusting the aspect ratio in the range above permits the particles to be hardly aggregated in the photosensitive material to make the image preservative property excellent. The aspect ratio is preferably in the range of 1.1 to 15.

The equivalent-circle diameter of the lepidoblastic particle is 0.05 μm to 1 μm, and there by making the particles to be hardly coagulated in the photosensitive material with a good preservative property of images. In the method for measuring the equivalent-circle diameter, the sample is directly photographed under an electron microscope, and the diameter is determined after developing the negative film.

The particle size distribution of the organic silver salt is preferably monodisperse. The monodisperse of the particle size is determined by determining the standard deviation of the volume weighted average diameter of the organic silver salt particles. The percentage (variation coefficient) obtained by dividing the diameter by the volume weighted average diameter is preferably 100% or less, more preferably 80% or less, and still more preferably 50% or less. For measuring the particle size (volume weighted average diameter), the organic silver salt particles dispersed in a liquid is irradiated with a laser light, the particle size is determined from an auto-correlation function of time-dependent fluctuation of the scattered light from the particles.

It is preferable to prepare the organic silver salt particles of the invention at a low temperature of 60° C. or less for providing particles with a low minimum density (Dₘᵢₙ). While the temperature of chemicals added such as an aqueous solution of an organic acid alkali metal salt may be higher than 60° C., the temperature of the reaction bath in which the reaction solution is immersed is preferably 60° C. or less, more preferably 50° C. or less, and particularly 40° C. or less.

When the organic silver salt particles are prepared by allowing a solution containing silver ions such as silver nitrate to react with a solution or suspension of the organic acid alkali metal salt, 50% or more of the total amount of silver is preferably added simultaneously with addition the solution or suspension of organic acid alkali metal salt. The addition method comprises adding on the liquid surface of the reaction bath, adding into the solution, or adding into sealed mixing means, the method for adding into the sealed mixing means (for example, a sealed mixing vessel) is particularly preferable.

An example of a preparation method for adding into sealed mixing means is described below.

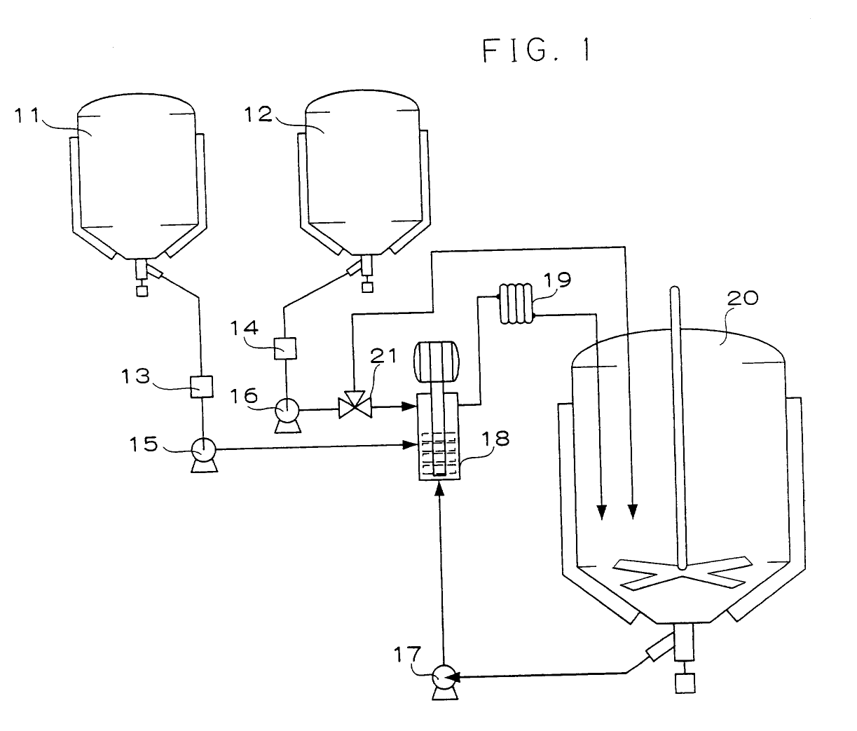

FIG. 1 shows an embodiment of an apparatus for manufacturing non-photosensitive organic silver salt to be used in the invention. In the drawing, reference numerals 11 and 12 denote vessels for storing a silver ion containing solution (for example, an aqueous silver nitrate solution) and an organic acid alkali metal salt solution, respectively, by controlling at a predetermined temperature. Reference numerals 13 and 14 denote flow meters for measuring the flow rates when these solutions are added into a sealed mixing device 18 filled with a liquid through pumps 15 and 16, respectively. In this embodiment, a pump 17 for recycling a dispersion of the prepared organic silver salt into the mixing device 18 is also provided as a third element. The solution after completing the reaction in the mixing device 18 is promptly cooled by being introduced into a heat exchanger 19, and is sent to a tank 20.

The pH value of the silver ion containing solution (for example, an aqueous silver nitrate solution) to be used in the invention is preferably 1 to 6, and more preferably 1.5 to 4. An acid and an alkali may be further added for controlling the pH value. The kinds of the acid or alkali are not particularly restricted.

The organic silver salt of the invention may be ripened by increasing the reaction temperate after completing addition of the silver ion containing solution (for example, aqueous silver nitrate solution) and/or organic acid alkali metal salt solution. The ripening temperature in the invention can be considered to be different from the reaction temperature as hitherto described. Silver nitrate and organic acid alkali metal salt solution or suspension are should be never added during ripening. The ripening temperature is preferably by 1° C. to 20° C., and more preferably by 1° C. to 10° C., higher than the reaction temperature. The ripening time is preferably determined by try-and-error.

The solution of the organic acid alkali metal salt may be discretely added in 2 to 6 steps for preparing the organic silver salts of the invention. The particles may discretely added for endowing the particles with various functions such as improving photographic performance and modifying surface hydrophilicity. The number of discrete addition of the particles is preferably 2 to 4. Since the organic acid salts may be solidified unless the temperature is high, a plurality of addition lines for division should be provided, or the circulation method should be devised for discrete addition.

Preferably, 0.5 mol % to 30 mol %, and more preferably 3 mol % to 20 mol %, of the total moles of the organic acid alkali metal salt solution is independently added after completing the addition of the silver ion containing solution for preparing the organic silver salt of the invention. This amount of addition is preferably applied as one time of addition of the discrete addition. While the solution may be added in the sealed mixing device or in the reaction vessel, it is preferable to add in the reaction vessel. Adding as described above enables surface hydrophilicity to be increased, thereby improving film forming ability of the photosensitive material and decreasing the incidence of peeling of the film.

The silver ion concentration of the silver ion containing solution (for example, aqueous silver nitrate solution) to be used in the invention in mole is preferably 0.03 mole/L to 6.5 mole/L, and more preferably 0.1 mole/L to 5 mole/L.

It is preferable, in order to form the organic acid particles in the invention, that an enough amount of an organic solvent for forming a substantially clear solution, not as strands or micelles of the organic acid alkali metal salt, is contained in at least one of the silver ion containing solution, organic acid alkali metal salt solution or dispersion, or a solution previously prepared as a reaction medium. While the organic solvent may be used alone, it may be a mixed solution with water.

While the organic solvent is not particularly restricted so long as it is soluble in water while having the properties as described above, solvents than hinder photographic performance are not preferable. The solvent is preferably alcohols and acetone that can be mixed with water, and tertiary alcohols with a carbon number of 4 to 6 are more preferable.

Practically preferable examples of the alkali metals for the organic acid alkali metal salts to be use in the invention include Na and K. The organic acid alkali metal salt can be prepared by adding NaOH or KOH in an organic acid. It is preferable to allow unreacted organic acid to remain by adding an amount of alkali not more than the molar equivalence of the organic acid. The amount of the remaining organic acid relative to the amount of the total organic acid is 3 mol % to 50 mol %, and preferably 3 mol % to 30 mol %. The residual organic acid may be prepared by neutralizing an excess amount of alkali by adding an acid such as nitric acid or sulfuric acid, after adding an alkali in an amount not smaller than the desired quantity.

For example, compounds represented by the general formula (1) in JP-A No. 62-65035, N-heterocyclic compounds containing hydrophilic groups as described in JP-A No. 62-150240, inorganic peroxides as described in JP-A No. 50-101019, sulfur compounds as described in JP-A 51-78319, and disulfide compounds and hydrogen peroxide as described in JP-A No. 57-643 maybe added in the silver ion containing solution and organic acid alkali metal salt solution to be used in the invention, or in the sealed mixing means in which both solutions are added.

The organic acid alkali metal salt solution to be used in the invention preferably contains 3% by volume to 70% by volume, and more preferably 5% by volume to 50% by volume, of an organic solvent relative to the volume of water. Since the optimum solvent volume changes depending on the reaction temperature, an optimum amount should be determined by trial-and error.

The concentration of the organic acid alkali metal salt to be used in the invention is 5% by mass to 50% by mass, preferably 7% by mass to 45% by mass, and more preferably 10% by mass to 40% by mass in mass ratio.

The temperature of the aqueous tertiary alcohol solution of the organic acid alkali metal salt added in the sealed mixing means or reaction vessel is preferably 50° C. to 90° C., more preferably 60° C. to 85° C., and most preferably 65° C. to 85° C., in order to maintain a temperature required for preventing the organic acid alkali metal salt from crystallizing or solidifying. The reaction temperature is preferably maintained at a constant temperature selected from the temperatures in the range as described above.

The rate of precipitation of the organic acid alkali metal salt from an aqueous tertiary alcohol solution by quenching a high temperature solution in the sealed mixing means, and the rate for forming the organic silver salt by a reaction with the silver ion containing solution are preferably controlled to enable preferable crystal habit, crystal size and crystal size distribution of the organic silver salt to be obtained. The performance as the heat developable material, particularly as the heat development photosensitive material may be also improved by controlling these rates as described above.

The solvent may be previously filled in the reaction vessel. While water is preferably used as the solvent to be filled in advance, a mixed solvent of water and tertiary alcohol may be also preferably used.

A dispersion assistant soluble in an aqueous medium may be added to the aqueous tertiary alcohol solution of the organic acid alkali metal salt, silver ion containing solution or reaction solution. Any dispersion assistants are available so long as they are able to disperse the organic silver salt formed, and examples of them are selected in accordance with the dispersion assistant of the organic silver salt to be described hereinafter.

A desalting and dehydration process is preferably applied for preparing the non-photosensitive organic silver salt particles. The methods are not particularly restricted, and any conventional methods known in the art may be used. For example, the methods available include filtration methods known in the art such as centrifugal filtration, suction filtration, ultrafiltration and washing with water after forming flocks by coagulation. Removal of supernatant after centrifugal separation and sedimentation is one of the methods preferably used. However, dehydration by ultrafiltration is preferable in the invention.

One time of desalting and dehydration may be applied, or plural times of desalting and dehydration may be repeated. Water may be continuously added and removed, or discretely added and removed. The particles are desalted and dehydrated until the conductivity of dehydrated water decreases to preferably about 300 μS/cm or less, more preferably about 100 μS/cm or less, and most preferably about 60 μS/cm or less. While the lower limit of conductivity is not particularly prescribed, it is usually about 5 μS/cm.

The ultrafiltration method used, for example, for desalting/concentration of a silver halide emulsion may be used in the invention. Research Disclosure No. 10, p. 208 (1972), No. 13, p. 122 (1975) and No. 16, p. 351 (1977) may be cited. While differential pressure and flow rate as crucial operation conditions may be selected with reference to characteristic curves described in “Handbook for Using Membrane”, p. 275, by Haruhiko Ohya, Saiwai Publishers Co. (1978), an optimum condition should be found for suppressing coagulation of the particles and fogging for treating the desired organic silver salt dispersion. While the solvent may be continuously or discretely added in the method for supplementing the solvent lost by membrane permeation, a constant volume method in which the desalting time is relatively short is preferable.

While ion-exchange water or distilled water is used for the solvent to be supplemented, a pH control agent or the like may be added in pure water or directly in the organic silver salt dispersion in order to maintain a desired pH value.

While ultrafiltration films such as planer films to be assembled as a module, cylindrical films and hollow fiber type films are commercially available from Asahi Chemical Industry Co., Ltd., Daicel Chemical Industries, Ltd., Toray Industries, Inc. and Nitto Denko Co., the spiral type and hollow fiber type membranes are preferable considering the total membrane area and cleaning performance.

The fractionated molecular weight as an index of the threshold if each component that is permeable through the membrane is preferable one fifth of the molecular weight of the polymer dispersing agent used.

For desalting by the ultrafiltration membrane of the invention, it is preferable to disperse the solution so that the particle size becomes about two fold of the volume weighted average of the final particle size in advance to the treatment. The dispersion means may be any methods such as a high pressure homogenizer or micro-fluidizer to be described hereinafter.

The temperature of the liquid is preferably maintained low until the desalting process advances immediately after formation of the particles, because nuclei of silver tend to be formed by a shear medium and pressure medium caused by the liquid sending operation and by passing through the ultrafiltration membrane when the organic solvent used for dissolving the organic acid alkali metal salt is permeated into the organic silver salt particles. Consequently, the dispersion of the organic silver salt particles is subjected to the ultrafiltration operation while maintaining the temperature at 1 to 30° C., and preferably at 5 to 25° C., in the invention.

It is further preferable for maintaining the application surface of the heat developable material, in particular, heat developable photosensitive material in good state to form the desalted and dehydrated organic silver salt as fine dispersion by adding a dispersing agent.

Any methods known in the art may be employed as a method for manufacturing and dispersing the organic silver salt to be used in the invention. These methods are referenced, for example, in JP-A Nos. 8-234358 and JP-A 10-62899, EP Nos. 0803763A1 and 0962812A1, JP-A Nos. 11-349591, 2000-7683,2000-72711, 2000-53682, 2000-75437, 2000-86669, 2000-143578, 2000-178278 and 2000-256254, JP-A Nos. 11-348228 to 30, 11-203413,11-115457, 11-180369, 11-297964, 11-157838 and 11-202081, Japanese Patent Application Nos. 2000-90093, 2000-195621, 2000-191226, 2000-213813, 2000-214155 and 2000-191226.

Methods for mechanically dispersing the organic silver salt into fine particles include using known miniaturization means (for example, a high speed mixer, homogenizer, high speed impact mill, Bambury mixer, homomixer, kneader, ball mill, vibration ball mill, planetary ball mill, atomizer, sand mill, beads mill, colloid mill, jet mill, roller mill, tron mill and high speed stone mill) in the presence of a dispersing assistance, thereby capable of dispersing mechanically.

For obtaining a solid dispersion of the aliphatic acid silver salt with a high S/N ratio, small particle size and uniform without coagulation, an even and large force is preferably applied within a range not to damage the organic silver salt particles as image forming media with no increase of the temperature. For this purpose, it is preferable to employ a dispersion method in which the pressure is reduced after converting the dispersion comprising the organic silver salt and dispersing solution into a high speed flow. While any solvents that permits the dispersion assistant to function are available, the solvent is preferably water, or may contain an organic solvent in a proportion of 20% by mass or less. Since the level of fogging increases to remarkably decrease sensitivity when the photosensitive silver salt is contained together during dispersion, it is more preferable that the dispersing solution is substantially free from the photosensitive silver salt during dispersion. The amount of the photosensitive silver salt in the dispersion solution to be dispersed is 0.1 mol % or less relative to one mole of the organic silver salt in the solution in the invention, and the photosensitive silver salt is preferably not added.

The dispersion apparatus for re-dispersion as described above, and technologies thereof are detailed, for example, in “Rheology of Dispersion System and Dispersion Technology” pp. 357-403, 1991, by Toshio Kajiuchi and Hiroki Usui, Shinzan-sha Publishing Co.; “Progress of Chemical Engineering, Vol. 24” pp184 to 185, 1990, edited by Tokai Department of The society of Chemical Engineers, Japan, Maki Bookstore Co.: JP-A No. 59-49832, U.S. Pat. No. 4,533,254, JP-A Nos. 8-137044, 8-238848, 2-261525 and 1-94933. In the fine re-dispersion method in the invention, the solution was allowed to pass through fine slender slits provided in the pipe, and the pressure of the dispersion was promptly reduced thereafter.

With respect to the high-pressure homogenizer, it is generally considered that uniform and efficient dispersion is possible by (a) a shear force generated by allowing dispersing substances to pass through narrow spaces (with an width of about 75 to 350 μm) at a high speed under a high pressure, and (b) liquid-liquid collision in a narrow space under a high pressure, or an increased cavitation force generated by pressure drop after collision to an wall without changing the impact force generated by the collision. While a Golin homogenizer had been used for this type dispersion apparatus before, the solution is converted into a high speed flow in a narrow gap on the cylinder face, and the solution vigorously collide with the surrounding wall to emulsify and disperse by means of the impact force. Examples of the liquid-liquid collision apparatus as described above include a Y-shape chamber in the micro-fluidizer, and a spherical chamber taking advantage of a spherical check valve as described in JP-A No. 8-103642. Examples of a liquid-wall collision apparatus include a Z-type chamber of the micro-fluidizer or the like. The pressure used is usually in the range of 100 to 600 kg/cm², and the flow rate is in the range of several meters to 30 m/sec. The high speed portion of the liquid is serrated in order to increase the number of collision. Representative examples of such apparatus include Golin homogenizer, micro-fluidizer made by Micro-Fluidex International Co., micro-fluidizer made by Mizuho Industires Co., and nanomizer made by Tokushu Kiko Co. Such apparatus is also described in JP-A Nos. 8-238848 and 8-103642, and U.S. Pat. No. 4,533,254.

The organic silver salt can be dispersed into a desired particle size by adjusting the differential pressure by pressure drop and the number of treatment. Preferably, the flow rate is 200 to 600 m/sec, and the differential pressure during the pressure drop is in the range of 900 to 3000 kg/cm² (9 to 30 MPs), and more preferably, the flow rate is 300 to 600 m/sec, and the differential pressure during the pressure is in the range of 1500 to 3000 kg/cm² (15 to 30 MPa) from the view point of photographic performance and particle size. The number of dispersion treatment may be selected, if necessary. While the selected number of dispersion is usually 1 to 10 times, 1 to 3 times is selected from the view point of productivity. It is not preferable to heat the dispersion at a high temperature under a high pressure is not preferable considering dispersion ability and photographic performance, and a high temperature exceeding 90° C. tend to increase the particle size besides increasing the degree of fogging. Accordingly, the system is preferably provided with a cooling device in the process before converting into a high pressure—high speed flow, or in the process after the pressure drop. The dispersion pressure is preferably maintained in the range of 5 to 90° C., more preferably in the range of 5 to 80° C., and particularly in the range of 5 to 65° C., by the cooling step. It is particularly effective to provide the cooling device when the liquid is dispersed under a high pressure in the range of 1500 to 3000 kg/cm² (15 to 30 MPa). The cooling device available for proper selection include those using a dual or triple pipe static mixer, a multi-pipe heat-exchanger and a coiled heat-exchanger in accordance with the required heat exchange amount. The diameter, thickness and material of the pipe may be properly selected considering the pressure used in order to improve the efficiency of heat exchange. The coolant used for the cooling device is well water at 20° C., cooled water at 5 to 10° C. after cooling with a refrigerator, and a coolant such as ethyleneglycol/water at −30° C. may be used.

Dispersing agents preferably used for forming solid micro-particles of the organic silver halide include synthetic anionic polymers such as polyacrylic acid, copolymer of acrylic acid, copolymer of maleic acid, copolymer of maleic acid monoester and copolymer of acryloyl methylpropane sulfomnic acid; semi-synthetic anionic polymers such as carboxymethyl starch and carboxymethyl cellulose; anionic polymers such as alginic acid and pectic acid; anionic surfactants described in JP-A No. 52-92716 and WO No. 88/04794; compounds described in Japanese Patent Application No. 7-350753; and anionic, nonionic and cationic surfactants known in the art; as well as polymers known in the art such as polyvinyl alcohol, polyvinyl pyrrolidone, carboxymethyl cellulose, hydroxypropyl cellulose and hydroxypropylmethyl cellulose; and natural polymers such as gelatin. Solvents preferably used as dispersing agents include polyvinyl butylal, butylethyl cellulose, methacrylate polymer, maleic anhydride ester copolymer, polystyrene and butadiene-styrene copolymer.

While the dispersion agent is usually fed into a dispersing device as a slurry by mixing with a powder of the organic silver salt or a wet cake of the organic silver salt before dispersion, the powder or cake of the organic silver salt may be prepared by treating the dispersing agent previously mixed with the organic silver salt with heat or solvent. The pH value may be controlled with an appropriate pH control agent before or during dispersion.

The organic silver salt my be roughly dispersed in a solvent by controlling the pH value without using a mechanical dispersion method, and the particles are further miniaturized by changing the pH value in the presence of a dispersion assistant. A fatty acid solution may be used for roughly dispersing the particles.

Since fogging is increased and sensitivity is decreased by the presence of the photosensitive silver salt when the organic silver salt is dispersed, it is preferable that the dispersing solvent is substantially free from the photosensitive silver salt. The amount of the photosensitive silver salt to be dispersed in an aqueous dispersion solution is 0.1 mol % or less relative to one mole of the organic silver salt in the solution, and the photosensitive silver salt is not purposely added.

The photosensitive material can be produced by mixing an aqueous dispersion of the organic silver salt and an aqueous dispersion of the photosensitive silver salt in the invention. While the mixing ratio between the organic silver salt and photosensitive silver salt may be selected depending on the object, the proportion of the photosensitive silver salt to the organic silver salt is preferably in the range of 1 to 30 mol %, more preferably in the range of 3 to 20 mol %, and particularly in the range of 5 to 15 mol %. It is preferably used for controlling photographic characteristics to mix 2 kinds or more of the aqueous dispersions of the organic silver salt with 2 kinds or more of the aqueous dispersions of the photosensitive silver salt.

While a desirable amount of the organic silver salt may be used in the invention, it is preferably 0.1 to 5 g/cm², and more preferably 1 to 3 g/cm², as converted in the quantity of silver.

The heat developable image recording material of the invention contains at least one kind of mercapto compound on the same side face of the substrate as the layer having photosensitive silver halide.

It is preferable that at least one kind of mercapto compound is contained in the photosensitive layer having silver halide. The preferably used mercapto compound is represented by the following general formula (1).

The compound represented by the general formula (1) to be used in the invention will be described in detail hereinafter.

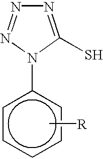

In the general formula (1), R represents a hydrogen atom, an alkyl group, an aralkyl group, an alkoxy group, an alkyl or aryl substituted amino group, an amide group, a sulfonamide group, an ureide group, an urethane group, an aryloxy group, a sulfamoyl group, a carbamoyl group, an aryl group, an alkylthio group, an arylthio group, a hydroxyl group, an alkylcarbonyl group, a halogen atom, a cyano group or phosphoramide group. These groups may be further substituted.

The compound represented by the general formula (1) will be described in more detail.

Examples of R in the general formula (1) include a hydrogen atom, an alkyl group (such as methyl, ethyl, propyl and cyclohexyl groups), an aralkyl group (such as benzyl group), an alkoxy group (such as methoxy and ethoxy groups), an alkyl or aryl substituted amino group (such as dimethylamino group), an amide group (such as pentylamide group), a sulfonamide group (such as methyl sulfonamide group), an ureide group, an urethane group (such as methyl urethane and ethyl urethane groups), an aryloxy group (such as phenoxy and naphthoxy groups), a sulfamoyl group (such as ethyl sulfamoyl and phenyl sulfamoyl groups), a carbamoyl group (such as ethyl carbamoyl and phenyl carbamoyl groups), an aryl group (such as phenyl and naphthyl groups), an alkylthio group (such as methylthio and hexylthio gorups), an arylthio group (such as phenylthio group), a hydroxyl group, an alkylcarbonyl group, halogen atoms (such as fluorine, chlorine, bromine and iodine), a cyano group and a phosphoramide group. These groups may be further substituted, and the substituents include the groups represented by R above.

R is preferably a ureide group, and the total carbon number of R is preferably 0 to 20.

While examples of the compound represented by the general formula (1) (exemplified compounds 1-1 to 1-46) are shown below, the invention is not restricted thereto.

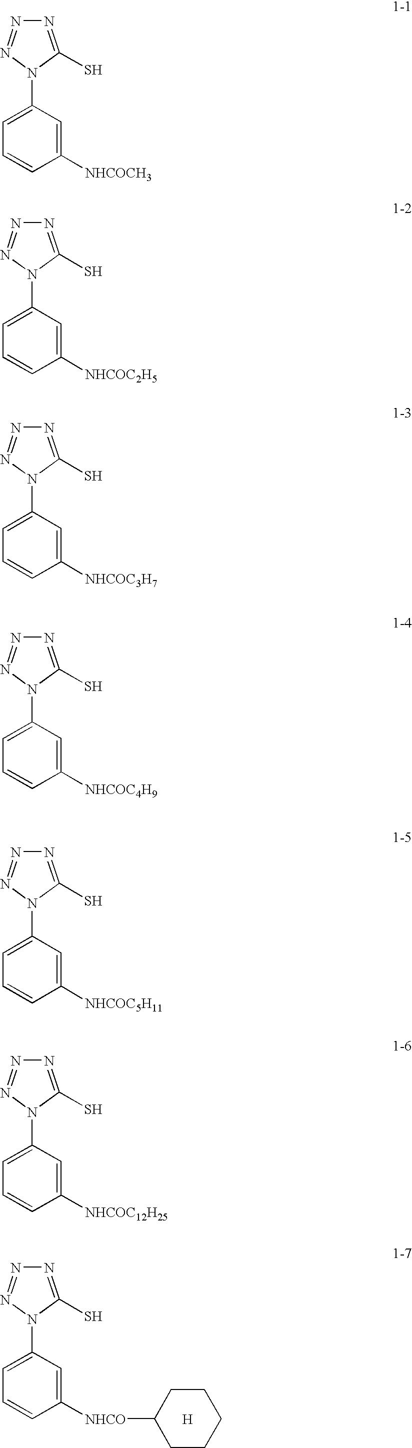

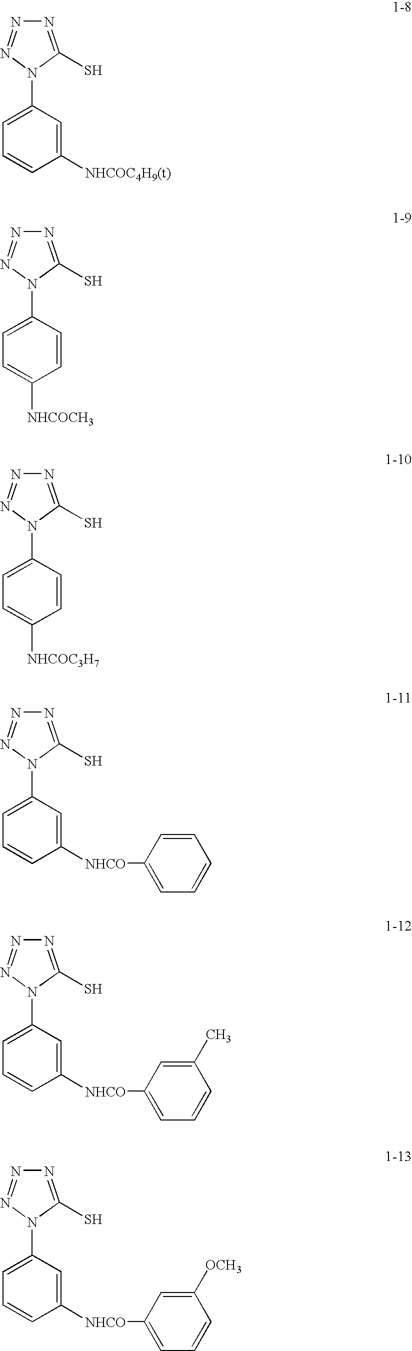

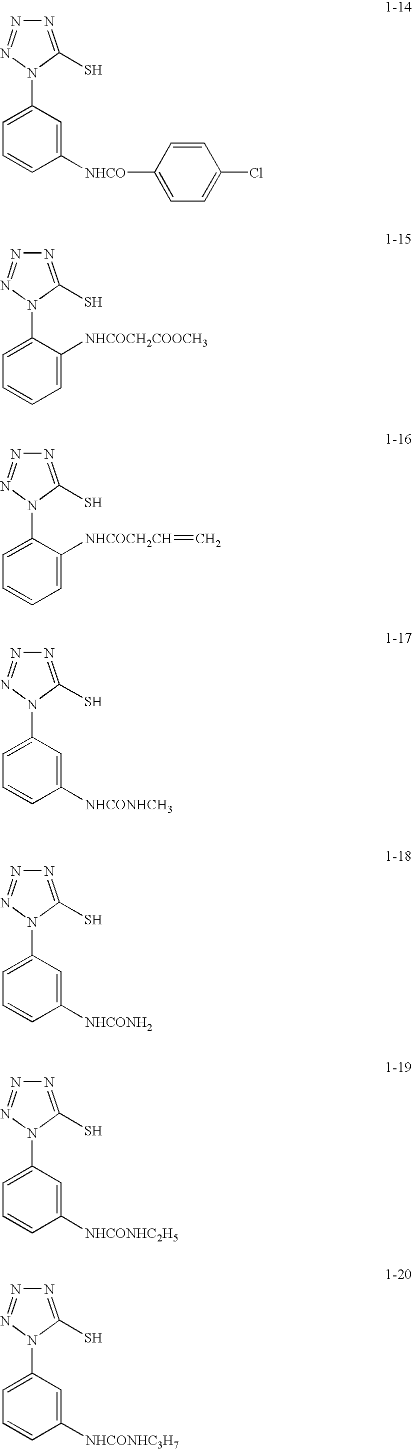

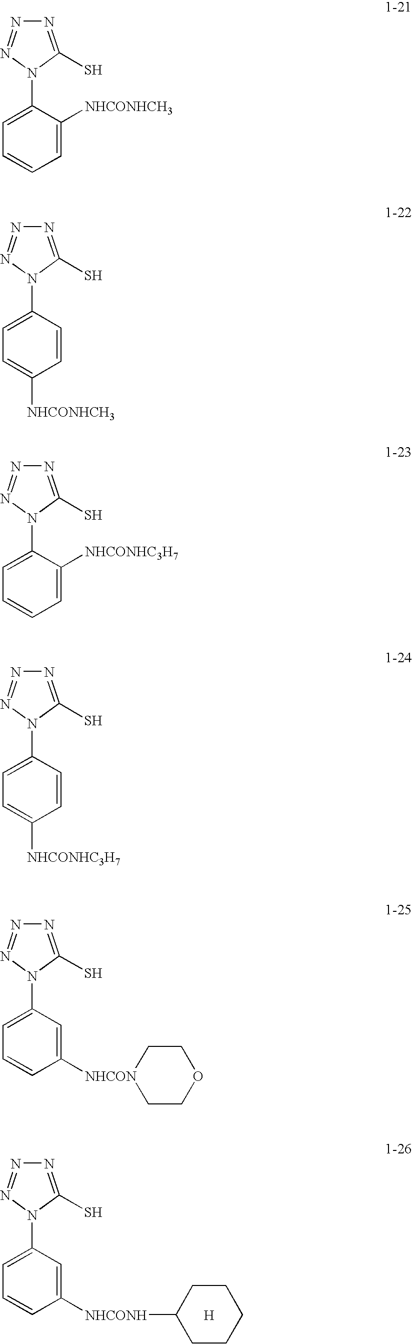

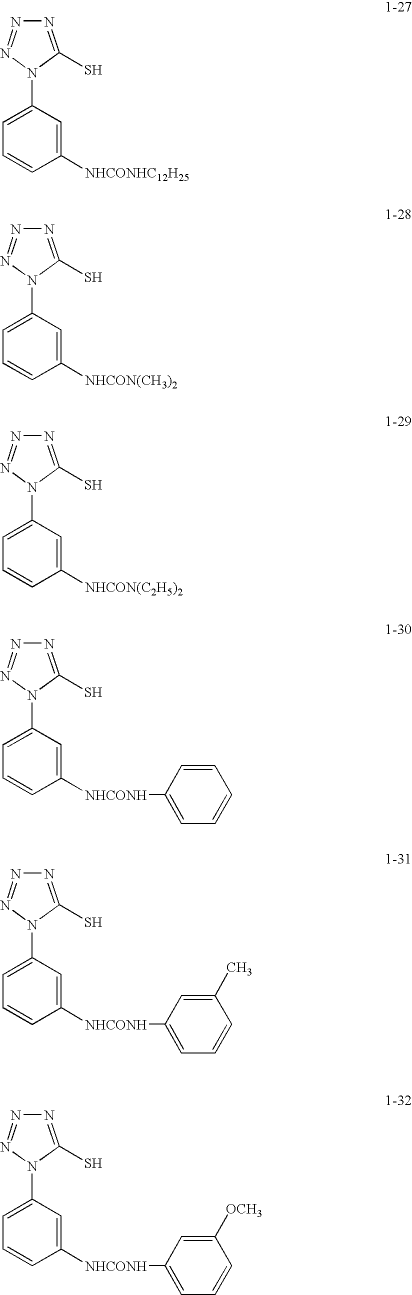

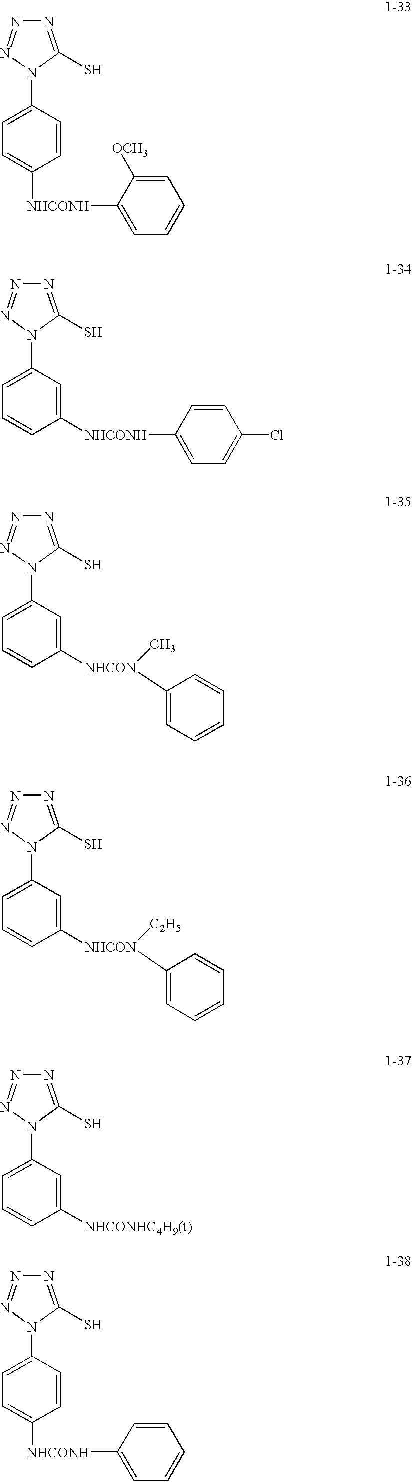

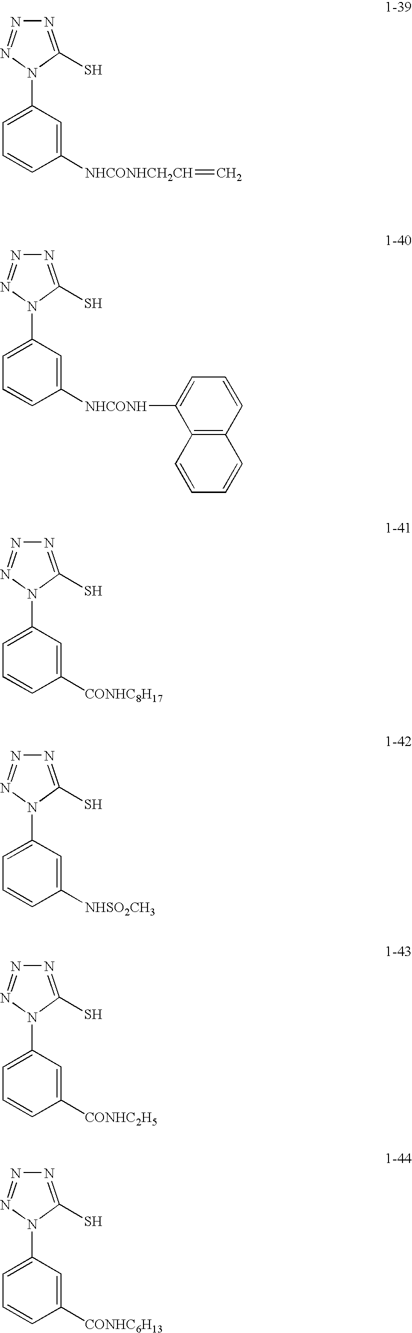

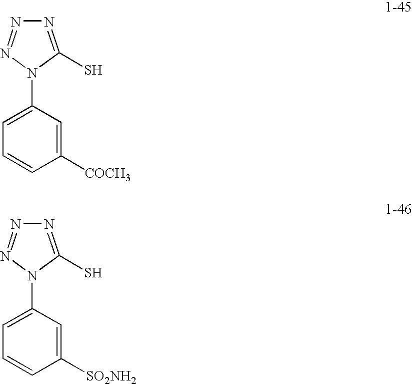

The compound represented by the general formula (1) of the invention may be used by dissolving into water or appropriate solvents such as alcohols (methanol, ethanol, propanol and fluorinated alcohols), ketones (acetone and methylethyl ketone), dimethylformamide, dimethylsulfoxide and methyl cellosolve.

An emulsified dispersion may be mechanically formed by an emulsifying dispersion method well known in the art after dissolving in an oil such as dibutyl phthalate, tricresyl phosphate, glyceryl triacetate or diethyl phthalate, or an auxiliary solvent such as ethyl acetate or cyclohexanone. Alternatively, the powder of the compound may be used by dispersing in water by a solid dispersion method known in the art using a ball mill or colloid mill, or by ultrasonic dispersion.

While the mercapto compound of the invention may be added in a layer having the photosensitive silver halide (or silver halide emulsion layer) or any other layers of the substrate, it is preferable to add in the silver halide emulsion layer or in the layer adjoining thereto.

The amount of addition of the mercapto compound of the invention is preferably 1×10⁻⁴ to 5×10⁻¹ mole, and more preferably 5×10⁻⁴ to 1×10⁻¹ mole relative to one mole of silver halide.

The ratio of the mercapto compound of the invention to the non-photosensitive organic silver salt particle is preferably 1:10000 to 1:30, and more preferably 1:2000 to 1:100 in mass ratio.

The heat developable image recording material of the invention contains a reducing agent for the silver ion (referred to as a reducing agent hereinafter. As the silver ion (referred to as a reducing agent hereinafter) any substances (preferably organic substances) which are able to reduce the silver ion into metallic silver may be used. These reducing agents are described in the paragraph Nos. 0043 to 0045 in JP-A No. 11-65021 and p7/line 34 to p18/line 12 in EP No. 0803764A1.

Reducing agents of hindered phenols or bisphenols are preferable as the reducing agent, and the compounds represented by the general formula (2) are more preferable.

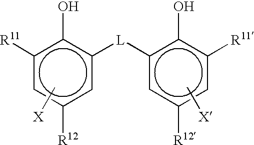

In the general formula (2), R¹¹ and R^{11′} independently represent an alkyl group with a carbon number of 1 to 20; R¹² and R^{12′} independently represent a hydrogen atom or a substituent capable of substituting to a benzene ring; L represents a —S— group or —CHR¹³— group; R¹³ represents a hydrogen atom or an alkyl group with a carbon number of 1 to 20; and X and X′ independently represent a hydrogen atom or a substituent capable of substituting to a benzene ring.

The general formula (2) will be described in detail.

R¹¹ and R^{11′} independently represent a substituted or non-substituted alkyl group with a carbon number of 1 to 20. The alkyl group is not particularly restricted, and it is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group and a halogen atom.

R¹¹ and R^{11′} are preferably secondary or tertiary alkyl groups with a carbon number of 3 to 15, and examples of them include an isopropyl group, an isobutyl group, a t-butyl group, a t-amyl group, a t-octyl group, a cyclohexyl group, a cyclopentyl group, a 1-methylcyclohexyl group and a 1-methylcyclopropyl group. More preferably, R¹¹ and R^{11′} are tertiary alkyl groups with a carbon number of 4 to 12, t-butyl group, t-amyl group and 1-methylcyclohexyl group are more preferable, and t-butyl group is most preferable.

R¹² and R^{12′} each independently are hydrogen atoms or substituents capable of substituting to a benzene ring.

R¹² and R^{12′} are preferably alkyl groups with a carbon number of 1 to 20, and examples of them include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group and a methoxyethyl group. Methyl group, ethyl group, propyl group, isopropyl group and t-butyl group are more preferable.

X and X′ each independently represent a hydrogen atom or a group capable of substituting to the benzene ring. Examples of the preferable group capable of substituting to the benzene ring include an alkyl group, an aryl group, a halogen atom, an alkoxy group and an acylamino group.

X and X′ are preferably hydrogen atoms, halogen atoms and alkyl groups, and more preferably hydrogen atoms.

L represents a —S— group or —CHR¹³— group, and preferably —CHCHR¹³— group.

R¹³ represents a hydrogen atom or an alkyl group with a carbon number of 1 to 20 which may be substituted or non-substituted. Examples of the non-substituted alkyl group represented by R¹³ are a methyl group, an ethyl group, a propyl group, a butyl group, a heptyl group, an undecyl group, an isopropyl group, a 1-ethylpentyl group and a 2,4,4-trimethylpentyl group. The substituent of the alkyl group is the same as the substituent of R¹¹, and include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group and a sulfamoyl group.

R¹³ is a hydrogen atom or an alkyl group with a carbon number of 1 to 15, and preferable examples of the alkyl group include a methyl group, an ethyl group, a propyl group, an isopropyl group and a 2,4,4-trimethylpentyl group. The hydrogen atom, methyl group and propyl group are particularly preferable as R¹³.

R¹² and R^{12′} are preferably an alkyl group with a carbon number of 2 to 5 when R¹³ is a hydrogen atom with the ethyl group and propyl group being more preferable, and the ethyl group being most preferable.

R¹² and R^{12′} are preferably methyl groups when R¹³ is a primary or secondary alkyl group with a carbon number of 1 to 8. Examples of the primary or secondary alkyl group with a carbon number of 1 to 8 represented by R¹³ preferably include a methyl group, an ethyl group, a propyl group and an isopropyl group, and the methyl group, ethyl group and propyl group are more preferable.

R¹³ is preferably a secondary alkyl group when all the R¹¹, R^{11′}, R¹² and R¹² are methyl groups. In this case, the isopropyl group, isobutyl group and 1-ethylpentyl group are preferable, and the isopropyl group is more preferable as the secondary alkyl group represented by R¹³.

While examples of the reducing agents (exemplified compounds 2-1 to 2-27) to be used in the invention such as the compounds represented by the general formula (2) are listed below, the invention is not restricted thereto.

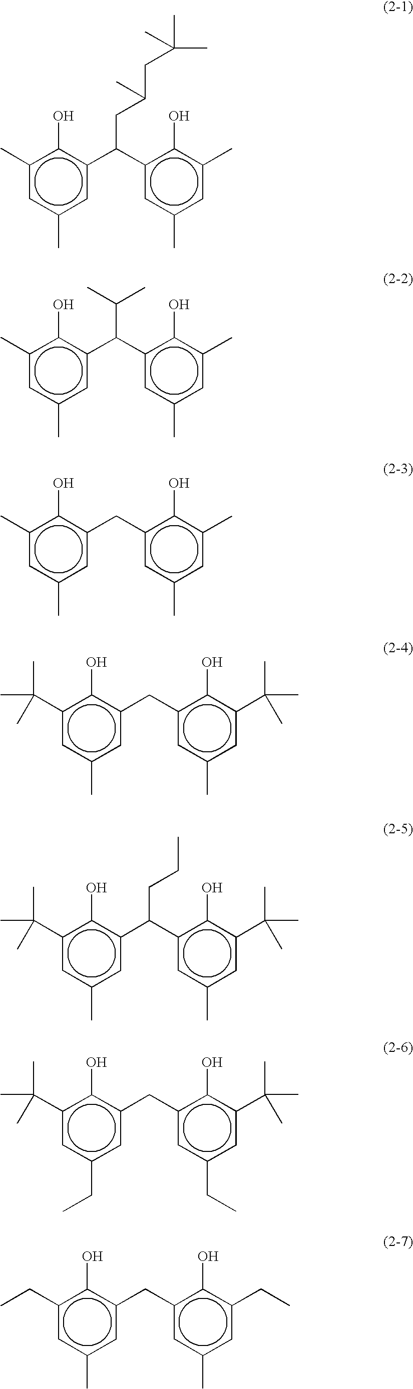

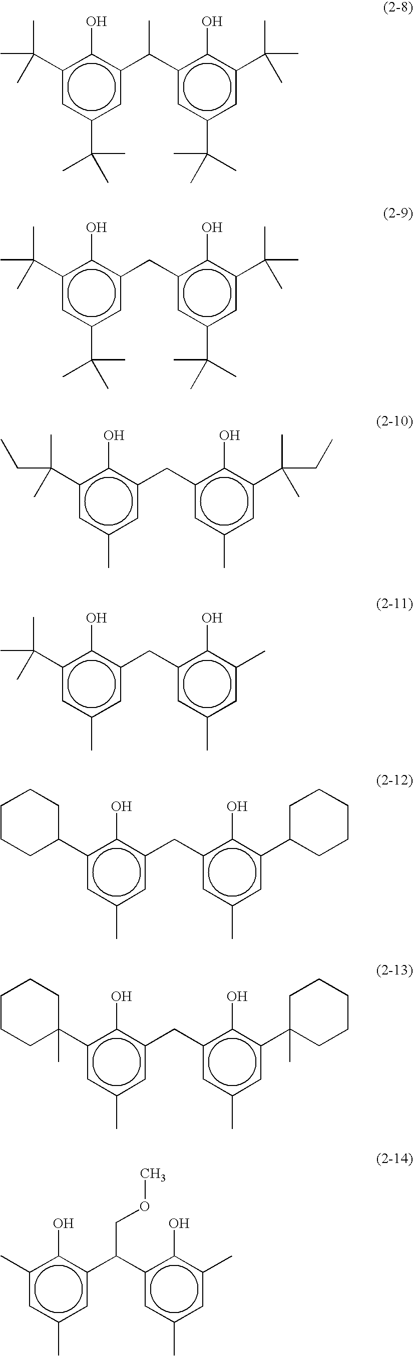

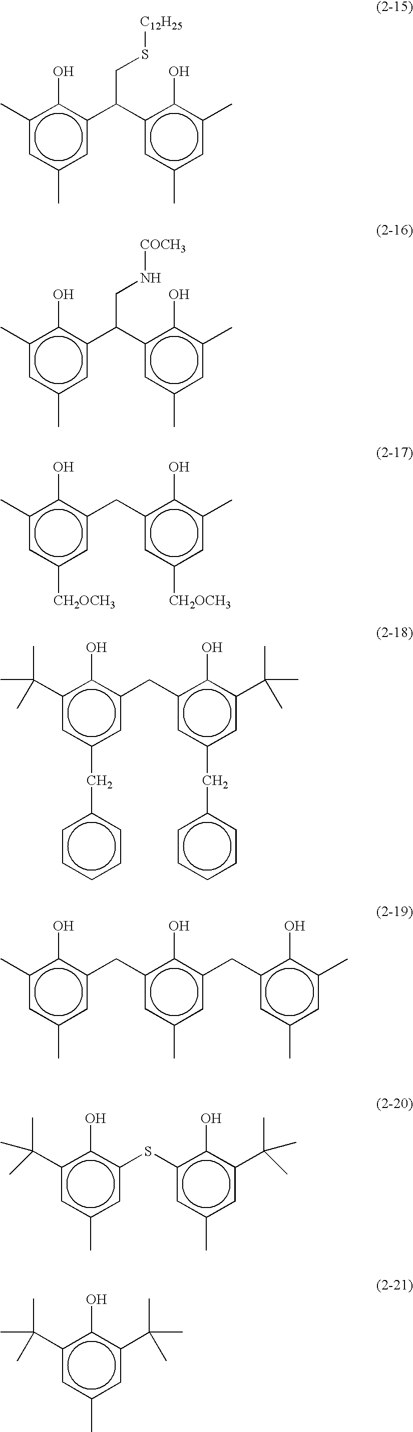

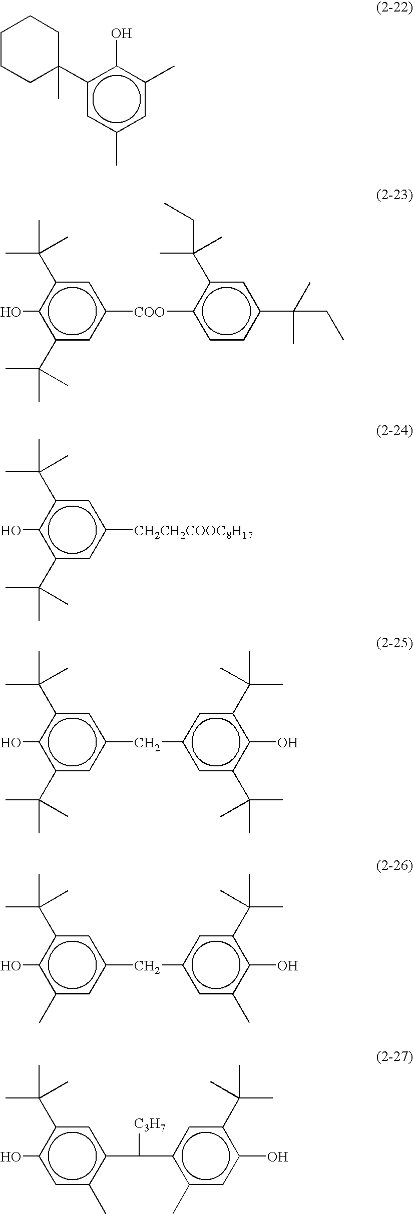

The amount of addition of the reducing agent in the invention is preferably 0.01 to 5.0 g/m², and more preferably 0.1 to 3 g/m²; or preferably 5 to 50 mol %, and more preferably 10 to 40 mol %, relative to one mole of silver in the surface having the image forming layer.

The reducing agent may be incorporated into the application fluid, or into the heat developable image forming material, in any form such as in solution, in emulsified dispersion and solid micro-dispersion.

The emulsification and dispersion method known in the art include dissolving using an oil such as dibutyl phthalate, tricresyl phosphate, glycerol triacetate or fiethyl phthalate, or an auxiliary solvent such as ethyl acetate or cyclohexanone, followed by mechanically emulsified dispersion.

The method for dispersing solid fine particles includes the steps of dispersing the powder of the reducing agent in an appropriate solvent such as water using a ball mill, colloid mill, vibration ball mill, sand mill, jet mill or roller mill, or by ultrasonic wave for preparing a solid dispersion. A protective colloid (for example, polyvinyl alcohol) and a surfactant (for example, an anionic surfactant such as triisopropyl naphthalene sulfonic acid [a mixture of compounds having different substitution sites for three isopropyl groups]) maybe used. An antiseptic (for example, sodium benzoisothiazolinone) may be added in the aqueous dispersion.

Phenol derivatives represented by the formula (A) described in Japanese Patent Application No. 11-73951 may be preferably used as the development accelerator in the heat developable image recording material of the invention.

When the reducing agent of the invention has aromatic hydroxyl (—OH) groups, in particular the reducing agent is bisphenols, a non-reducing agent having a group capable of forming a hydrogen bond with the group as described above is preferably used. Examples of the group that forms a hydrogen bond with a hydroxyl group or an amino group include a phosphoryl group, a sulfoxide group, a sulfonyl group, a carbonyl group, an amide group, an ester group, an urethane group, an ureide group, a tertiary amino group and a nitrogen containing aromatic group. Compounds having a phosphoryl group, a sulfoxide group, an amide group (having no >N—H group, and being blocked like >N—Ra (Ra is a substituent except H)), an urethane group (having no >N—H group, and being blocked like >N—Ra (Ra is a substituent except H)) and an ureide group (having no >N—H group, and being blocked like >N—Ra (Ra is a substituent except H)) are more preferable among them.

The particularly preferable hydrogen bond forming compound in the invention is represented by the following general formula (3):

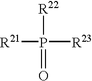

In the general formula (3), R²¹, R²² and R²³ each independently represent an alkyl group, an aryl group, an alkoxy group, an aryloxy group, an amino group or a heterocyclic group. These groups may be non-substituted or substituted.

Examples of the substituent when each of R²¹, R²² and R²³ has a substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group and a phosphoryl group. Preferable substituents are alkyl groups or aryl groups, and example of them include a methyl group, an ethyl group, an isopropyl group, a t-butyl group, a t-octyl group, a phenyl group, a 4-alkoxyphenyl group and a 4-acyloxyphenyl group.

Examples of the alkyl group represented by R²¹, R²² and R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group and a 2-phenoxypropyl group.

Examples of the aryl group represented by R²¹, R²² and R²³ include a phenyl group, a cresyl group, a xylyl group, a naphthyl group, a 4-t-butylphenyl group, a 4-t-octylphenyl group, a 4-anisidyl group and a 3,5-dichlorophenyl group.

Examples of the alkoxy group represented by R²¹, R²² and R²³ include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Examples of the aryloxy group represented by R²¹, R²² and R²³ include a phenoxy group, a cresyloxy group, an isopropylphenoxy group, a 4-t-butylphenoxy group, a naphthoxy group and a biphenyloxy group.

Examples of the amino group represented by R²¹, R²² and R²³ include a dimethylamino group, a diethylamino group, a dibutylamino group, a dioctylamino group, a N-methyl-N-hexylamino group, a dicyclohexylamino group, a diphenylamino group and a N-methyl-N-phenylamino group.

An alkyl group, an aryl group, an alkoxy group and an aryloxy group are preferable as R²¹, R²² and R²³. It is preferable in terms of the effect of the invention that at least one of R²¹, R²² and R²³ is an alkyl group or an aryl group, and it is more preferable that at least two of them are alkyl or aryl groups. Preferably, groups represented by R²¹, R²² and R²³ are the same groups for purchasing the reagents with cheap price.

While examples (exemplified compounds 3-1 to 3-17) of the compounds capable of forming hydrogen bonds such as the compounds represented by the general formula (3) in the invention, the invention is not restricted thereto.

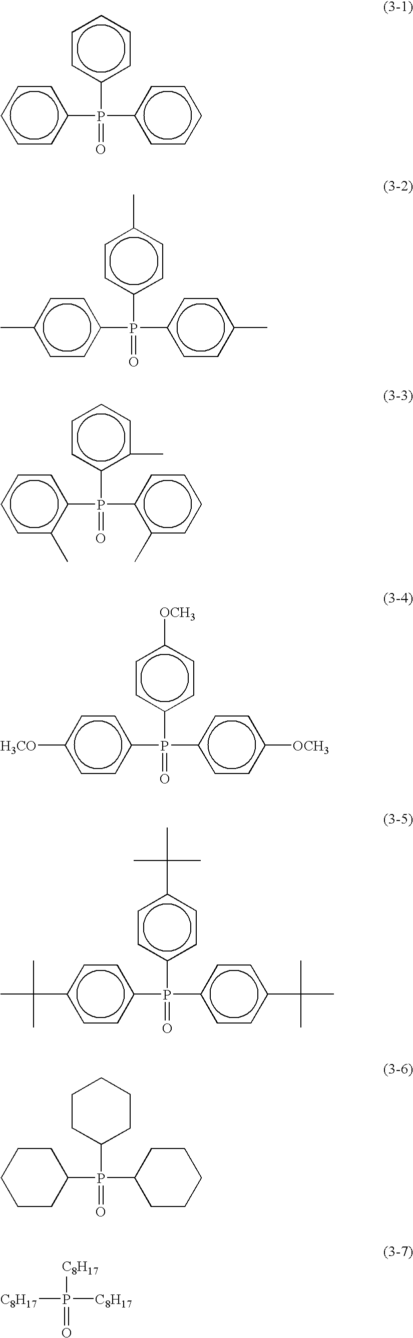

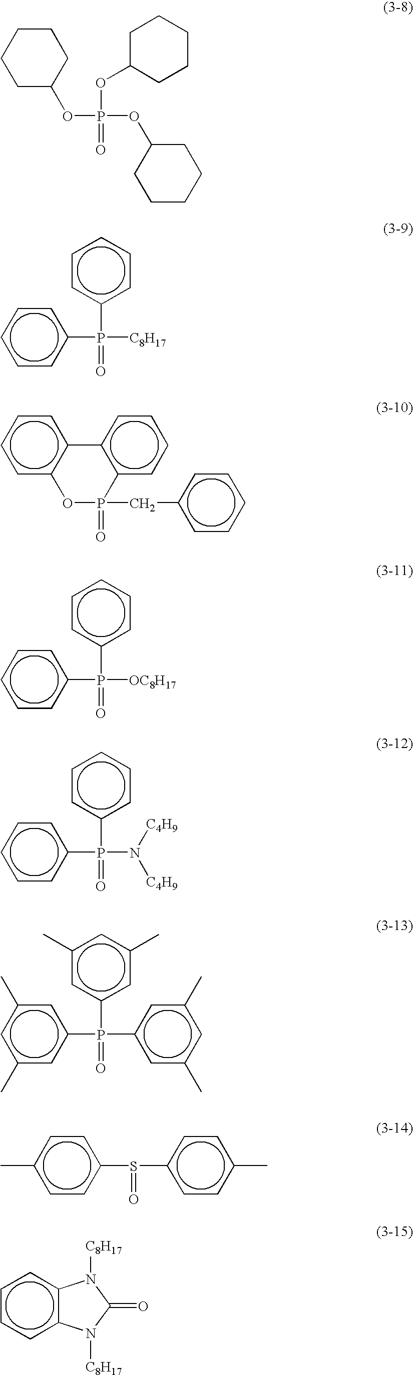

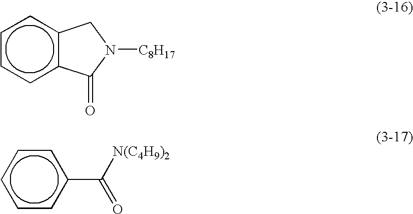

Examples of the hydrogen bond forming compounds other than those described above are described in EP NO. 1096310, and Japanese Patent Application Nos. 2000-270498 and 2000-124796.

The compound represented by the general formula (3) to be used in the invention may be used in the photosensitive material by adding in an application fluid in any form such as in solution, in emulsified dispersion and solid micro-dispersion as in the case of the reducing agent. The compounds form hydrogen bonding complexes with compounds having phenolic hydroxyl groups or amino groups, and the complex may be isolated in a crystalline state depending on the combination between the reducing agents and the compounds represented by the general formula (3). For obtaining stable performance, it is particularly preferable to use the crystalline powder isolated as described above as a dispersion of solid fine particles. In a different metod preferably used, the reducing agent and the compound represented by the general formula (3) are mixed as powders, and the complex is formed when they are dispersed with a sand grinder mill using an appropriate dispersing agent.

The compound represented by the general formula (3) is preferably used in a range of 1 to 200 mol %, more preferably in the range of 10 to 150 mol %, and still more preferably in the range of 30 to 100 mol %, relative to the reducing agent.

The halogen composition of the photosensitive silver halide to be used in the invention is not particularly restricted, and silver chloride, silver chlorobromide, silver bromide, silver iodobromide and silver iodochlorobromide may be used. Silver bromide and silver iodobromide are preferable among them. Distribution of the halogen composition in the particles may be uniform, may be discretely changed, or may be continuously changed. Silver halide particles having a core-shell structure may be preferably used. Preferably used core-shell structures include double to five-fold structures, more preferably double to four-fold structures. Preferably, a technology can be applied in which silver bromide or silver iodide is localized on the surface of the silver chloride, silver bromide or silver chlorobromide particles.

The method available for forming the photosensitive silver halide is well known in the art including those described in Research Disclosure No. 17029, June 1978 and U.S. Pat. No. 3,700,458. Specifically, the method includes, for example, adding a silver donor and halogen donor in gelatin or other polymer solutions to prepare the photosensitive silver halide, followed by mixing with the organic silver salt. The method described in the paragraph No. 0217 to 0224 in JP-A No. 11-119374, and the methods described in Japanese Patent Application Nos. 11-98708 and 2000-42336 are also preferable.

A smaller diameter of the particle size of the photosensitive silver halide particle is preferable in order to suppress turbidity after forming images, and it is actually 0.20 μm or less, more preferably 0.01 μm to 0.15 μm or less, and still more preferably 0.02 μm to 0.12 μm. The particle size as used herein refers to as the diameter when the particle is converted into a circular image having the same area as the projected area of the silver halide particles (the projected area of the major plane in case of a tabular particle).

While the shape of the silver halide particles include cubic, octahedral, tabular, spherical, rod-like and potato-like shapes, the cubic particles are particularly preferable in the invention. Particles having round corners may be also preferably used. While the face index (Miller index) of the outer surface of the photosensitive silver halide particles is not particularly restricted, it is preferable that the proportion of the {100} face having a high spectral sensitization efficiency when a spectral sensitization dye is adsorbed is high. The proportion is preferably 50% or more, more preferably 65% or more, and still more preferably 80% or more. The proportion of the face having the Miller index of {100} face can be determined by the method by T. Tani, J. Imaging Sci., 29, 165, 1985 taking advantage of adsorption dependency of the {111} face and {100} face in adsorption of a sensitizing dye.

The silver halide particles having adsorbed hexacyano metal complex on the outermost surface is preferable in the invention. The hexacyano metal complex available includes [Fe(CN)₆]⁴⁻, [Fe(CN)₆]³⁻, [Ru(CN)₆]⁴⁻, [Fe(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³ and [Re(CN)₆]³⁻. Hexacyano Fe complex is preferable in the invention.

Paired cations are not so improtant in the hexacyano metal complex since the complex is ionized in water, alkali metal ions such as sodium ion, potassium ion, rubidium ion, cesium ion and lithium ion, ammonium ion, alkylammonium ion (for example, tetramethylammonium ion, thetraethylammonium ion, tetrapropylammonium ion and terta(n-butyl) ammonium ion) are preferably used since they are suitable for precipitation operation of the silver halide emulsion.

The hexacyano metal complex may be added by mixing with a mixed solvent of water and an appropriate organic solvent being able to be mixed with water (for example, alcohols, ethers, glycols, ketones, esters and amides) or gelatin in addition to mixing with water.

The amount of addition of the hexacyano metal complex is preferably 1×10⁻⁵ mole to 1×10⁻² mole, and more preferably 1×10⁻⁴ mole to 1×10⁻³ mole, per one mole of silver.

For permitting the haxacyano metal complex to exsist on the outermost surface of the silver halide particle, the hexacyano metal complex is directly added after completing addition of an aqueous solution of silver nitrate to be used for forming the particles, before completing an addition step for a chemical sensitization step such as chalcogen sensitization including sulfur sensitization, selenium sensitization or tellurium sensitization, or precious metal sensitization such as gold sensitization, in a washing step with water, in a dispersion step, or before the chemical sensitization step. It is preferable to add the hexacyano metal complex as early as possible after forming the particles, and more preferably before the addition step, in order to inhibit the silver halide particles from growing.

Addition of the hexacyano metal complex may be initiated after adding 96% by mass, preferably 98% by mass, and still more preferably 99% by mass, of total silver nitrate added for forming the particles.

The hexacyano metal complex may be adsorbed on the outermost surface of the silver halide particles by adding the complex after adding the aqueous silver nitrate solution immediately before forming the particles, and almost all the complexes form a sparsely soluble salt with the silver ion of the surface of the particle. Since the silver salt of hexacyano iron (II) is more hardly soluble than AgI, it can prevent re-dissolution of fine particles, thereby enabling fine particles of silver halide having a small particle size.

The photosensitive silver halide particle of the invention may contain metals or metal complexes in the group 8 to 10 in the periodic table (representing group 1 to group 18). Preferable metals or the central metals of the complex belonging to the groups 8 to 10 in the periodic table are rhodium, ruthenium and iridium. These meta complexes may be used alone, or at least two kinds of the complexes of the same metal or different metals may be used together. The content is preferably in the range of 1×10⁻⁹ to 1×10⁻³ relative to one mole of silver. These heavy metals and metal complexes and methods for adding thereof are described in JP-A No. 7-225449, paragraph Nos. 0018 to 0024 in JP-A No. 11-65021, and paragraph Nos. 0227 to 0240 in JP-A No. 11-119374.

Metal atoms to be incorporated into the silver halide particles to be used in the invention (for example, [Fe(CN)₆]⁴⁻), and desalting method and chemical sensitization method for the silver halide emulsion are described in the paragraph Nos. 0046 to 0050 in JP-A No. 11-84574, paragraph Nos. 0025 to 0031 in JP-A No. 11-65021, and paragraph Nos. 0242 to 0250 in JP-A No. 11-119374.

Various kinds of gelatin may be contained in the silver halide emulsion to be used in the invention. Low molecular weight gelatin with a molecular weight of 500 to 60,000 is preferably used in order to maintain good dispersion in the application fluid containing the organic silver salt of the photosensitive silver halide emulsion. While the low molecular weight gelatin may be used in the step of forming the particles or in the dispersion step after desalting treatment, it is preferable to use in the dispersion step after the desalting step.

The sensitizing dye of the invention is able to spectrally sensitize the silver halide particles at a desired wavelength region by adsorbing on the silver halide particles, and the sensitizing dye fitted to spectral characteristics of the exposure light source may be advantageously selected. The sensitizing dye and the method for adding thereof includes the compounds described in the paragraph Nos. 0103 to 0109 in JP-A No. 11-65021, the compounds represented by the general formula (II) in JP-A No. 10-186572, the dye represented by the general formula (I) in JP-A No. 11-119374, the dyes described in the paragraph No. 0106 in U.S. Pat. No. 5,510,236 and in the example 5 in U.S. Pat. No. 3,871,887, the dyes disclosed in JP-A Nos. 2-96131 and 59-48753, and those described in line 36/p19 to line 35/p20 in EP No. 0803764A1, Japanese Patent Application Nos. 2000-86865, 2000-102560 and 2000-205399. These sensitizing dyes may be used alone, or in combination of at least two of them. In the invention, the timing for adding the sensitizing dye in the silver halide emulsion is preferably after the desalting step and before the application step, and more preferably after the desalting step and before the chemical ripening step.

While the amount of addition of the sensitizing dye in the invention may be controlled in a desired quantity considering sensitivity and fogging performance, it is preferably 10⁻⁶ to 1 mole, and more preferably 10⁻⁴ to 10⁻¹ mole per one mole of silver halide in the photosensitive layer.

A supersensitizer may be used in the invention for improving the spectral sensitization efficiency. The supersensitizer to be used in the invention includes the compounds described in EP No. 587,338, U.S. Pat. Nos. 3,877,943 and 4,873,184, JP-A Nos. 5-341432, 11-109547 and 10-111543.

The photosensitive silver halide particles in the invention are preferable subjected to chemical sensitization such as sulfur sensitization, selenium sensitization and tellurium sensitization. The compounds known in the art, for example the compounds described in JP-A No. 7-128768 and the like may be used for the sulfur, selenium and tellurium sensitization methods. The tellurium sensitization method is preferable in the invention, and the compounds described in the paragraph No. 0030 in JP-A No. 11-65021 and the compounds represented by the general formulae (II), (II) and (IV) in JP-A No. 5-313284 are more preferable.

Chemical sensitization may be applied at any time of after forming the particles and before application, and it may be preferably before spectral sensitization, (2) at the same time of spectral sensitization, (3) after spectral sensitization, (4) immediately before application, or the like.

Although the amount of use of the sulfur, selenium and trillium sensitizers is changed depending on the silver halide particles used and chemical ripening conditions, it is 10⁻⁸ to 10⁻² mole, and preferably about 10⁻⁷ to 10⁻³ mole per one mole of silver halide. While the conditions for chemical sensitization is not particularly restricted in the invention, the pH value is in the range of 6 to 11, pAg is in the range of 6 to 11, and the temperature is in the range of 40 to 90° C.

Thiosulfonic acid compounds may be added in the silver halide emulsion to be used in the invention according to the method disclosed in EP No. 293,917.

One kind of the photosensitive silver halide emulsion may be used in the invention, or at least two kinds of the photosensitive silver halide (for example, those having different average particle sizes, having different halogen compositions, having different crystal habits, or being different in the chemical sensitization conditions) maybe used together. Gradation may be controlled by using a plurality of the photosensitive silver halides having different sensitivities with each other. The arts related thereto are disclosed in JP-A Nos. 57-119341, 53-106125, 47-3929, 48-55730, 46-5187, 50-73627 and 57-150841. A sensitivity difference of 0.2 log E or more is preferable among respective emulsions.

The amount of addition of the photosensitive silver halide is preferably 0.03 to 0.6 g/m², more preferably 0.07 to 0.4 g/m², and most preferably 0.10 to 0.3 g/m² as indicated by the amount of application per 1 m² of the heat developable image recording material; or preferably 0.01 to 0.5 mole, and more preferably 0.02 mole to 0.3 mole per one mole of the organic silver salt. Particularly preferable amount is 0.03 mole to 0.2 mole.

The method and condition for mixing the independently prepared photosensitive silver halide and organic silver salt comprise mixing the independently prepared photosensitive silver halide and organic silver salt using a high speed stirrer, ball mill, sand mill, colloid mill, vibration ball mill or homogenizer; or preparing the organic silver salt by mixing the already prepared photosensitive silver halide at any timing during preparation of the organic silver salt. However, the method is not particularly restricted so long as the effect of the invention is sufficiently manifested. It is a preferable method for the photographic characteristics to mix at least two kinds of the aqueous organic silver salt dispersions and at least two kinds of the aqueous photosensitive silver salt dispersions.

While the preferable timing for adding silver halide into the application fluid of the image forming layer is from 180 minutes before application to immediately before application, preferably from 60 minutes before to 10 seconds before, the mixing method and mixing condition are not particularly restricted so long as the effect of the invention is sufficiently manifested. Examples of the mixing method comprise mixing in a tank in which the mean resident time calculated from the addition speed and flow rate to a coater is adjusted to be a desired time interval; and using a static mixer as described in chapter 8 of “Liquid Mixing Technology” by N. Harnby, M. F. Edwards and A. W. Nienow, translated by Koji Takahashi, Nikkan Kogyo Shinbun, 1989.

Any polymers may be used for the binder for the layer containing the organic silver salt (or the image forming layer) in the invention. Prefarable binders are transparent or semi-transparent and generally col, and examples of them include natural resins, polymers and copolymers; synthetic resins, polymers and copolymers; and other film forming medium such as gelatins, rubbers, polyvinyl alcohols, hydroxyethyl celluloses, cellulose acetates, cellulose acetate butylates, polyvinyl pyrrolidones, caseins, starchs, polyacrylic acids, polymethyl methacrylic acids, polyvinyl chlorides, polymethacrylic acids, styrene-maleic anhydride copolymers, styrene-acrylonitrile copolymers, styrene-butadiene copolymers, polyvinyl acetals (for example, polyvinyl formals and polyvinyl butyrals), polyesters, polyurethanes, phenoxy resins, polyvinylidene chlorides, polyepoxides, polycarbonates, polyvinyl acetates, polyolefins, cellulose esters and polyamides. The binder may be formed by coating from an aqueous solution, from an organic solution or from an emulsion.

The glass transition temperature (Tg) of the binder in the layer containing the organic silver salt is preferably 10° C. to 80° C. (referred to as a high Tg binder hereinafter), more preferably 15° C. to 70° C., and still more preferably 20° C. to 65° C. in the invention.

Tg was calculated by the following equation in the specification of the invention:

1/Tg=Σ(Xᵢ/Tg₁)

The polymer is assumed to be a copolymer of monomer components from i=1 to i=n. Xi is mass fraction of the i-th monomer (ΣX₁=1), and Tgᵢ is the glass transition temperature (in absolute temperature) of a homopolymer of i-th monomer. Σ means a sum from 1 to n. The value described in “Polymer handbook (third Edition)”., by E. H. Immergut, Wiley Interscience, 1989 was used for the glass transition temperature (Tg₁) of a homopolymer of each monomer.

The polymers as the binder may be used alone, or as a combination of at least two of them, if necessary. A combination of a polymer with a glass transition temperature of 20° C. or more and a polymer with a glass transition temperature of less than 20° C. may be used together. It is preferable that the weighted average Tg falls within the range as described above when 2 or more of the polymers having different Tg's are blended for use.

It is preferable in the invention that the layer containing the organic silver salt is formed by applying an application fluid containing 30% by mass or more of water in a solvent and drying. The performance of the binder in the layer containing the organic silver salt is improved when it is soluble or capable of being dispersed in a water based solvent (an aqueous solvent), particularly when it comprises a latex of a polymer with an equilibrium content of water at 25° C. and 60% RH of 2% by mass. The binder prepared so as to have an ionic conductance of 2.5 mS/cm is most preferable, and such binder may be prepared by purification using a functional separation membrane after synthesis of the polymer.

The water based solvent in which the polymer is soluble or capable of dispersion means water or a solvent in which 70% by mass or less of an organic solvent capable of mixing with water is added in water. Examples of the organic solvent capable of mixing with water include alcohols such as methyl alcohol, ethyl alcohol and propyl alcohol, cellosolves such as methyl cellosolve, ethyl cellosolve and butyl cellosolve, ethyl acetate and dimethyl formamide.

The term “water based solvent” as used herein refers to as a system in which the polymer is not dissolved in terms of thermodynamics, and is contained as a so-called dispersion state.

The term “equilibrium content of water at 25° C. and 60% RH” is represented as follows using the weight W1 of a polymer in equilibrium with moisture in an atmosphere at 25° C. and 60% RH, and the weight W0 of a dried polymer at 25° C.:

Equilibrium content of water at 25° C. and 60% RH={(W1−W0)/W0}×100 (% by mass)

Polymer Technology Vol. 14, Polymer Material Test Method (ed. by Polymer Association, published by Chijin Shokan Co.) may be referenced with respect to the definition of water content and the method for measuring the water content.

It is preferable in the invention that the equilibrium content of water of the binder polymer at 25° C. and 60% RH is 2% by mass or less, more preferably 0.01% by mass to 1.5% by mass, and still more preferably 0.02% by mass to 1% by mass.

Particularly preferable polymer is able to be dispersed in a water based solvent in the invention. While either a dispersion such as a latex in which fine particles of a hydrophilic polymer insoluble in water are dispersed, or a dispersion in which a latex or polymer is dispersed in a molecular level or by forming a micelle may be used, a dispersion containing dispersed latex particles is more preferable. The average particle diameter of the dispersed particles is in the range of 1 to 50,000 nm, preferably in the range of 5 to 1000 nm, more preferably in the range of 10 to 500 nm, and still more preferably in the range of 50 to 200 nm. The particle size distribution of the dispersed particles is not particularly restricted, and the particle size may be widely distributed or may be monodisperse. It is a preferable method of use for controlling the properties of the application fluid to use a mixture of 2 kind or more of particles having monodisperse particle size distribution.

Preferable examples of the polymer that is able to be dispersed in the water based solvent in the invention include hydrophobic polymers such as acrylic polymer, polyesters, rubbers (for example, SBR resins), polyurethanes, polyvinyl chlorides, polyvinyl acetates, polyvinylidene chlorides and polyolefins. These polymers may be a linear polymer, branched polymer or cross-linked polymer, or a so-called homopolymer in which a single monomer is polymerized, or a copolymer in which at least 2 kinds of monomers are polymerized. The copolymer may be a random copolymer or a block copolymer. The number average molecular weight of the polymer is 5,000 to 1,000,000, and preferably 10,000 to 200,000. The mechanical strength of the emulsion layer becomes insufficient when the molecular weight is too small, while film forming ability becomes poor when the molecular weight is too large. A cross-linked polymer latex is particularly preferable for use.

Examples of the preferable polymer latex are described below. The following examples are represented by the monomer as a starting material, the numerals in the parenthesis denotes % by mass, and the molecular weight is described in terms of a number average molecular weight. Since the concept of the molecular weight cannot be applied when functional monomers used form a cross-linked structure, they are described as “cross-linking” and description of the molecular weight is omitted. Tg means a glass transition temperature.

P-1: latex of MMA(70)-EA(27)-MAA(3)(molecular weight 37,000, Tg 61° C.)

P-2: latex of MMA(70)-2EHA(20)-St(5)-AA(5)(molecular weight 40,000, Tg 59° C.)

P-3: Latex of St(50)-Bu(47)-MAA(3) (cross-linking, Tg 17° C.)

P-4: Latex of St(68)-Bu(29)-AA(3) (cross-linking, Tg 17° C.)

P-5: Latex of St(71)-Bu(26)-AA(3) (cross-linking, Tg 24° C.)

P-6: Latex of St(70)-Bu(27)-IA(3) (cross-linking)

P-7: Latex of St(75)-Bu(24)-AA(1) (cross-linking, Tg 29° C.)

P-8: Latex of St(60)-Bu(35)-DVB(3)-MAA(2) (cross-linking)

P-9: Latex of St(70)-Bu(25)-DVB(2)-AA(3) (cross-linking)

P-10: Latex of VC(50)-MAA(20)-EA(20)-AN(5)-AA(5) (molecular weight 80,000)

P-11: Latex of VDC(85)-MAA(5)-EA(5)-MAA(5) (molecular weight 67,000)

P-12: Latex of Et(90)-MAA(10) (molecular weight 12,000)

P-13: Latex of St(70)-2EHA(27)-AA(3) (molecular weight 130,000, Tg 43° C.)

P-14: Latex of MAA(63)-EA(35)-AA(2) (molecular weight 33,000, Tg 47° C.)

P15: Latex of St(70.5)-Bu(26.5)-AA(3) (cross-linking, Tg 23° C.)

P-16: Latex of St(69.5)-Bu(27.5)-AA(3) (cross-linking, Tg 20.5° C.)

The abbreviations in the structures above denote the following monomers. MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

The polymer latex described above is commercially available including the following polymers. Examples of acrylic polymers include Cebian A-4635, 4718 and 4601 (Daicell Chemical Industries Ltd.) and Nipol Lx811, 814, 821, 820 and 857 (Nippon Zeon Co., Ltd.); examples of polyesters include FINETEX ES650, 611, 675 and 850 (Dainippon Ink and Chemicals Incorporated) and WD-size and WMS (Eastman Chemical Company); examples of polyurethanes include HYDRAN AP10, 20, 30 and 40 (Dainippon Ink and Chemicals, Incorporated); examples of rubbers include LACSTAR 7310K, 3307B, 4700H and 7132C (Dainippon Ink and Chemicals Incorporated), Nipol Lx416, 410, 438C and 2570 (Nippon Zeon Co., Ltd.); examples of polyvinyl chlorides include G351 and G576 (Nippon Zeon Co., Ltd.); examples of polyvinylidene chlorides include L502 and L513 (Ashahi Chemical Industry Co., Ltd.); and examples of polyolefins include Chemipal S120 and SA100 (Mitsui Chemicals Inc.).

These polymer latex may be used alone, or as a blend of at least 2 of them, if necessary.

Particularly, the latex of the styrene-butadiene copolymer is preferable as the polymer latex to be used in the invention. The weight ratio of the styrene monomer unit to the butadiene monomer unit in the styrene-butadiene copolymer is preferably 40:60 to 95:5. The proportion of the styrene monomer unit and butadiene monomer unit in the copolymer is preferably 60 to 99% by mass.

The polymer latex contains acrylic acid or methacrylic acid in a proportion of preferably 1 to 6% by mass, and more preferably 2 to 5% by mass, relative to the sum of styrene and butadiene in the invention. The polymer latex of the invention preferably contains acrylic acid.

The latex of the styrene-butadiene copolymer preferably used in the invention includes P-3 to P-8 and P-15 as described above, and commercially available LACSTAR-3307B, 7132C and Nipol Lx416.

Hydrophilic polymers such as gelatin, polyvinyl alcohol, methyl cellulose, hydroxypropyl cellulose and carboxymethyl cellulose may be added, if necessary, to the layer containing the organic silver salt of the photosensitive material of the invention. The amount of addition of these hydrophobic polymers is preferably 30% by mass or less, and more preferably 20% by mass or less, of the total binder in the layer containing the organic silver salt.

The layer containing the organic silver salt (the image forming layer) of the invention is preferably formed using the polymer latex. The amount of the binder in the layer containing the organic silver salt is preferably in the range of 1/10 to 10/1, more preferably 1/3 to 5/1, and still more preferably 1/1 to 3/1, in the weight ratio of total binder/organic silver salt.

The layer containing the organic silver salt is also a photosensitive layer (emulsion layer) containing the photosensitive silver halide as a photosensitive silver salt. The weight ratio of the total binder/silver halide in such case is in the range of preferably 400/1 to 5/1, and more preferably 200/1 to 10/1.

The total amount of the binder in the image forming layer of the invention is preferably in the range of 0.2 to 30 g/m², more preferably in the range of 1 to 15 g/m², and still more preferably 2 to 10 g/m². A cross-linking agent for cross-linking, and a surfactant for improving application property may be added in the image forming layer of the invention.

The solvent (the solvent and dispersing medium are represented as “solvent” herein for simplicity of the description) for the application fluid of the layer containing the organic silver salt in the photosensitive material of the invention preferably contains 30% by mass or more of water. Any organic solvents that can be mixed with water such as methyl alcohol, ethyl alcohol, isopropyl alcohol, methyl cellosolve, ethyl cellosolve, dimethylformamide and ethyl acetate may be used as the component other than water. The water content of the solvent in the application fluid is preferably 50% by mass to more preferably 70% by mass or more. Examples of the preferable solvent composition include water/methyl alcohol=90/10, water/methyl alcohol=70/30, water/methyl alcohol/dimethylformamide=80/15/5, water/methyl alcohol/ethyl cellosolve=85/10/5 and water/methyl alcohol/isopropyl alcohol=85/10/5 in addition to water (the numerals denote % by mass).

The fog preventive agent, stabilizer and stabilizer precursor that can be used in the invention include compounds described in the paragraph No. 0070 in JP-A No. 10-62899, line 57/p20 to line 7/p21 in EP No. 0803764A1, JP-A Nos. 9-281637 and 9-329864. The fog preventive agents preferably used in the invention are organic halogen compounds, and examples of them are those described in the paragraph Nos. 0111 to 0112 in JP-A No. 11-65021. Organic halogen compounds represented by the formula (P) in Japanese Patent Application No. 11-87297, organic polyhalogen compounds represented by the general formula (II) in JP-A No. 10-339934, and organic polyhalogen compounds described in Japanese Patent Application No. 11-205330 are particularly preferable.

The preferable organic polyhalogen compounds in the invention will be described in detail hereinafter. The preferable polyhalogen compounds in the invention are represented by the following general formula (4):

Q-(Y)ₙ—X(Z₁)(Z₂)X (4)

In the general formula (4), Q represents an alkyl group, an aryl group or a heterocyclic group; Y represents a divalent connection group; n represents an integer of 0 or 1; Z₁ and Z₂ represent halogen atoms; and X represents a hydrogen atom or an electron attracting group.

Q is preferably an aryl group or a heterocyclic group in the general formula (4).

When Q is a heterocyclic group in the general formula (4), it is a heterocyclic group containing one or two nitrogen atoms, and preferably a 2-pyridyl or 2-quinolyl group.

When Q represents an aryl group in the general formula (4), Q preferably represents a phenyl group substituted with electron attracting groups with a positive Hamett's substituent constant σp. The Hamett's substituent constant may be referenced in Journal of Medicinal Chemistry, 1973, Vol. 16, No. 11, pp. 1207-1216. Examples of these electron attracting groups include a halogen atom (fluorine atom (σp: 0.06), a chlorine atom (σp: 0.13), a bromine atom (σp: 0.23), an iodine atom (σp: 0.18)), a trihalomethyl group (trobromomethyl (σp: 0.29), trichloromethyl (σp: 0.33), trifluoromethyl (σp: 0.54)), a cyano group (σp: 0.66), a nitro group (σp: 0.78), an aliphatic, aryl or heterocyclic sulfonyl group (for example, methanesulfonyl group (σp: 0.72)), an aliphatic, aryl or heterocyclic acyl group (for example, acetyl group (σp: 0.50), a benzoyl group (σp: 0.43)), an alkynyl group (for example, C≡CH (σp: 0.23)), an aliphatic, aryl or heterocyclic oxycarbonyl group (for example, methoxycarbonyl (σp: 0.45) and phenoxycarbonyl (σp: 0.44)), a carbamoyl group (σp: 0.36), a sulfamoyl group (σp: 0.57), a sulfoxide group, a heterocyclic group and a phosphoryl group. The σp value is preferably in the range of 0.2 to 2.0, and more preferably in the range of 0.4 to 1.0. Preferable groups as the electron attracting group include the carbamoyl group, alkoxycarbamoyl group, alkylsulfonyl group and alkylphosphoryl group, and the carbamoyl group is most preferable among them.

X is preferably an electron attracting group, and more preferably a halogen atom, an aliphatic sulfonyl group, an arylsulfonyl group, a heterocyclic sulfonyl group, an aliphatic acyl group, an arylacyl group, a heterocyclic acyl group, an aliphatic oxycarbonyl group, an aryloxycarbonyl group, a heterocyclic oxycarbonyl group, a carbamoyl group and a sulfamoyl group, and still more preferably a halogen atom. The chlorine atom, bromine atom and iodine atom are preferable, the chlorine atom and bromine atom are more preferable, and the bromine atom is particularly preferable among the halogen atoms.

Y is preferably represents —C(C═O)—, —SO— or —SO₂—, more preferably —C(═O)— and —SO₂—, and still more preferably —SO₂—. n represents 0 or 1, and preferably 1.

While examples (exemplified compounds 4-1 to 4-23) of the compounds represented by the general formula (4) to be used in the invention are shown below, the present invention is not restricted thereto.

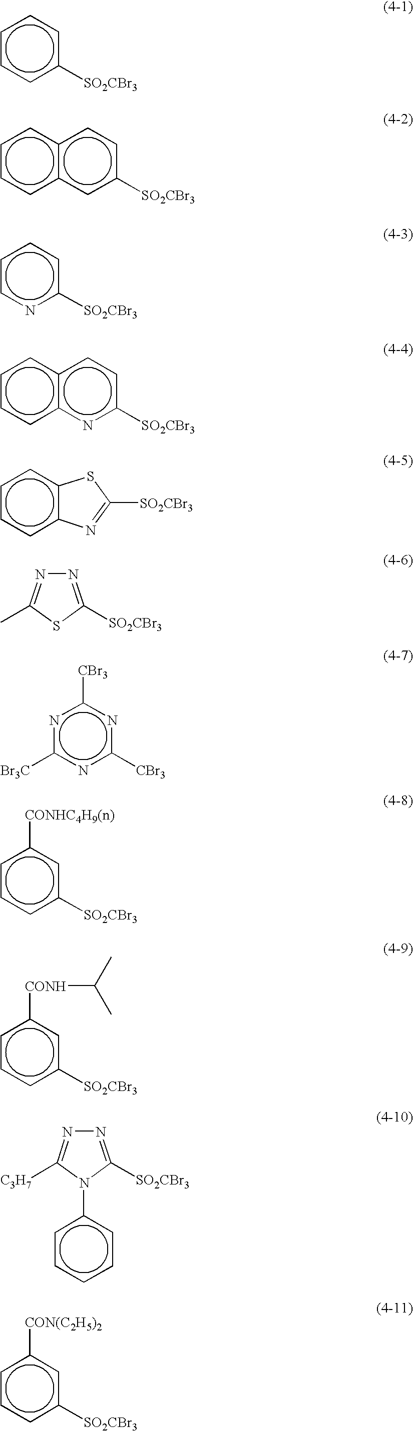

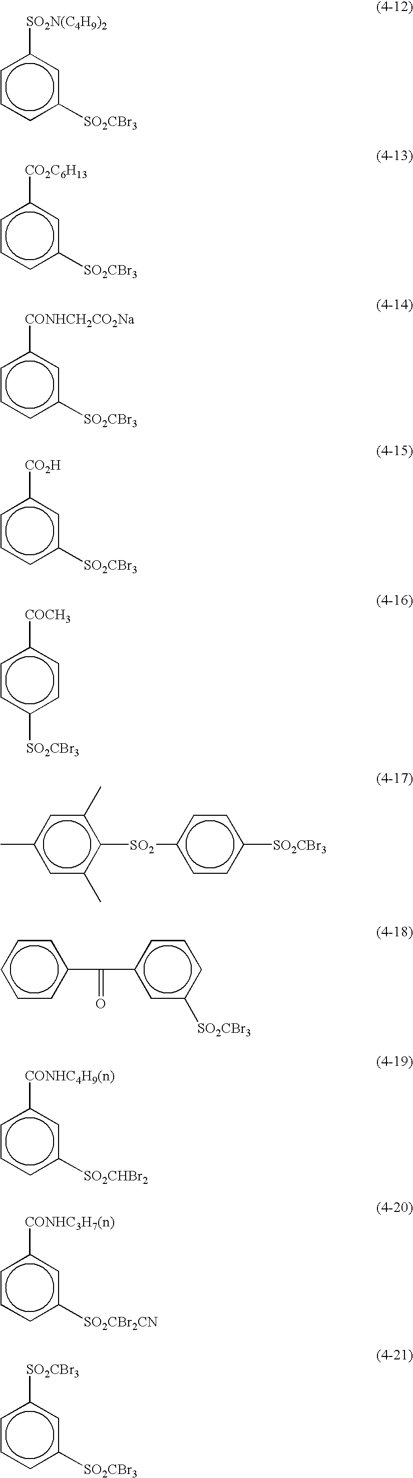

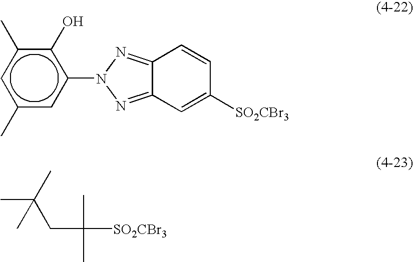

The compound represented by the general formula (4) in the invention is preferably used in the range of 1×10⁻⁴ to 1 mole, more preferably in the range of 1×10⁻³ to 0.8 mole, and still more preferably in the range of 5×10⁻³ to 0.5 mole, per one mole of the photosensitive organic silver salt in the image forming layer. Particularly preferable range is 1×10⁻² to 0.2 mole.

An example of the method for allowing the fog preventive agent to contain in the photosensitive material in the invention is described in the foregoing method for allowing the reducing agent to contain, and it is preferable to add the organic halogen compound as a dispersion of solid fine particles.

Examples of other fog preventive compounds include mercury (II) salts described in the paragraph No. 0113 and benzoic acid salts described in the paragraph No. 0114 in JP-A No. 11-65021, salicylic acid derivative in JP-A No. 2000-206642, formalin scavenger compounds represented by the formula (S) in JP-A No. 2000-221634, triazine compounds according to claim 9 in JP-A No. 11-352624, and the compound represented by the general formula (III) and 4-hydroxy-6-methyl-1,1,3a,7-tetrazaindene in JP-A No. 6-11791.

The heat developable image recording material of the invention may contain azolium salts for preventing fogging. Examples of the azolium salts include the compounds represented by the general formula (XI) in JP-A No. 59-193447, the compounds described in JP-B No. 55-12581, and the compounds represented by the general formula (II) in JP-A No. 60-153039. While the azolium salt may be added in any portions in the photosensitive material, the layer to be added is preferably the layer on the face having the photosensitive layer, and more preferably in the layer containing the organic silver salt. The azolium salts may be added at any timing for preparing the application fluid. The azolium salts may be also added at any timing from the time for preparing the organic silver alt to the time for preparing the application fluid, and the preferable timing is from after preparing the organic silver salt and to immediately before application. The azolium salt may be added by any methods including a powder, solution and dispersion of fine particles. The azolium salt may be added as a mixed solution with other additives such as a sensitizing dye, reducing agent and color control agent. While the azolium salt may be added in any amount, it is preferably 1×10⁻⁶ mole to 2 mole, and more preferably 1×10⁻³ mole to 0.5 mole.

Mercapto compounds, disulfide compounds and thione compounds may be incorporated in the present invention in order to suppress or promote development to control development, in order to improve spectral sensitization effect, and in order to improve preservative property before and after development. These compounds include those described in the paragraph Nos. 0067 to 0069 in JP-A No. 10-62899, compounds represented by the general formula (I) in JP-A No. 10-186572, and examples of the compounds are described in the paragraph Nos. 0033 to 0052 of the same publication, in lines 36 to 56 in page 20 in EP No. 0803764A1, and in Japanese Patent Application No. 11-273670. Heterocyclic aromatic compounds substituted with mercapto group are preferable among them.

The color control agent is preferably added in the heat developable image recording material. The color control agents are described in the paragraph Nos. 0054 to 0055 in JP-A No. 10-62899, lines 23 to 48 in page 21 in EP No. 0803764 μl, JP-A No. 2000-356317 and Japanese Patent Application No. 2000-187298. Particularly, phthaladinones (phthaladinone, phthaladinone derivatives or metal salts; for example, 4-(1-naphthyl)phthaladinone, 6-chlorophthaladinone, 5,7-dimethoxyphthaladinone and 2,3-dihydro-1,4-phthaladinedione); combinations of phthaladinones and phthalic acids (for example, phthalic acid, 4-methylphthalic acid, 4-nitrophthalic acid, diammonium phthalate, sodium pahtalate, potassium phthalate and terrachlorophthalic anhidride); phthaladines (phthaladine, phthaladine derivatives or metal salts; for example, 4-(1-naphthyl)phthaladine, 6-isopropylphthaladine, 6-t-butylphthaladne, 6-chlorophthaladine, 5,7-dimethoxyphthaladine and 2,3-dihydrophthaladine); combinations of phthaladines and phthalic aids are preferable, and the combination of phthaladines and phthalic acids is particularly preferable. Other particularly preferable combinations include the combination of 6-isopropylphthaladine and phthalic acid or 4-methylphthalic acid.

Plasticizers and lubricants available for the photosensitive layer in the invention are described in the paragraph No. 0117 in JP-A 11-65021, ultra-hardening agent for ultra-hard image formation and the methods and amount of addition are described in the paragraph No. 0118 in JP-A 11-65021, in the paragraph Nos. 0136 to 0193 in JP-A No. 11-223898, compounds represented by the formulae (H), (1) to (3), (A) and (B) in Japanese Patent Application No. 11-87297, compounds represented by the general formulae (III) to (V) in Japanese Patent Application 11-91652 (for example, exemplified compounds 21 to 24), and the ultra-hardening accelerators are described in the paragraph No. 0102 in JP-A No. 11-65021 and paragraph Nos. 0194 to 0195 in JP-A No. 11-223898.

Formic acid or formic acid salts to be used as a strong fogging substance may be contained in a proportion of 5 milli-mole, and preferably 1 milli-mole, per one mole of silver in the layer at the side comprising the image forming layer containing the photosensitive silver halide.

An acid formed by hydrating phosphorous pentoxide or salts thereof are preferably used together when the super-hardening agent is used in the heat developable image recording material of the invention. Examples of the acids formed by hydrating phosphorous pentoxide or salts thereof include metaphosphoric acid (or salts), pyrrophosphoric acid (or salts), orthophosphoric acid (or salts), triphosphoric acid (or salts), tetraphosphoric acid (or salts) and hexametaphosphoric acid (or salts). Preferably used acids or salts thereof formed by hydrating phosphorous pentoxide are orthophosphoric acid (or salts) and hexametaphosphoric acid (oe salts). Examples of the salts include sodium orthophosphate, sodium dihydrogen orthophosphate, sodium hexametaphosphate and ammonium hexametaphosphate.

The amount of use (amount of application per 1 m² of the photosensitive material) of the acids formed by hydrating phosphorous pentoxide or salts thereof may be arbitrarily determined depending on performance such as sensitivity and fogging, the preferable amount is 0.1 to 500 mg/m², and more preferably 0.5 to 100 mg/mh².

A surface protective layer may be provided in the heat developable image recording material for the purpose of protecting the image-forming layer from being contaminated. The surface protective layer may comprise a single layer or plural layers. The surface protective layer is described in the paragraph Nos. 0119 to 0120 in JP-A No. 11-65021 and Japanese Patent Application No. 2000-171936.

While gelatin is preferable as the binder for the surface protective layer of the invention, polyvinyl alcohol (PVA) is also preferable used alone or used together. Gelatin available includes inert gelatin (for example, Nitta gelatin 750) and phthalated gelatin (for example, Nitta gelatin 801). Examples of PVA include those described in the paragraph Nos. 0009 to 0020 in JP-A No. 2000-171936, and preferable examples include perfectly saponified PVA-105, partially saponified PVA-205 and PVA-335, and modified polyvinyl alcohol MP-203 (trade names of Kuraray Co., Ltd.). The amount of application (per 1 m² of the substrate) of polyvinyl alcohol on the protective layer (per one layer) is preferably 0.3 to 4.0 g/m², and more preferably 0.3 to 2.0 g/m².

The polymer latex is preferably used for the surface protective layer and back layer, when the heat developable image recording material of the invention is used for printing that requires little dimensional change. Such polymer latex is described in “Synthetic Resin Emulsion” ed. by Taira Okuda and Hiroshi Inagaki, Polymer Publishing Association, 1978; “Application of Synthetic Latex”, ed. by Takaaki Sugimura, Yasuo Kataoka, Sohichi Suzuki and Keiji Kasahara, Polymer Publishing Association, 1993; and “Chemistry of Synthetic Latex”, by Shoichi Muroi, Polymer Publishing Association, 1970. Examples of latex include latex of methyl methacrylate (33.5% by mass)/ethyl acrylate (50% by mass)/methacrylic acid (16.5% by mass) copolymer, latex of methyl methacrylate (47.5% by mass)/butadiene (47.5% by mass)/itaconic acid (5% by mass) copolymer, latex of ethyl acrylate/methacrylic acid copolymer, latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer, and latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass). The combination of latex described in Japanese Patent Application No. 11-6872, the technology described in the paragraph Nos. 0021 to 0025 in Japanese Patent Application No. 11-143058, the technology described in the paragraph Nos. 0027 to 0028 in Japanese Patent Application No. 11-6872, and the technology described in the paragraph Nos. 0023 to 0041 in Japanese Patent Application No. 10-199626 may be used for the binder for the surface protective layer. The proportion of the polymer latex in the surface protective layer is preferably 10% by mass to 90% by mass and particularly 20% by mass to 80% by mass of the total binder.

The amount of application (per 1 m² of the substrate) of the total binder (including the water soluble polymer and latex polymer) in the surface protective layer (per one layer) is preferably 0.3 to 5.0 g/m², and more preferably 0.3 to 2.0 g/m².

The temperature for preparing the application fluid of the image forming layer in the invention is preferably 30° C. to 65° C., more preferably 35° C. to 60° C., and still preferably 35° C. to 55° C. It is preferable that the temperature of the application fluid for the image forming layer is maintained at 30° C. to 65° C. immediately after adding the polymer latex.

The image-forming layer of the invention comprises at least one layer on the substrate. The layer comprises the organic silver salt, photosensitive silver halide, reducing agent and binder with desired color control agent, application assistant and other auxiliary agents, if necessary, when the layer is a mono-layer. When the image-forming layer comprises at least two layers, on the other hand, a first image forming layer (usually the layer adjacent to the substrate) contains the organic silver salt and photosensitive silver halide, and some other components should be contained in a second image forming layer or in both layers. The multi-color photosensitive heat developable photographic material is composed of a combination of the two layers for respective colors, or all the components may be included in a single layer as described in U.S. Pat. No. 4,708,928. In the case of a multi-die multi-color photosensitive heat developable photographic material, the emulsion layers are maintained by being distinguished with each other by using functional or non-functional barrier layers between respective layers, as described in U.S. Pat. No. 4,460,681.

Various dyes and pigments (for example C.I. Pigment Blue 60, C.I. Pigment Blue 64, C.I. Pigment Blue 15:6) may be used in the photosensitive layer of the invention for improving color tone, for preventing interference patterns from generating during laser exposure, and for protecting from irradiation. These pigments and dyes are described in detail in WO 98/36322, and JP-A Nos. 10-268465 and 11-338098.

An anti-halation layer may be provided at the side remote from a light source in the heat developable image recording material of the invention.

The heat developable photosensitive material comprises a non-photosensitive layer in addition to the photosensitive layer. The non-photosensitive layers can be classified, in terms of their arrangement, as (1) a protective layer provided on the photosensitive layer (at the remote side from the substrate), (2) an intermediate layer provided between a plurality of photosensitive layers or between the photosensitive layer and the protective layer, (3) an undercoat layer provided between the photosensitive layer and the substrate, and (4) a back layer provided at the opposed side to the photosensitive layer. A filter layer is provided in the photosensitive material as the layer (1) or (2). An anti-halation layer is provided in the photosensitive material as the layer (3) or (4).

The anti-halation layer is described in the paragraph Nos. 0123 to 0124 in JP-A No. 11-65021, JP-A Nos. 11-223898, 9-230531, 10-36695, 10-104779, 11-231457, 11-352625 and 11-352626.

The anti-halation layer contains an anti-halation dye that absorbs a light at an exposure wavelength. An infrared light absorbing dye may be used when the exposure wavelength is in the infrared region, and the dye preferably has no absorption in the visible region.

It is preferable not to substantially remain the color of the dye behind after forming images when halation is prevented using the dye having absorption in the visible region. Accordingly, It is preferable to used means for quenching the color by the heat of heat development, and it is more preferable to add a heat-quenching dye and a base precursor to allow them to function as the anti-halation layer. These technologies are described in JP-A No. 11-231457 and the like.

The amount of addition of the quenching dye is determined depending of its use. The dye is usually added in an amount so that the optical density (absorbance) exceeds 0.1 as measured at a desired wavelength. The optical density is preferably 0.2 to 2. The amount of use of the dye for obtaining such optical density is usually about 0.001 to 1 g/m².

The optical density after the heat development can be decreased to 0.1 by quenching the dye as described above. Two or more of the quenching dyes may be used together in the heat-quenching type recording material and heat developable photosensitive material. Similarly, two or more of the base precursors may be used together.

For improving the heat color-quenching property and the like, it is preferable to use a substance that decreases the melting point by 3° C. or more by mixing with the base precursor as described in JP-A No. 11-352626 (for example, diphenyl sulfone and 4-chlorophenyl(phenyl)sulfone) or 2-naphthyl benzoate for color-quenching using the dye and base precursor.

A coloring agent having an absorption maximum at 300 to 450 nm may be added in the invention for improving silver color tone and time dependent changes of the image. Such coloring agents are described in JP-A Nos. 62-210458, 63-104046, 63-103235, 63-208846, 63-306436, 63-314535 and 01-61745, and Japanese Patent Application No. 11-276751.

The coloring agent is usually added in a range of 0.1 mg/m² to 1 g/m², and is preferably added in the back layer provided at the opposit side to the photosensitive layer.

The heat developable image recording material of the invention is a so-called one face photosensitive layer comprising the photosensitive layer containing at least one layer of the silver halide emulsion layer on one side of the substrate, and the back layer on the other side thereof.

It is preferable in the invention to add a matting agent for improving transfer performance. The matting agent is described in the paragraph Nos. 0126 to 0127 in JP-A No. 11-65021. The matting agent is applied in a proportion of 1 to 400 mg/m², and more preferably 5 to 300 mg/m², as indicated by the amount of application per 1 m² of the photosensitive material.

While the shape of the matting agent may be definite or not definite, it is preferably dentine, and a spherical shape is preferably used. The average particle size is preferably 0.5 to 10 μm, more preferably 1.0 to 8.0 μm, and still more preferably 2.0 to 6.0 μm. The variation coefficient of the size distribution is preferably 50% or less, more preferably 40% or less, and still more preferably 30% or less. The variation coefficient is defined as [(standard deviation of particle size)/(average particle size)]×100. It is also preferable to use at least two kinds of the matting agents having small variation coefficients and the average particle size ratio of larger than 3.

Any degree of matting may be available so long a small white void (so-called star dust defects) are not generated and the light does not leak. The Beck smoothness is preferably 30 seconds to 2000 seconds, and more preferably 40 seconds to 1500 seconds. The beck smoothness may be readily determined by Japanese Industrial Standard (JIS) P8119 “Smoothness test Method of Paper and Paperboard” and TAPPI Standard T479.

The degree of matting of the back layer in the invention has Beck smoothness of preferably 10 seconds to 1200 seconds, more preferably 20 seconds to 800 seconds, and still more preferably 40 seconds to 500 seconds.

The matting agent is preferably contained in the outermost layer or the layer than functions as the outermost layer of the photosensitive layer, or in the layer close to the outer surface, and is preferably contained in the layer that functions as a so-called protective layer.

The back layer applicable to the invention is described in the paragraph Nos. 0128 to 0130 in JP-A No. 11-65021.

The pH of the layer surface before heat development is preferably 7.0 or less, and more preferably 6.6 or less, in the heat developable image recording material of the invention. While its lower limit is not particularly restricted, it may be about 3. The most preferable pH range is 4 to 6.2. It is preferable to use an organic acid such as a phthalic acid derivative or a non-volatile acid such as sulfuric acid for reducing the pH of the layer surface in adjusting the pH of the layer surface. Ammonia is also preferable for lowering the pH of the layer surface, since it is readily evaporated and is able to remove in the application process or before heat development.

Non-volatile bases such as sodium hydroxide, potassium hydroxide and lithium hydroxide may be preferably used together with ammonia. The method for measuring the pH of the layer surface is described in the paragraph No. 0123 in Japanese Patent Application No. 11-87297.

A layer-hardening agent may be sued in the photosensitive layer, protective layer and back layer in the invention. Examples of the layer-hardening agent are described in p77 of “The Theory of the Photographic Process” by T. H. James, Macmillan Publishing Co., Inc., published in 1977. These compounds include chromium alum, 2,4-dichloro-6-hydroxy-s-triazine sodium salt, N,N-ethylene bis(vinylsulfone acetamide) and N,N-propylene bis (vinylsulfone acetamide), as well as multivalent metal ions described in p78 in the document above and the like, polyisocyanates describe din U.S. Pat. No. 4,281,060, JP-A No. 6-208193 and the like, epoxy compounds described in U.S. Pat. No. 4,791,042 and the like, and vinylsulfone compounds described in JP-A No. 62-89048 and the like.

The layer hardening agent is added as a solution, an the timing of addition of the solution in the protective layer application fluid is from 180 minutes before application to immediately before application, preferably 60 minutes before to 10 seconds before. However, the mixing method and mixing condition are not particularly restricted so long as the effect of the present invention is well manifested. Examples of the mixing method include a method for mixing in a tank by adjusting the mean resident time calculated from the feed flow rate and feed volume to be within a desired period, and a method for using a static mixer as described in “Fluid Mixing Technology” by N. Harnby, M. F. Edwards and A. W. Nienow, translated by Koji Takahashi, Nikkan Kogyo Shinbun Co., 1989.

The surfactant applicable in the invention is described in the paragraph No. 0132 in JP-A No. 11-65021; solvents are described in the paragraph No. 0133 in the same publication, the substrate is described in the paragraph No. 0134 in the same publication, the electrification preventive layer or conductive layer is described in the paragraph No. 0135 in the same publication, the method for obtaining color images is described in the paragraph No. 0136 in the same publication, and the lubricating agent is described in the paragraph Nos. 0061 to 0064 in JP-A 11-84573 and paragraph Nos. 0049 to 0062 in Japanese Patent Application 11-106881.

Polyester heat-treated in a temperature range of 130 to 185° C., and particularly polyethylene terephthalate is preferably used for relaxing inner distortion remaining in the film during biaxial drawing and for eliminating heat contraction generated during heat development. The transparent substrate may be colored with a blue dye (for example, the dye-1 described in Example in JP-A No. 8-240877) or may be colorless in the case of the heat developable photosensitive material for medical use. It is preferable to apply undercoat technologies using water soluble polyester JP-A No. 11-84574 and styrene-butadiene copolymer described in JP-A No. 10-186565, respectively, and polyvinylidene chloride copolymers described in JP-A 2000-39684 and paragraph Nos. 0063 to 0080 in Japanese Patent Application 11-106881. Technologies described in JP-A Nos. 56-143430, 56-143431 and 58-62646, 56-120519, paragraph Nos. 0040 to 0051 in JP-A No. 11-84573, U.S. Pat. No. 5,575,957, and paragraph Nos. 0078 to 0084 in JP-A No. 11-223898 may be also applied for the electrification preventive layer or undercoat layer.

The heat developable image recording material of the invention is preferably a mono-sheet type layer (a type capable of forming images on the heat developable photosensitive material without using any other layers such as an image receiving material).

An anti-oxidation agent, a stabilizer, a plasticizer, a UV absorbing agent or a coating assistant may be further added in the heat developable image recording material. These additives may be added in either the photosensitive layer or non-photosensitive layer. WO 98/36322, EP No. 803764A1, and JP-A Nos. 10-186567 and 10-18568 may be referenced with respect to these additives.

The heat developable image recording material of the invention may be applied by any methods. Examples of them include various coating operations such as extrusion coating, slide coating, curtain coating, dip coating, knife coating, flow coating and extrusion coating using a hopper as described in U.S. Pat. No. 2,681,294. Extrusion coating or slide coating as described in pp. 399-536 in “Liquid Film Coating” by Stephen F. Kistler Petert and M. Schweizer, Chapman & Hall Co., 1997 is preferably used, and slide coating is more preferably used. The configuration of the slide coater used for slide coating is shown in FIG. 11b-1. Two or more layers may be simultaneously coated, if necessary, by the methods described in pp. 399-536 in the document above, and described in U.S. Pat. No. 2,761,791 and U.K. Patent No. 837,095.

The application fluid containing the organic silver salt in the invention is preferably a so-called thixotropic fluid. This technology may be referenced in JP-A No. 11-52509. The application fluid containing the organic silver salt of the invention has a viscosity of preferably 400 mPa·s to 100,000 mPa·s, and more preferably 500 mPa·s to 20,000 mPa·s at a shear velocity of 0.1 S⁻. The viscosity is preferably 1 mPa·s to 200 mPa·s, and more preferably 5 mPa·s to 80 mPa·s at a shear velocity of 1000 S⁻¹.

The technologies available in the heat developable image recording material of the invention include those described in EP Nos. 803764A1 and 883022A1, WO 98/36322, JP-A Nos. 56-62648, 58-62644, 9-43766, 9-281637, 9-297367, 9-304869, 9-311405, 90329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832,11-84574, 11-65021, 11-109547,11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099 and 11-343420, Japanese Patent Application Nos. 2000-187298, 2000-10229, 2000-47345, 2000-206642, 2000-98530, 2000-98531, 2000-112059, 2000-112060, 2000-112104, 2000-112064 and 2000-171936.

The photosensitive material of the invention is preferably packaged in a packaging material having a low oxygen permeability and/or moisture permeability, in order to suppress variation of photographic performance during preservation of row materials, or in order to improve curling and crimp habits. The oxygen permeability is preferably 50 ml/atm·m²·day or less, more preferably 10 ml/atm·m²·day or less, and still more preferably 1.0 ml/atm·m²·day or less. The moisture permeability is preferably 10 g/atm·m²·day or less, more preferably 5 g/atm·m²·day or less, and still more preferably 1 g/atm·m²·day or less.

Examples of the packaging materials having a low oxygen permeability and/or moisture permeability are described in JP-A Nos. 8-254793 and 2000-206653.

While the heat developable image recording material of the invention may be developed by any methods, it is usually developed by increasing the temperature of the heat developable image recording material after image-wise exposure. The development temperature is preferably 80 to 250° C., and more preferably 100 to 140° C. The development time is preferably 1 to 60 seconds, more preferably 3 to 30 seconds, still more preferably 5 to 25 seconds, and particularly 7 to 15 seconds.

While either a drum type heater or a plate type heater may be used for the heat development, the plate heater is preferable. The method described in JP-A No. 11-133572 is preferable as the heat development method using the plate heater, which is a heat development apparatus for obtaining a visible image by allowing the heat developable photosensitive material forming a latent image to contact heating means in the heat development unit. The heating means comprises the plate heater, a plurality of pressing rollers are aligned along one surface of the plate heater in opposed relation with each other, and the heat developable photosensitive material is made to pass through the space between the pressing roller and the plate heater for heat development. The plate heater is divided into 2 to 6 stages, and those at the tip has a temperature by about 1 to 10° C. lower than other stages. For example, four sets of plate heaters whose temperatures can be independently controlled are used, and respective sets are controlled at 112° C., 119° C., 121° C. and 120° C. Such method is described in JP-A No. 54-30032, which is able to discharge the moisture and organic solvents incorporated in the heat developable photosensitive material while enabling change of the shape of the substrate of the heat developable photosensitive material by rapidly heating the heat developable photosensitive material.

While the heat developable photosensitive image recording material of the invention may be exposed by any methods, a laser light is preferable as an exposure light source. The preferable lasers available in the invention include gas lasers (Ar⁺, He—Ne), YAG laser, dye laser and semiconductor laser. The semiconductor laser and a second harmonic wave generator may be also used. The gas laser or semiconductor laser emitting a red to infrared light is preferable.

An example of the medical laser imager comprising the exposure unit and heat development unit is Fuji Medical Dry laser Imager FM-DP L. FM-DP L is described in Fuji Medical Review No. 8, pp. 39-55, and the technology can be naturally applied to the laser imager of the heat developable image recording material of the invention. A net work system suitable for the DICOM standard is applicable to the heat developable image recording material for use in the laser imager in the “AD network” proposed by Fuji Medical System Co.

The heat developable image recording material of the invention is preferably used as a heat developable photosensitive material for medical diagnosis, heat developable photosensitive material for industrial photographs, heat developable photosensitive material for printing and heat developable photosensitive material for COM by forming a monochromatic image by the silver image.

A second aspect of the invention will be described in detail (detailed descriptions may be omitted when the detailed description in the first aspect of the invention is applicable).

Organic Silver Salt and Non-Photosensitive Organic Silver Salt Particles, and Method for Preparing the Same

The Organic silver salt and non-photosensitive organic silver salt particles to be used in the invention will be described hereinafter.

While the organic silver salt available in the invention is relatively stable to light, silver images are formed by heating at 80° C. or more in the presence of an exposed photo-catalyst (latent image of the photosensitive silver halide) and a reducing agent.

The organic silver salt may be any organic substances containing a source capable of reducing silver ions. Such non-photosensitive organic silver salt is described in the above-described JP-A No. 06-130543 and the like. Silver salts of organic acids, particularly silver salts of long chain aliphatic carboxylic acids (with a carbon number of 10 to 30, preferably 15 to 28) are preferable.

Preferably, silver behenate, silver archidate and silver stearate, and a mixture thereof are preferable as the silver salts of the long chin aliphatic carboxylic acids.

The content of silver behenate is preferably 90 mol % or more, more preferably 95 mol % or more, and more preferably 97 mol % or more in the heat developable photosensitive material of the invention.

The content of silver stearate is preferably 1 mol % or less, and more preferably 0.5 mol % or less with substantially no content being particularly preferable.

The content of silver arachidate is preferably 6 mol % or less, and more preferably 3 mol % or less.

While the shape of the organic silver salt available in the invention is not particularly restricted, it is a lepidoblastic shape with an aspect ratio of preferably 1 to 9, and more preferably 1 to 3.

The lepidoblastic particles of the organic silver salt, and the aspect ratio thereof, are defined as hitherto described.

In the lepidoblastic particles, “a” may be considered to be the thickness of tabular particles having a major plane with edges of “b” and “c”. The mean value of “a” is preferably 0.01 μm to 0.23 μm, and more preferably 0.1 μm to 0.20 μm.

The ratio of the equivalent-circle diameter of particle to “a” is defined as the aspect ratio in the lepidoblastic particles.

While the aspect ratio of the lepidoblastic particles of the invention is not particularly restricted, it is preferably 1.1 to 30, and more preferably 1.1 to 15. While the equivalent-circle diameter of the lepidoblastic particles of the invention is not particularly restricted, it is preferably 0.05 μm to 1 μm, and more preferably 0.1 μm to 1 μm.

Increase of fogging and color change of the image should be prevented when preserving for a long period of time or under a high temperature and high humidity environment, when the silver image is obtained by heating in the presence of the organic silver salt and reducing agent using the compound represented by the general formula (3).

A third aspect of the invention will be described in detail hereinafter (detailed descriptions may be omitted when the descriptions in the first and second aspects are applicable).

(Description of Organic Silver Salt)

While the non-photosensitive organic silver salt available in the invention is relatively stable to light, it functions as a silver ion donor when heated at 80° C. or more in the presence of the exposed photosensitive silver halide and reducing agent to form the silver image. The organic silver salt may be any organic substance that can donate silver ions being reduced by the reducing agent. Such non-photosensitive organic silver salt is described in the paragraph Nos. 0048 to 0049 in JP-A No. 10-62899, line 24/p18 to line 37/p19 in EP No. 0803764A1, EP No. 0962812A1, JP-A Nos. 11-349591, 2000-7683 and 2000-72711. Silver salts of organic acids, particularly silver salts of long chain aliphatic fatty acids (silver salts of fatty acids with a carbon number of 10 to 30, preferably 15 to 28) are particularly preferable.

Preferable examples of the fatty acid silver salts include silver lignoserinate, silver behenate, silver arachidate, silverstearate, silveroleate, silverlaurate, silver caproate, silver milistate, silver milistate and silver erucidate, and mixtures thereof.

The organic silver salt is prepared from organic acids containing behenic acid and at least an appropriate amount of erucic acid. The content of the behenic acid relative to the total organic acids is preferably 50 mol % to 99.9 mol %, more preferably 90 mol % to 99.99 mol %, and still more preferably 95 mol % to 99.99 mol %.

The content of the erucic acid is 0.000001 mol % to 0.4 mol %, preferably 0.00001 mol % to 0.1 mol %, and more preferably 0.0001 mol % to 0.01 mol % relative to behenic acid.

The heat developable photosensitive material with an excellent preservative property can be obtained with no increase of fogging by light and heat after heat development and with no need of taking care of light and heat during handling, by using the organic silver salt particles prepared from the organic acid containing behenic acid and erucic acid in the composition range as described above.

The shape of the organic silver salt particles to be used in the invention is not particularly restricted, and any shapes of needle-like, rod-like, plate-like or lepidoblastic may be use.

The lepidoblastic organic silver salt is preferable in the invention. Short needle-like, rectangular parallelepiped or cubic particles with a ratio of the major axis length to minor axis length of 5 or less, or potato-like non-definite shape particles may be also preferably used. These organic silver salt particles show less fogging as compared with long needle-like particles with a ratio of the major length axis to the minor axis length of 5 or more. Particularly, particles with a ratio of the major length axis to the minor axis length of 3 or more is preferable due to their mechanical stability.

The lepidoblastic organic silver salt particles are defined as follows in the invention. Shape of the organic silver salt particles are approximated as a rectangular parallelepiped by observing under an electron microscope. The edges of the rectangular parallelepiped are represented by “a”, “b” and “c” in the order of their shortness (“b” and “c” may be the same), and “x” is calculated from the following equation:

x=b/a

The “x” values are determined with respect to 200 particles, and the lepidoblastic particles are defined from a mean value of “x” satisfying the relation of xₘₑₐₙ≧1.5. Preferably, the mean value of “x” satisfies the relation of 30≧xₘₑₐₙ≧1.5, preferably 20≧xₘₑₐₙ≧2.0. The needle-like shape is defined to satisfy the relation of 1.5>xₘₑₐₙ≧1.

The lepidoblastic particles may be considered as tabular particles with a major plane having a thickness of “a” and edge lengths of “b”. The mean value of “a” is preferable 0.01 μm to 0.23 μm, and more preferably 0.1 μm to 0.20 μm. The mean value of c/b is preferably 1 to 6, more preferably 1.05 to 4, still more preferably 1.1 to 3, and particularly 1.1 to 2.

The particle size distribution of the organic silver salt is preferably monodisperse. Monodisperse means that the percentages of the values obtained by dividing the standard deviations of the lengths of the minor and major axes by the lengths of the minor and major axes, respectively, are preferably 100% or less, more preferably 80% or less, and still more preferably 50% or less. The shape of the organic silver salt particles can be determined by the image of the dispersed organic silver salt particles under a transmission electron microscope.

Another method for measuring monodisperse of the particles is to determine the standard deviation of the volume weighted average diameter of the organic silver salt particles. The percentage obtained by dividing the standard deviation by the volume weighted average diameter (variation coefficient) is preferably 100% or less, more preferably 80% or less, and still more preferably 50% or less. The organic silver salt dispersed in an organic solvent is irradiated with a laser beam, and the standard deviation of the volume weighted average diameter can be determined from the particle size (volume weighted average diameter) obtained by determining the auto-correlation function of the time dependent fluctuation of the scattered light.

It is more preferable that the photosensitive silver salt is not substantially contained in the organic silver salt during dispersion, since fog increases by the mingled photosensitive silver salt to remarkably decrease sensitivity. The amount of the photosensitive silver salt dispersed in the aqueous dispersion solution is preferably 1 mol % or less, more preferably 0.1 mol % or less, relative to 1 mole of the organic silver salt in the solution and, and still more preferably, the photosensitive silver salt is not purposely added.

In the invention, the photosensitive material can be manufactured by mixing an aqueous dispersion of the organic silver salt with an aqueous dispersion of the photosensitive silver salt, and the mixing ratio of the organic silver salt and photosensitive silver salt may be selected depending on the purposes. However, the ratio of the photosensitive silver salt to the organic silver salt is preferably in the range of 1 to 30 mol %, more preferably in the range of 2 to 20 mol %, and still more preferably in the range of 3 to 15 mol %. It is preferably used for controlling photographic characteristics to mix at least 2 kinds of the aqueous dispersion of the organic silver salt with at least 2 kinds of the aqueous dispersion of the photosensitive silver salt.

While a desired amount of the organic silver salt may be used in the invention, the total amount of application of silver including the photosensitive silver halide in the heat developable photosensitive material is preferably 0.1 to 5.0 g/m², more preferably 0.3 to 3.0 g/m², and still more preferably 0.5 to 2.0 g/m² as converted into the amount of the silver atom. Particularly, the total amount of application of silver is 1.8 g/m² or less, and more preferably 1.6 g/m² for improving preservative property of the image. A sufficient image density can be obtained at a low silver concentration by using the preferable reducing agent of the invention.

In the invention, the amount of erucic acid and behenic acid contained in the organic acid is quantified by a GC-FID measurement after esterification of the organic acid by treating with diazomethane at 40° C. for 30 minutes. The column used for the GC-FID measurement was DB-1 (30 m (length)×0.25 mm (diameter), df=0.25 tm). The organic acid was recrystallized using IPA when the concentration of the organic acid is large, and erucic acid remaining in the supernatant was used after concentration.

The compound represented by the general formula (2) is preferable in the invention as the reducing agent. While examples of the reducing agent in the invention are shown below, the invention is not restricted thereto.

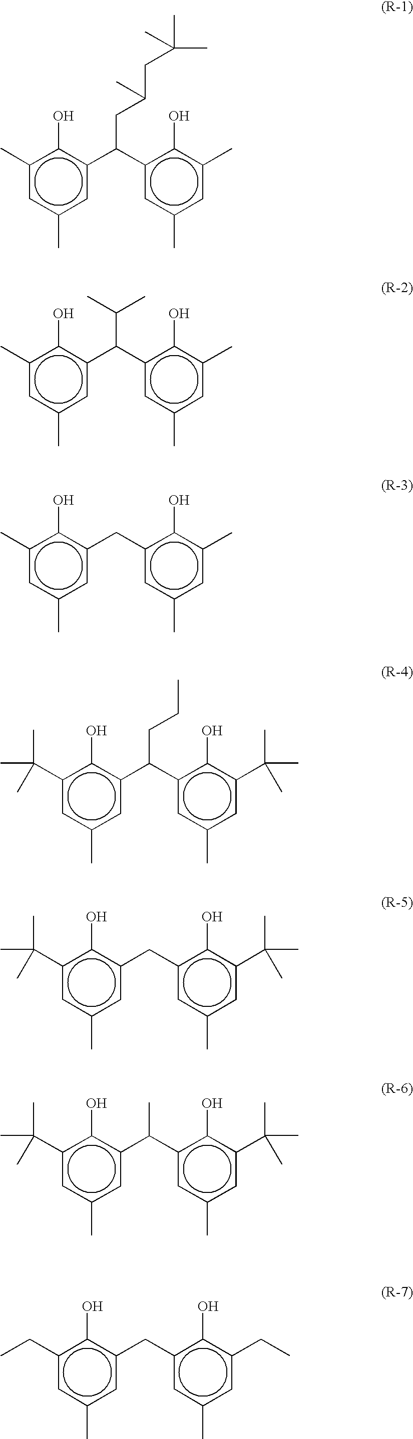

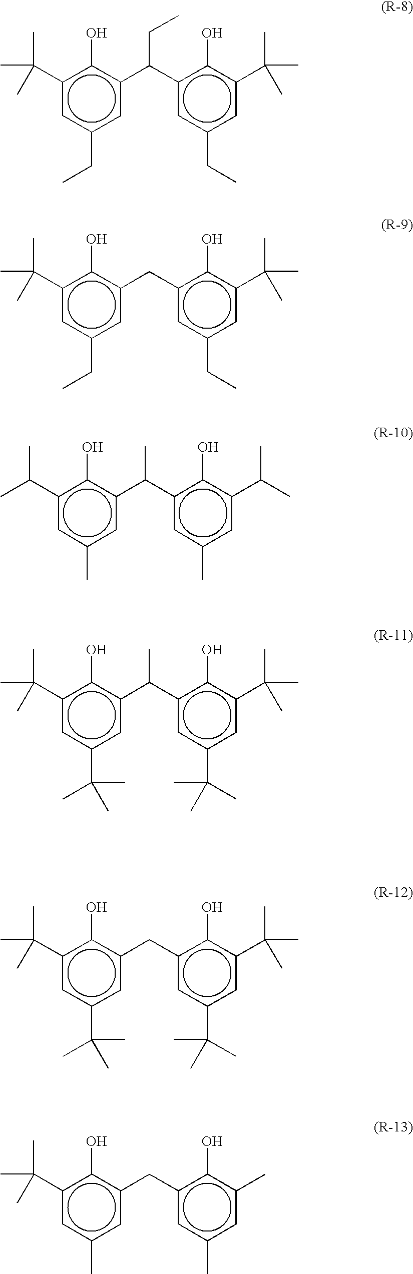

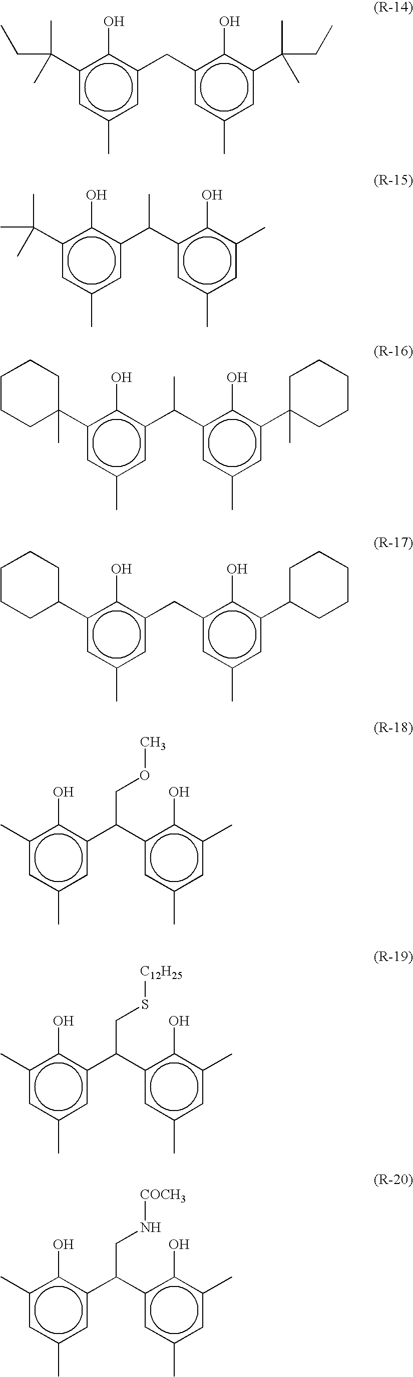

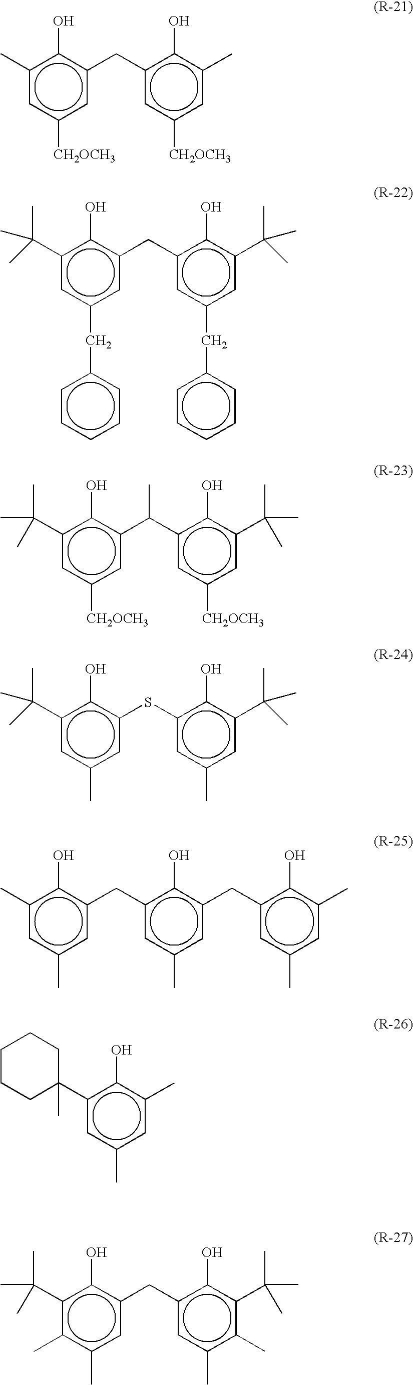

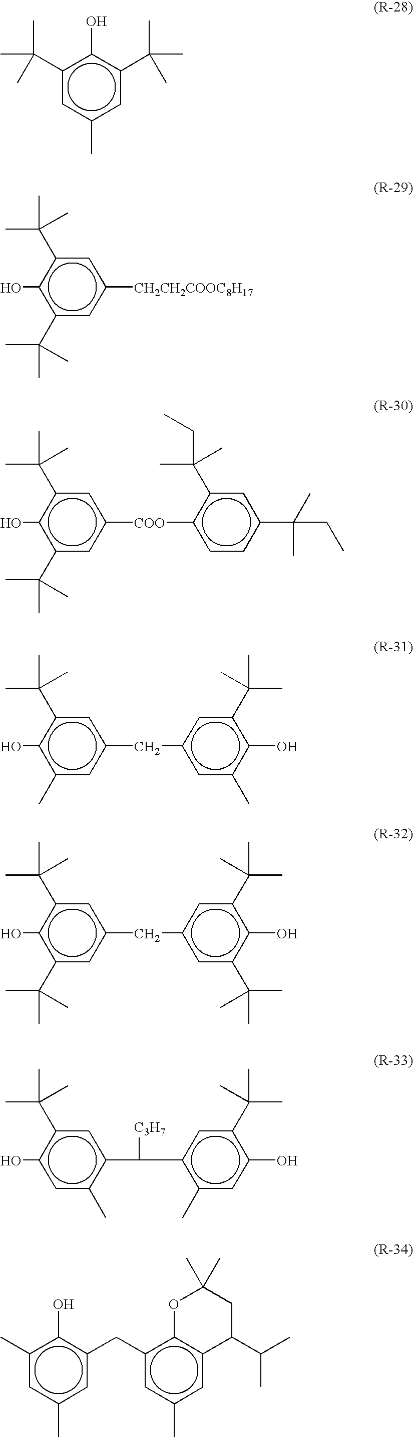

The amount of addition of the reducing agent in the invention is preferably 0.1 to 3.0 g/m², more preferably 0.2 to 1.5 g/m²₁ and still more preferably 0.3 to 1.0 g/m². The proportion of the reducing agent is 5 to 50 mol %, more preferably 8 to 30 mol %, and still more preferably 10 to 20 mol % relative to one mole of silver in the face having the image forming layer. The reducing agent is preferably added in the image-forming layer.

The reducing agent is added in the photosensitive material in any form and method including as a solution, emulsified dispersion and solid fine dispersion particles.

The emulsification and dispersion method known in the art comprises dissolving in an oil such as dibutyl phthalate, tricresyl phosphate, glyceryl triacetate or diethyl phthalate, or an auxiliary solvent such as ethyl acetate and cyclohexanone, and mechanically forming an emulsified dispersion.

The method for dispersing the solid fine particles comprises dispersing the powder of the reducing agent in an appropriate solvent such as water using a ball mill, colloid mill, vibration ball mill, sand mill, jet mill or roller mill, or by ultrasonic wave to form a solid dispersion. A protective colloid (for example, polyvinyl alcohol) and a surfactant (for example, an anionic surfactant such as sodium tri-isopropyl naphthalene sulfonate (a mixture of surfactants having different substitution sites of three isopropyl groups)) maybe used. Beads of zirconia are usually used as a dispersion medium in the mills above, and Zr and the like dissolved from the beads may be mixed with the dispersion. While the content of Zr is usually in the range of 1 ppm to 1000 ppm, an amount of Zr of 0.5 mg per 1 g of silver is practically of no problem.

It is preferable to allow an antiseptic (for example, sodium benzo-isothiazoline) to incorporate in the aqueous dispersion.

The reducing agent is preferably used as a solid dispersion in the invention.

Development Accelerator

Sulfonamide phenol based compounds represented by the general formula (A) in JP-A Nos. 2000-267222 and 2000-330234, hindered phenol based compounds represented by the general formula (II) in JP-A No. 2001-92075, hydrazine based compounds represented by the general formula (I) in JP-A Nos. 10-62895 and 11-15116 and by the general formula (I) in Japanese Patent Application No. 2001-074278, and phenol or naphtol based compounds represented by the general formula (2) in Japanese Patent Application No. 2000-76240 are preferably used as the development accelerator in the heat developable photosensitive material of the invention. These development accelerators are used in a proportion in the range of 0.1 to 20 mol %, preferably in the range of 0.5 to 10 mol %, and more preferably in the range of 1 to 5 mol %, relative to the reducing agent. While the same introduction method as used for introducing the reducing agent into the photosensitive material may be sued, it is preferable to add as a solid dispersion or emulsified dispersion. When the accelerator is added as an emulsified dispersion, it is preferably added by using a high boiling point solvent that is a solid at room temperature and a low boiling point auxiliary solvent, or as a so-called oilless emulsified dispersion with no use of the high boiling point solvent.

The hydrazine based compounds represented by the general formula (1) in Japanese Patent Application No. 2001-074278, or phenol based or naphthol based compounds represented by the general formula (2) in Japanese Patent Application No. 2000-76240 are preferable in the invention among the development accelerators above.

While preferable examples of the development accelerators of the invention are shown below, the present invention is not restricted thereto.

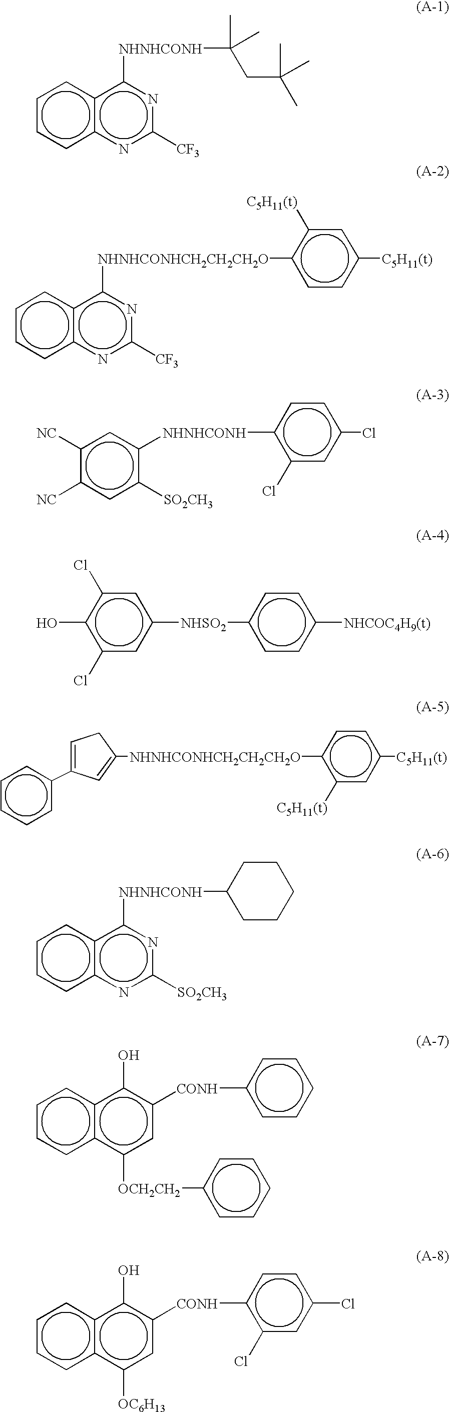

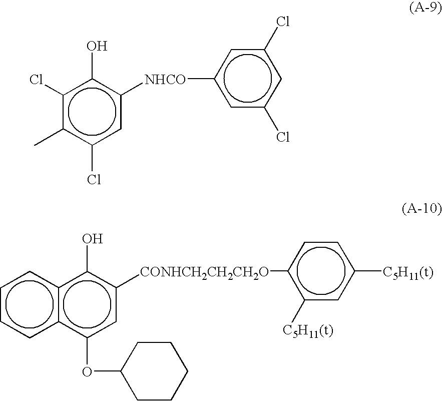

Descriptions of the hydrogen bonding compounds are basically the same as those in the first aspect of the invention. While examples of the hydrogen bonding compounds available are shown below, the invention is not restricted to these compounds.

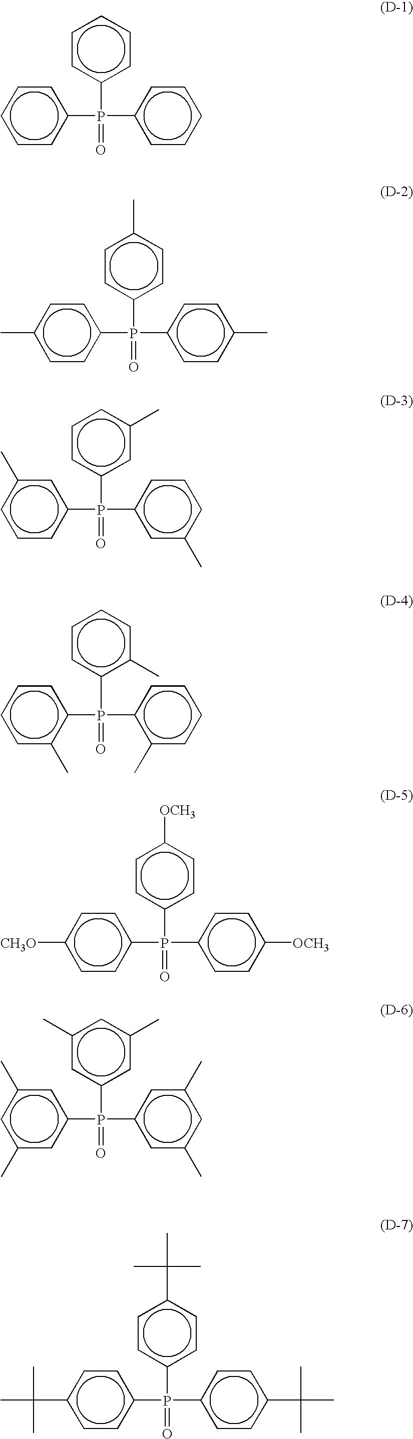

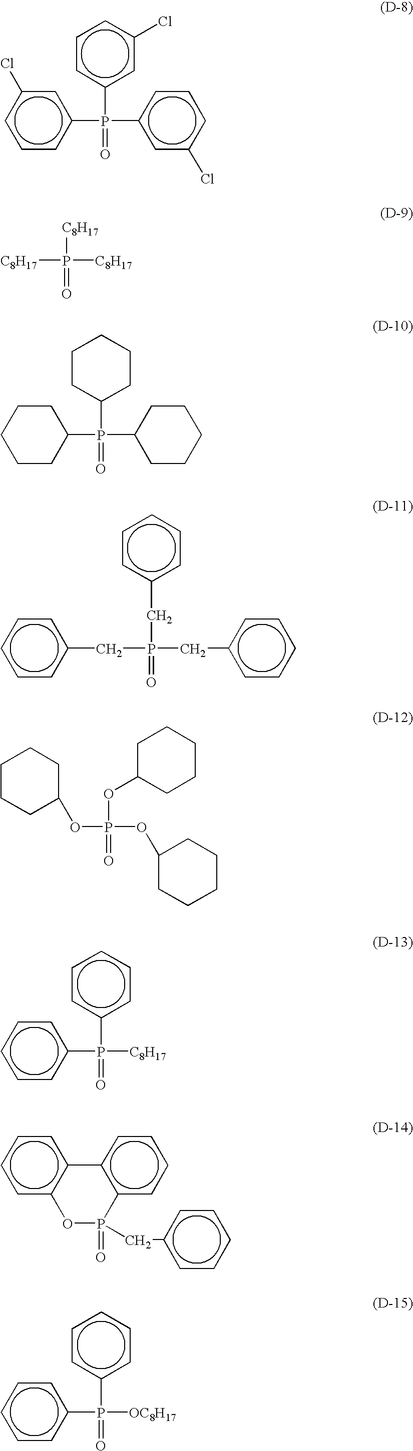

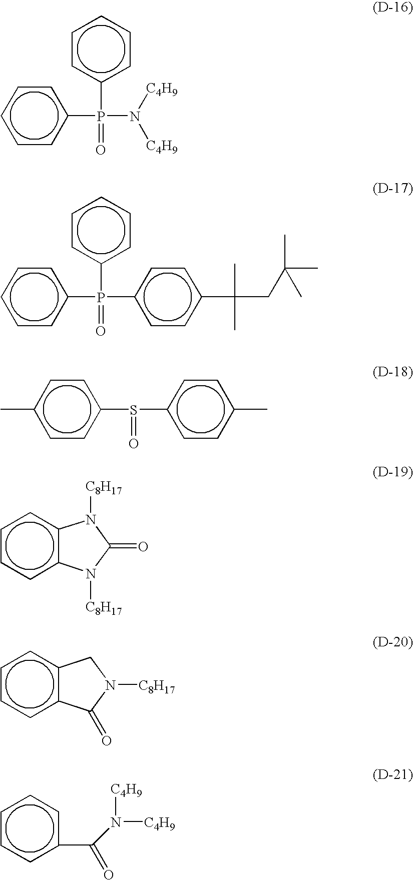

The descriptions of the silver halide in the first aspect of the invention is also used in this aspect.

Various gelatin may be used for adding in the photosensitive silver halide emulsion to be used in the invention. The photosensitive silver halide should be sufficiently dispersed in the application fluid containing the organic silver salt. The molecular weight of gelatin is preferably in the range of 10,000 to 1,000,000. Substituents of gelatin is preferably treated with phthalic acid. While gelatin may be used during granulation or dispersion after desalting treatment, it is preferable to use during granulation.

The photosensitive silver halide particles in the invention is preferably sensitized in combination with chalcogen sensitization, or chemically sensitized by itself by gold sensitization. Mono- or trivalent gold is preferable as a gold sensitizer that is a gold compound usually used. Representative examples thereof include gold chloroaurate, gold bromoaurate, potassium chloroaurate, potassium bromoaurate, auric trichloride, potassium auricthiocyanate, potassium iodoaurate, tetracyanoauric acid, ammonium aurothiocyanate and pyridil trichlorogold. Gold sensitizers described in U.S. Pat. No. 5,858,637 and Japanese Patent Application No. 2001-79450 are also preferably used.

Chemical sensitization may be applied at any time in the invention provided it is after granulation and before application, and it may be (1) before spectral sensitization, (2) simultaneously with spectral sensitization, (3) after spectral sensitization, (4) immediately before application, and the like.

While an amount of the sulfur, selenium and tellurium sensitizer used in the invention may change depending on the silver halide particles and chemical aging condition used and the like, the sensitizer is used in an amount of about 10⁻⁸ to 10⁻² mole, and preferably about 10⁻⁷ to 10⁻³ mole, per one mole of silver halide.

While the amount of addition of the gold sensitizer changes depending on various conditions, it is preferably 10⁻⁷ to 10⁻³ mole, and more preferably 10⁻⁶ to 5×10⁻⁴ mole, per one mole of silver halide.

Although the conditions for chemical sensitization in the invention is not particularly restricted, pH is about 5 to 8, pAg is about 6 to 11, and the temperature is about 40 to 95° C.

Thiosulfonic acid compounds may be added in the silver halide emulsion to be used in the invention according to the method described in EP No. 293,917.

A reduction sensitizer is preferably used in the photosensitive silver halide particles of the invention. Examples of the compounds used in the reduction sensitization preferably include ascorbic acid and thiourea dioxide, and use of stannous chloride, aminoiminomethane sulfonic acid, hydrazine derivatives, borane compounds, silane compounds, polyamine compounds and the like is preferable. The reduction sensitizer may be added at any time in the process for manufacturing the emulsion from crystal growth to immediately before application. Chemical sensitization is preferably proceeded by ripening while maintaining pH of emulsion at 7 or more or pAg thereof at 8.3 or less, respectively. Reduction is preferably sensitized by discretely introducing silver ions during granulation.

An FED sensitizer (Fragmentable electron donating sensitizer) as a compound that donate two electrons per one photon is preferably incorporated into the photosensitive silver halide emulsion in the invention. Preferable examples of the FED sensitizer is described in U.S. Pat. Nos. 5,747,235, 5,747,236, 6,054,260 and 5,994,051, and in Japanese Patent Application No. 2001-86161. The FED sensitizer is preferably added at any steps from crystal growth to immediately before application. While the amount of addition changes depending on various conditions, it is preferably about 10⁻⁷ mole to 10⁻¹ mole, and more preferably 10⁻⁶ mole to 5×10⁻² mole.

Descriptions of the binder and latex are the same as those in the first aspect.

Descriptions of the organic polyhalogen compounds are also similar to those in the first aspect of the invention. In the general formula (4), Q is preferably an aryl group or a heterocyclic group. When Q is the heterocyclic group, it is preferably a nitrogen containing heterocyclic group having one to two nitrogen atoms, and is particularly 2-pyridil group or 2-quinolyl group.

While examples of the compound represented by the general formula (4) are shown below, the present invention is not restricted thereto.

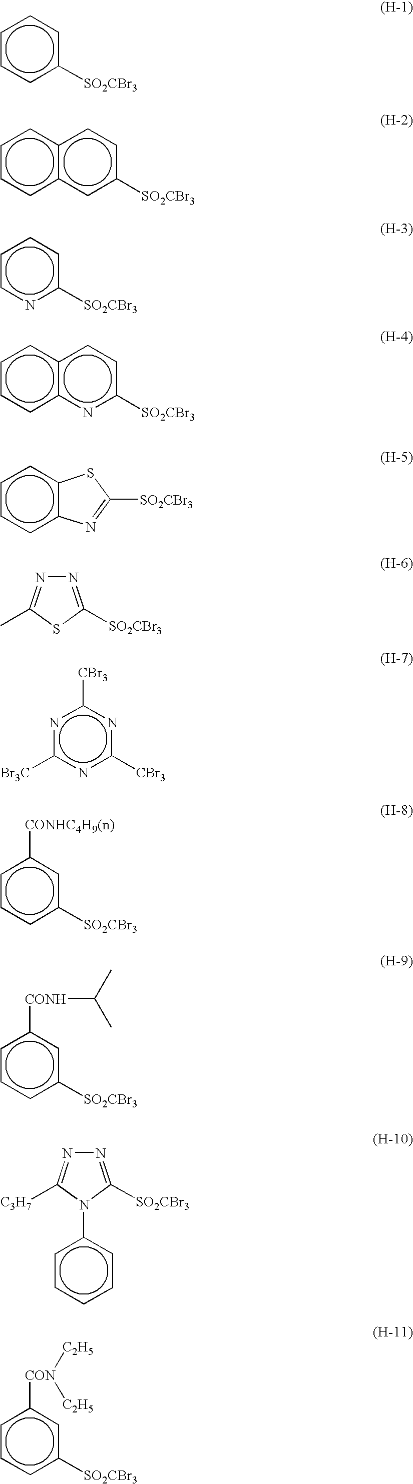

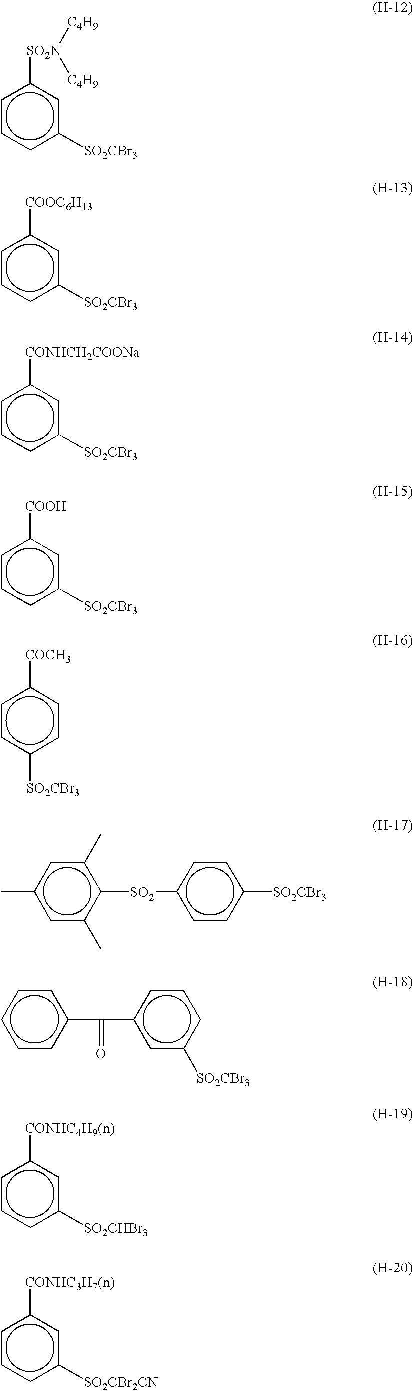

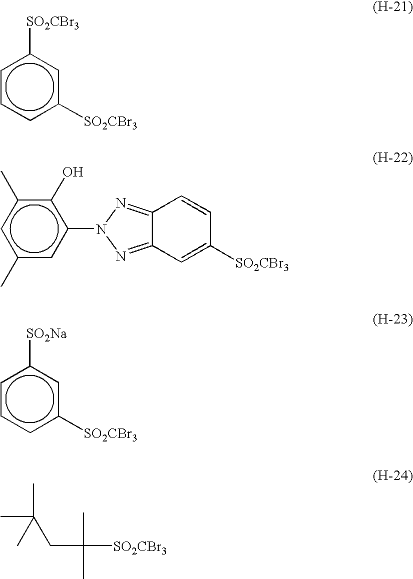

The same descriptions as those in the first aspect of the invention may be applied with respect to the fog preventive agent, color control agent, other additives, construction of the layers and matting agent.

The conductive layer containing metal oxides is preferably provided in the invention. Metal oxides in which conductivity is enhanced by introducing oxygen defects and metallic heteroatoms are preferably used as the conductive material in the conductive layer. Preferable examples of the metal oxide include ZnO, TiO₂ and SnO₂, and it is preferable to add In and Al in ZnO₂, Sb, Nb, P, halogen element and the like in SnO₂, and Nb, Ta and the like in TiO₂. Adding Sb in SnO₂ is particularly preferable. The amount of addition of the heteroatom is preferably in the range of 0.01 to 30 mol %, and more preferably 0.1 to 10 mol %. While the shape of the metal oxide may be any of spherical, needle-like and plate-like, needle-like particles with the major axis/minor axis ratio is 2.0 or more, and preferably 3.0 to 50, are used. The amount of use of the metal oxide is preferably in the range of 1 mg/m² to 1000 mg/m², more preferably 10 mg/m² to 500 mg/m². and still more preferably 20 mg/m² to 200 mg/m².

While the conductive layer of the invention may be provided at the emulsion layer side or back face side, it is preferably provided between the substrate and the back layer. Examples of the conductive layer of the invention are described in JP-A Nos. 7-295146 and 11-223901.

Fluorine based surfactants are preferably used in the invention. Examples of the fluorine based surfactant is described in JP-A Nos. 10-197985, 2000-19680 and 2000-214554. The fluorine polymer based surfactants described in JP-A No. 9-281636 are also preferably used. Use of the fluorine based surfactant descried in Japanese Patent Application No. 2000-206560 is particularly preferable.

### EXAMPLE

While the present invention is described in detail with reference to examples, the invention is not restricted to these examples.

### Example 1

(Preparation of PET Substrate)

PET with a specific viscosity IV of 0.66 (as measured in a mixed solvent of phenol and tetrachlotoethane in a ratio of 6:4 (mass ratio) at 25° C.) was obtained by a conventional method using terephthalic acid and ethylene glycol. The polymer was formed into a pellet, dried at 130° C. for 4 hours, and was extruded from a T type die after melting at 300° C. followed by quenching, thereby obtaining a non-drawn film with a thickness of 175 μm after heat curing.

The film was drawn 3.3 times using three rolls with different circumference speeds with each other in the longitudinal direction, and subsequently drawn 4.5 times in the transverse direction using a tenterhook. The temperatures for both draw treatments were 110° C. and 130° C., respectively. After heat-curing the film at 240° C. for 20 seconds, it was relaxed by 4% in the transverse direction at the same temperature. After slitting the chuck portion, null processing was applied at both ends, and the film was wound under a load of 4 kg/cm² (4×10⁴ Pa) to obtain a roll with a thickness of 175 μm.

(Surface Corona Treatment)

Both surfaces of the substrate was processed at 20 m/minute using a corona processor (made by Piller Co., solid state 6 KVA model). It was confirmed that the substrate was treated at 0.375 kV·A·minute/m² from the applied electric current and voltage. The treatment frequency was 9.6 kHz, and the gap clearance between the electrode and the dielectric roll was 1.6 mm.

(Preparation of Undercoat Substrate)

(1) Preparation of Application Fluid for Undercoat Layer Recipe (i) (for Photosensitive Layer Side Undercoat Layer)

(1) Preparation of application fluid for undercoat layer

| | |
|---|---|
| Recipe (i) (for photosensitive layer side undercoat layer) | |
| Pesresin A-515GB (30% by mass solution) made by Takamatsu | 234 g |
| Oil & Fat Co., Ltd. | |
| polyethyleneglycol monononylphenyl ether | 21.5 g |
| (mean ethylene oxide number = 8.5, 10% by mass solution) | |
| MP-1000 made by Soken Chemical & Engineering Co., | 0.91 g |
| Ltd. | |
| (fine polymer particle, average particle diameter 0.4 μm) | |
| distilled water | 744 ml |
| Recipe (ii) (for back face first layer) | |
| styrene-butadiene copolymer latex | 158 g |
| (solid fraction 40% by mass, styrene/butadiene weight | |
| ratio = 68/32) | |
| 8% by mass of aqueous 2,4-dichloro-6-hydroxy-S-triazine | 20 g |
| sodium salt solution | |
| 1% by mass of aqueous sodium laurylbenzene sulfonate | 10 ml |
| distilled water | 854 ml |
| Recipe (iii) (for back face second layer) | |
| SnO₂/SbO (mass ratio 9/1, average particle diameter 0.038 | 84 g |
| μm, 17% by weight dispersion) | |
| gelatin (10% by mass aqueous solution) | 89.2 g |
| metholose TC-5 (1% by mass aqueous solution, made by | 8.6 g |
| Shin-Etsu Chemical Co., Ltd.) | |
| MP-1000 (made by Soken Chemical & Engineering Co., | 0.01 g |
| Ltd.) | |
| 1% by mass aqueous sodium dodecylbenzene sulfonate | 10 ml |
| solution | |
| NaOH (1% by mass) | 6 ml |
| Proxel (made by ICI Co.) | 1 ml |
| distilled water | 805 ml |

(2) Preparation of Undercoat Substrate

After applying corona discharge treatment on both surfaces of the biaxially drawn polyethylene terephthalate with a thickness of 175 μm, the overcoat application fluid of the recipe (i) above was coated on one face (photosensitive layer face) with a wire bar with an wet coating amount of 6.6 ml/m² followed by drying at 180° C. for 5 minutes. Then, the overcoat application fluid of the recipe (ii) was coated on the back face of the substrate with the wire bar with an wet coating amount of 5.7 ml/M² followed by drying at 180° C. for 5 minutes. Subsequently, the overcoat application fluid of the recipe (iii) was coated on the back face of the substrate with the wire bar with an wet coating amount of 7.7 ml/m² followed by drying at 180° C. for 6 minutes, thereby preparing an undercoat substrate.

(Preparation of Back Face Application Fluid)

(1) Preparation of Dispersion Solution (a) of Solid Fine Particles of Base Precursor

Mixed with 220 ml of distilled water were 64 g of a base precursor compound 11, 29 g of diphenylsulfone and 10 g of a surfactant (Demol N made by Kao Corporation), and the mixture was dispersed with a sand mill (¼ gallon sand grinder mill, made by I.mecs Co.) using beads to obtain a dispersion solution (a) of solid fine particles of a base precursor compound with an average particle diameter of 0.2 μm.

(2) Preparation of Dispersion Solution of Solid Fine Particles of Dye.

Mixed with 305 ml of distilled water were 9.6 g of a cyanine dye compound 13 and 5.8 g of sodium p-dodecylbenzene sulfonate. The mixed solution was dispersed with a sand mill (¼ gallon sand grinder mill, made by I.mecs Co.) to obtain a dispersion solution of solid fine particles of dye with an average particle diameter of 0.2 μm.

(3) Preparation of Halation Preventive Layer Application Fluid

Mixed were 17 g of gelatin, 9.6 g of polyacrylamide, 70 g of the dispersion solution (a) of solid fine particles of the base precursor, 56 g of the dispersion solution of solid fine particles of the dye, 1.5 g of monodisperse fine particles polymethyl methacrylate (average particle size: 8, standard deviation of particle diameter: 0.4), 0.03 g of benzoisothiazolinone, 2.2 g of sodium polyethylene sulfonate, 0.2 g of a blue dye compound 14, 3,9 g of an yellow dye compound 15, and 844 ml of water to prepare a halation preventive application fluid.

(4) Preparation of Application Liquid for Back Face Protective Layer

After keeping the temperature of a vessel at 40° C., 50 g of gelatin, 0.2 g of sodium polystyrenesulfonate, 2.4 g of N,N-ethylenebis(vinylsulfone acetamide), 1 g of sodium tert-octylphenoxyethoxyethane sulphonate, 30 mg of benzoisothiazolinone, 37 mg of fluoride based surfactant (F-1: N-perfluorooctylsulfonyl-N-propylalanine potassium salt),0.15 g of fluorine based surfactant (F-2: polyethyleneglycol mono(N-perfluorooctylsulfonyl-N-propyl-2-aminoethyl)ether [mean degree of polymerization of ethylene oxide; 15]), 64 mg of fluorine based surfactant (F-3), 32 mg of fluorine based surfactant (F-4), 8.8 g of acrylic acid/ethyl acrylate copolymer (copolymerization ratio 5/95), 0.6 g of aerosol OT (made by American Cyanamid Co.), 1.8 g of liquid paraffin as a liquid paraffin emulsion, and 950 ml of water were mixed to prepare an application fluid for the back face protective layer.

(Preparation of Silver Halide Emulsion)

<<Preparation of Silver Halide Emulsion A>>

3.1 ml of 1% by mass potassium bromide solution was added in 1421 ml of distilled water, followed by adding 3.5 ml of 0.5 mole/L sulfuric acid and 31.7 g of gelatin modified with phthalic acid. The solution was kept at 30° C. with stirring in a stainless steel reaction vessel. A solution (a) prepared by adding distilled water to 22.22 g of silver nitrate to make 95.4 ml solution, and a solution (b) prepared by diluting 15.3 g of potassium bromide and 0.8 g of potassium iodide to make 97.4 ml solution by adding distilled water, were added within 45 seconds at a constant flow rate.

Then, 10 ml of 3.5% by mass of aqueous hydrogen peroxide solution, and 10.8 ml of 10% by mass of aqueous benzoimidazole solution were added.

Subsequently, a solution (c) prepared by diluting 51.86 g of silver nitrate to 317.5 ml by adding water, and a solution (d) prepared by diluting 44.2 g of potassium bromide and 2.2 g of potassium iodide to 400 ml by adding distilled water were added within 20 minutes. The flow rate of the solution (c) was kept constant, while the solution (d) was added by a controlled double jet method so as to maintain pAg at 8.1.

Potassium hexachloroiridate (III) was added 10 minutes after starting of addition of the solutions (c) and (d) so that the proportion of the iridium becomes 1×10⁻⁴ mole per one mole of silver. An aqueous solution of potassium hexacyano iron (II) was also added 5 seconds after completing the addition of the solution (c) so that the proportion of iridium becomes 3×10⁻⁴ mole per one mole of silver. The pH of the solution was adjusted to 3.8 using 0.5 mole/L sulfuric acid, followed by precipitation, desalting and washing with water by stopping stirring.

The solution was adjusted to pH 5.9 with 1 mole/L sodium hydroxide solution, and a dispersion of silver halide with pAg of 8.0 was prepared.

Chemical sensitization was performed as follows. The silver halide dispersion was maintained at 38° C. with stirring, and 5 ml methanol solution of 0.34% by mass of 1,2-benzointhiazoline-3-one was added. After 40 minutes, a methanol solution containing the spectral sensitizing dye (a) and spectral sensitizing dye (b) in 1:1 molar ratio was added with a combined proportion of the spectral sensitizing dyes (a) and (b) of 1.2×10⁻³ mole per one mole of silver, and the temperature of the solution was increased to 47° C. after 1 minute.

After 20 minutes of the temperature increase, sodium benzenesulfonate was added in a proportion of 7.6×10⁻⁵ mole per one mole of silver and, 5 minutes thereafter, the tellurium sensitizer B was added in a proportion of 3.5×10⁻⁴ mole per one mole of silver with ripening for 91 minutes. Subsequently, 1.3 ml of 0.8% by mass methanol solution of N,N′-dihydroxy-N″-diethylamine was added and. 4 minutes thereafter, a methanol solution of 5-methyl-2-mercaptobenzimidazole (MMBI) and a methanol solution of 1-phenyl-2-heptyl-5-merapto-1,3,4-triazole (PHMT) were added in the proportions of 4.8×10⁻³ mole and 5.4×10⁻³ mole, respectively, per one mole of silver, thereby preparing the silver halide emulsion A.

The particles in the silver halide particles prepared were silver bromide particles with an average equivalent-circle diameter of 0.042 μm with a variation coefficient of 20% uniformly containing 3.5 mole of iodine. The particle size or the like was determined as a mean value of the diameters of 1000 particles using an electron microscope. The proportion of the {100} face of this particle was determined to be 80% using a Kubelka-Munk method.

<<Preparation of Silver Halide Emulsion B>>

The silver halide emulsion B was prepared by the same method used in preparation of the silver halide emulsion A, except that the liquid temperature for forming the particles was changed from 30° C. to 49° C., the volume of the solution (b) was changed by diluting 15.9 g of potassium bromide to 97.4 ml by diluting with distilled water, the volume of the solution (d) was changed by diluting 45.8 g of potassium bromide to 400 ml by diluting with distilled water, the time for adding the solution (c) was changed to 30 minutes, and potassium hexacyano iron (II) was not added. Precipitation, desalting, washing with water and dispersion were also carried out as in the preparation of the silver halide (1). Chemical sensitization was performed as follows. The amount of addition of a methanol solution, containing the spectral sensitizing dye (a) and spectral sensitizing dye (b) in 1:1 molar ratio, was changed to 7.5×10⁻⁴ mole per one mole of silver as a sum of the spectral sensitizing dyes (a) and (b). The amount of addition of the tellurium sensitizer B was changed to 4.3×10⁻⁵ mole per one mole of silver. The amount of addition of 5-methyl-2-mercaptobenzimidazole (MMBI) as a methanol solution was changed to 1.8×10⁻³ mole per one mole of silver, and the amount of addition of 1-phenyl-2-heptyl-5-mercapto-1,3,4-triazole (PHMT) was changed to 3.3×10⁻³ mole per one mole of silver. Spectral sensitization and chemical sensitization conditions as well as addition of 5-methl-2-mercaptobenzimidazole and 1-phenyl-2-heptyl-5-mercapto-1,3,4-triazole were carried out as in preparing the silver halide emulsion A, thereby obtaining the silver halide emulsion B. The particles of the silver halide emulsion (2) were cubic particles of pure silver halide with an average equivalent-circle diameter of 0.08 μm and variation coefficient of the equivalent-circle diameter of 15%.

<<Preparation of Silver Halide Emulsion C>>

The silver halide emulsion C was obtained by the same method as preparing the silver halide particle A, except that 1.4×10³ mole of a sum of the spectral sensitizing dyes (a) and (b) was added per one mole of silver for chemical sensitization, and an aqueous solution of a mercapto compound (exemplified compound 1-17) as a compound represented by the general formula (1) was prepared as shown below and added in a proportion of 1.3×10⁻² mole per one mole of silver, in place of adding 5-methyl-2-meraptobenzimidazole and 1-phenyl-2-heptyl-5-mercapto-1,3,4-triazole. The particles of the silver halide emulsion C had an average equivalent-circle diameter of 0.042 μm and the variation coefficient of the equivalent-circle of 20%. The silver halide particles were silver iodide particles with uniformly distributed iodine proportion of 3.5 mol %.

<<Preparation of Compound Represented by the General Formula (1)>>

After completely dissolving 2 g of the mercapto compound (1-17) by adding 0.34 g of NaOH and 100 ml of water, pH of the solution was adjusted to 7.0 with citric acid.

<<Preparation of Silver Halide Emulsion D>>

The silver halide emulsion D was obtained by the same method as preparing the silver halide emulsion B, except that the aqueous solution of the mercapto compound (1-17) prepared as described above was added in a proportion of 4.7×10⁻² mole per one mole of silver in place of adding 5-methyl-2-mercaptobenzimidazole and 1-phenyl-2-heptyl-5-mercapto-1,3,4-triazole.

(Preparation of Organic Acid Silver Salt Dispersions A to G)

Mixed were 258.5 mole of an organic acid, 423 L of distilled water, 49.2 L of 5 mole/L aqueous NaOH solution and 120 l of t-butanol in a composition ratio as shown in Table 1, and the mixture was allowed to react at 75° C. for 1 hour with stirring to obtain a solution of sodium salt of the organic acid.

Separately prepared was 206.2 L of an aqueous solution (pH 4.0) containing 40.4 kg of silver nitrate, and the solution was kept at 10° C. A reaction vessel containing 635 L of distilled water and 30 L of t-butanol was kept at 30° C., the total volume of the organic acid sodium solution and the total volume of the aqueous silver nitrate solution were added, respectively, in 93 minutes and 14 seconds and 90 minutes at a constant flow rate with thorough stirring. Only the aqueous silver nitrate solution was added for 11 minutes after initiating addition of the aqueous silver nitrate solution, addition of the organic acid sodium salt was started thereafter, and only the organic acid sodium salt was added for 14 minutes and 15 seconds after completing addition of the aqueous silver nitrate solution.

The reaction temperature in the reaction vessel was adjusted as described in Table 1, and the external temperature was controlled so as to maintain the constant temperature of the reaction solution. The piping system for adding the organic acid sodium salt was kept at a constant temperature by circulating warmed water at the outer space of the double wall pipe, so that the liquid temperature of the outlet at the tip of the nozzle is controlled at 75° C. The temperature in the piping system of the aqueous silver nitrate solution was maintained by circulating cooled water in the outer space of the double wall pipe. The position of addition of the organic acid sodium salt and the position of addition of the aqueous silver nitrate were disposed in symmetrical relation with each other relative to the center of the stirrer axis, and the positions were adjusted so as not to touch the reaction solution.

TABLE 1

| | unit: mol % | | | |
|---|---|---|---|---|
| Dispersion of organic | Silver | Silver | Silver | Silver |
| acid silver salt | stearate | arachidate | behenate | lignocerate |
| A | 5.0 | 6.0 | 87.0 | 2.0 |
| B | 1.5 | 8.5 | 87.0 | 3.0 |
| C | 1.0 | 6.0 | 91.0 | 2.0 |
| D | 1.5 | 7.0 | 91.0 | 1.5 |
| E | 1.0 | 3.0 | 94.0 | 2.0 |
| F | 0.5 | 2.0 | 95.0 | 2.5 |
| G | 0 | 0.7 | 96.5 | 1.8 |

Reaction temperature in reaction vessel: 30° C.

<<Ripening/Centrifugal Filtration>>

After completing addition of the organic acid sodium solution, the solution was left at that temperature with stirring for 20 minutes. The temperature was increased to 35° C. in 30 minutes, followed by ripening for 210 minutes. The solid fraction was filtered off by centrifugal filtration immediately after ripening, and was washed with water until the conductivity of water after filtration of the solid fraction decreases to 30 μS/cm. The wet cake was made to be a slurry by adding pure water followed by filtration, and this procedure was repeated 3 times in order to facilitate conductivity to decrease. The wet cake of organic silver was centrifuged under a centrifugal force G of 700 for 1 hour. G is represented by 1.119×10⁻⁵×radius of vessel (cm)×rotational speed (rpm)². The solid fraction of the wet cake of the organic acid silver salt (as measured by drying 1 g of the wet cake at 110° C. for 2 hours) thus obtained was 44%.

<<Preliminary Dispersion>>

Added to the wet cake corresponding to 260 kg of the dried solid fraction were 19.3 g of polyvinyl alcohol (trade name: PVA-217) and water, 1000 kg in total of the mixture was formed into a slurry with a dissolver blade, and was further preliminarily dispersed with a pipe line mixer (PM-10 made by Mizuho Industries Co.).

<<Final Dispersion>>

The starting liquid after pre-dispersion was processed three times by adjusting the pressure of the dispersing device (trade name: Microfluidizer M-610 using a Z-type interaction chamber made by Micro-Fluidex International Corporation) at 1260 kg/cm² (12.6 MPa) to obtain a dispersion of the organic acid silver salt (dispersion of silver behenate). The characteristic values of the shape of the dispersion was the same as those after washing with water. The dispersion was cooled by providing coil-type heat exchangers at the front and rear sides of the interaction chamber, and the dispersion temperature was adjusted to 18° C. by controlling the temperature of the coolant.

The volume weighted average diameter (the equivalent-circle diameter) was 0.48 μm, the variation coefficient of the volume weighted average diameter was 23%, the ratio of the major axis “c” to the minor axis “b” of particle (the longitudinal to transverse ratio) was 1.4, and the aspect ratio was 2.4 with respect to the organic silver salt particles contained in the organic silver salt dispersion F. The particle size was measured with Master Sizer X made by Malvern Instruments Ltd.

<<Preparation of Dispersion of Reducing Agent 1>>

Added into 10 kg of the reducing agent-1 (1,1-bis(2-hydroxy-3,5-dimethylphenyl)-3,5,5-trimethylhexane) and 10 kg of 20% by mass of aqueous solution of modified polyvinyl alcohol (Poval MP203 made by Kuraray Co., Ltd.) was 16 kg of water, and the mixture was thoroughly stirred to form a slurry.

The slurry was sent with a diaphragm pump, and after dispersing for 3 hours and 30 minutes using a horizontal type sand mill filled with zirconia beads with an average diameter of 0.5 mm, the concentration of the reducing agent was adjusted to 25% by mass by adding 0.2 g of sodium benzoisothiazolinone and water to obtain the reducing agent-1 dispersion.

The reducing agent particles contained in the reducing agent-1 dispersion had a median diameter of 0.42 μm and a maximum particle diameter of 2.0 μm. The educing agent-1 dispersion obtained was filtered with a polypropylene filter with a pore diameter of 10.0 μm to remove foreign substances such as dusts.

<<Preparation of Dispersion of Reducing Agent-2>>

A slurry was prepared by mixing 10 kg of the reducing agent-2 (2,2′-isobutylifdene-bis-(4,6-dimethyloenol)) and modified polyvinyl alcohol (Poval MP203 made by Kuraray Co., Ltd.) with 16 kg of water with thorough stirring.

The slurry was sent with a diaphragm pump, and after dispersing for 3 hours and 30 minutes with a horizontal sand mill (UVM-2 made by I.mecs Co.) filled with zirconia beads with an average diameter of 0.5 mm, the concentration of the reducing agent was adjusted at 25% by mass by adding 0.2 g of sodium benzoisothiazolinone and water to obtain the reducing agent-2.

The reducing agent particles contained in the reducing agent-2 dispersion thus obtained had a median diameter of 0.38 μm and a maximum particle diameter of 2.0 μm. The reducing agent dispersion obtained was filtered with a polypropylene filter with a pore diameter of 10.0 μm to remove foreign substances such as dusts.

<<Preparation of Dispersion of Reducing Agent-3 Complexes>>

Mixed with through mixing to 10 kg of the reducing agent-3 complex (1:1 complex of 2,2′-methylenebis-(4-ethyl-6-t-butylphenol) and triphenyl phosphine oxide) 0.12 kg of triphenyl phosphine oxide and 16 kg of 10% by mass of an aqueous solution of modified polyvinyl alcohol (Poval MP203 made by Kuraray Co., Ltd.) were 7.2 kg of water to form a slurry.

The slurry was sent with a diaphragm pump and, after dispersing with a horizontal sand mill (UVM-2 made by I.mecs Co.) filled with zirconia beads with an average diameter of 0.5 mm for 4 hours and 30 minutes, the concentration of the reducing agent was adjusted to 25% by mass by adding 0.2 g of sodium benzoisothiazolinone and water to obtain the dispersion of the reducing agent-3. The reducing agent particles contained in the dispersion of the reducing agent-3 complex had a median diameter of 0.46 μm, and a maximum particle diameter of 1.6 μm. The dispersion of the reducing aget-3 obtained was filtered with a polypropylene filter with a pore diameter of 3.0 μm to remove foreign substances such as dusts.

<<Preparation of Dispersion of Reducing Agent-4>>

Added to 10 kg of the reducing agent-4 (2,2′-methylenebis-(4-ethyl-6-t-butylpehnol)) and 20 kg of 10% by mass of aqueous solution of modified polyvinyl alcohol (Poval MP203 made by Kuraray Co., Ltd.) was 6 kg of water to obtain a slurry by mixing with thorough stirring.

The slurry was sent with a diaphragm pump and, after dispersing with a horizontal sand mill (UVM-2 made by I.mecs Co.) filled with zirconia beads with an average diameter of 0.5 mm for 3 hours and 30 minutes, the concentration of the reducing agent was adjusted to 25% by mass by adding 0.2 g of sodium benzoisothiazolinone and water to obtain the dispersion of the reducing agent-4.

The particles of the reducing agent contained in the dispersion of the reducing agent-4 complex had a median diameter of 0.40 μm, and a maximum particle diameter of 1.5 μm. The dispersion of the reducing agent-4 obtained was filtered with a polypropylene filter with a pore diameter of 3.0 μm to remove foreign substances such as dusts.

<<Preparation of Dispersion of Reducing Agent-5>>

Added to 10 kg of the reducing agent-5 (2,2′-methylenebis-(4-methyl-6-t-butylpehnol)) and 20 kg of 10% by mass of aqueous solution of modified polyvinyl alcohol (Poval MP203 made by Kuraray Co., Ltd.) was 6 kg of water to obtain a slurry by mixing with thorough stirring.

The slurry was sent with a diaphragm pump and, after dispersing with a horizontal sand mill (UVM-2 made by I.mecs Co.) filled with zirconia beads with an average diameter of 0.5 mm for 3 hours and 30 minutes, the concentration of the reducing agent was adjusted to 25% by mass by adding 0.2 g of sodium benzoisothiazolinone and water to obtain the dispersion of the reducing agent-5.

The reducing agent particles contained in the dispersion of the reducing agent-5 had a median diameter of 0.38 μm, and a maximum particle diameter of 1.5 μm The dispersion of the reducing agent-5 obtained was filtered with a polypropylene filter with a pore diameter of 3.0 μm to remove foreign substances such as dusts.

<<Preparation of Hydrogen Bonding Compound-1>>

Mixed to 10 kg of the hydrogen bonding compound-1 (tri(4-t-butylphenyl)phosphine oxide) and 20 kg of 10% by mass of aqueous solution of modified polyvinyl alcohol (Poval MP203 made by Kuraray Co., Ltd.) was 10 kg of water with thorough mixing to prepare a slurry.

The slurry was sent with a diaphragm pump and, after dispersing with a horizontal sand mill (UVM-2 made by Imex Co.) filled with zirconia beads with an average diameter of 0.5 mm for 3 hours and 30 minutes, the concentration of the reducing agent was adjusted to 22% by mass by adding 0.2 g of sodium benzoisothiazolinone to obtain the dispersion of the hydrogen bonding compound-1.

The particles of the hydrogen bonding compound contained in the dispersion of the hydrogen bonding compound-1 had a median diameter of 0.35 μm, and a maximum particle diameter of 1.5 μm. The dispersion of the hydrogen bonding compound-1 obtained was filtered with a polypropylene filter with a pore diameter of 3.0 μm to remove foreign substances such as dusts.

<<Preparation of Dispersion of Organic Polyhalogen Compound-1>>

Added and thoroughly mixed were 10 kg of the organic polyhalogen compound-1 (2-tribromomethanesulfonyl naphthalene), 10 kg of 20% by mass aqueous solution of modified polyvinyl alcohol (Poval MP203 made by Kuraray Co., Ltd.), 0.4 kg of 20% by mass of aqueous solution of sodium triisopropylnaphthalene sulfonate and 16 kg of water to obtain a slurry. The slurry was sent with a diaphragm pump and, after dispersing with a horizontal sand mill (UVM-2 made by Imex Co.) filled with zirconia beads with an average diameter of 0.5 mm for 5 hours, the concentration of the organic polyhalogen compound was adjusted to 23.5% by mass by adding 0,2 g of sodium benzoisothiazolinone and water to obtain the dispersion of the organic polyhalogen compound-1. The particles of the organic polyhalogen compound contained in the dispersion of the organic polyhalogen compound-1 had a median diameter of 0.36 μm, and a maximum particle diameter of 2,0 μm. The dispersion of the organic polyhalogen compound-1 obtained was filtered with a polypropylene filter with a pore diameter of 10.0 μm to remove foreign substances such as dusts.

<<Preparation of Dispersion of Organic Polyhalogen Compound-2>>

Added and thoroughly mixed were 10 kg of the organic polyhalogen compound-2 (tribromomethanesulfonyl benzene) 10 kg of 20% by mass aqueous solution of modified polyvinyl alcohol (Poval MP203 made by Kuraray Co., Ltd.), 0.4 kg of 20% by mass of aqueous solution of sodium triisopropyl naphthalene sulfonate and 14 kg of water to obtain a slurry.

The slurry was sent with a diaphragm pump and, after dispersing with a horizontal sand mill (UVM-2 made by Imex Co.) filled with zirconia beads with an average diameter of 0.5 mm for 5 hours, the concentration of the organic polyhalogen compound was adjusted to 26% by mass by adding 0.2 g of sodium benzoisothiazolinone and water to obtain the dispersion of the organic polyhalogen compound-2.

The particles of the organic polyhalogen compound contained in the dispersion of the organic polyhalogen compound-2 had a median diameter of 0.41 μm, and a maximum particle diameter of 2.0 μm. The dispersion of the organic polyhalogen compound-2 obtained was filtered with a polypropylene filter with a pore diameter of 10.0 μm to remove foreign substances such as dusts.

<<Preparation of Dispersion of Organic Polyhalogen Compound-3>>

Added and thoroughly mixed were 10 kg of the organic polyhalogen compound-3 (N-butyl-3-tribromomethanesulfonyl benzamide), 20 kg of 10% by mass aqueous solution of modified polyvinyl alcohol (Poval MP203 made by Kuraray Co., Ltd.), 0.4 kg of 20% by mass of aqueous solution of sodium triisopropyl naphthalene sulfonate and 8 kg of water to obtain a slurry.

The slurry was sent with a diaphragm pump and, after dispersing with a horizontal sand mill (UVM-2 made by Imex Co.) filled with zirconia beads with an average diameter of 0.5 mm for 5 hours, the concentration of the organic polyhalogen compound was adjusted to 25% by mass by adding 0.2 g of sodium benzoisothiazolinone and water. The dispersion was heated at 40° C. for 5 hours to obtain the dispersion of the organic polyhalogen compound-3.

The particles of the organic polyhalogen compound contained in the dispersion of the organic polyhalogen compound-3 had a median diameter of 0.36 μm, and a maximum particle diameter of 1.5 μm. The dispersion of the organic polyhalogen compound-3 obtained was filtered with a polypropylene filter with a pore diameter of 3.0 μm to remove foreign substances such as dusts.

<<Preparation of Phthalazine Compound-1>>

Dissolved in 174.57 kg of water was 8 kg of modified polyvinyl alcohol MP203 made by Kuraray Co., Ltd., and 3.15 kg of 20% by mass of aqueous sodium triisopropyl naphthalene sulfonate solution and 14.28 kg of 70% by mass aqueous phthalazine compound-1 (6-isopropyl phthalazine) were added to prepare 5% by mass of phthalazine compound-1.

<<Preparation of Aqueous Mercapto Compound-T Solution>>

Dissolved in 993 g of water was 7 g of the mercapto compound-T (1-(3-sulfophenyl)-5-mercaptotetrazol sodium salt) to prepare 0.7% by mass of aqueous solution.

<<Preparation of Pigment-1 Dispersion>>

A slurry was prepared by adding C. I. Pigment Blue 60 and Demol N made by Kao Corporation in water with through mixing. Prepared and placed in a vessel together with slurry were 800 g of zirconia beads with an average diameter of 0.5 mm, and the mixture was dispersed in a dispersing apparatus (¼G sand grinder mill made by Imex Co.) for 25 hours to obtain the pigment-1 dispersion. The pigment particles contained in the pigment-1 dispersion thus obtained had an average particle diameter of 0.21 μm.

<<Preparation of SBR Latex>>

An SBR latex with Tg of 23° C. was prepared as follows.

After emulsion polymerization of 70.5 parts by mass of styrene, 26.5 parts by mass of butadiene and 3 parts by mass of acrylic acid using ammonium persulfate as a polymerization initiator and anionic surfactant as an emulsifier, the product was aged at 80° C. for 8 hours. The product was cooled to 40° C., the pH was adjusted to 7.0 with aqueous ammonia, and Sundet BL (made by Sanyo Chemical Industries Ltd.) was added in a concentration of 0.22%. Subsequently, the pH of the solution was adjusted to 8.3 by adding 5% aqueous sodium hydroxide followed by adjusting to pH 8.4 with aqueous ammonia. The ratio of Na⁺ ion to NH⁴⁺ ion used herein was 1:2.3. The SBR latex solution was prepared by adding 0.15 ml of 7% aqueous solution of sodium benzoisothiazolinone into 1 kg of this solution.

SBR latex (÷St (70.5))−Bu (26.5)−AA (3) latex) Tg 23° C.

The latex had an average particle diameter of 0.1 μm, a concentration of 43% by mass, an equilibrium moisture content at 25° C. and 60% RH of 0.6% by mass, an ionic conductivity of 4.2 S/cm (the ionic conductivity was measured using a conductivity meter CM-30 made by DKK-TOA Corporation at 25° C. using a neat latex solution (43% by mass)), and pH of 8.4.

The latex having different Tg was also prepared by the same method above by appropriately changing the proportion of styrene and butadiene.

<<Preparation of Emulsion Layer (Photosensitive Layer) Application Fluid-1>>

Sequentially added were 1000 g of the dispersion A of the organic acid silver salt, 125 ml of water, 91 g of the reducing agent-2 dispersion, 27 g of the pigment-1 dispersion, 82 g of the dispersion of the organic polyhalogen compound-1, 40 g of the dispersion of the organic polyhalogen compound-2, 173 g of the dispersion of the phthalazine compound-1, 1082 g of the SBR latex (Tg 20.5° C.) solution and 9 g of themercapto compound-T. Then, a mixture of 111 g of the silver halide emulsion-A and 47 g of the silver halide emulsion-B were added immediately before application to obtain the application fluid-1 for the emulsion layer (photosensitive layer) with thorough stirring. The solution was directly sent to a coating die for application.

The viscosity of the emulsion layer (photosensitive layer) application fluid-1 was 85 mPa·s at 40° C. as measured with a B-type viscometer (No. 1 rotor, 60 rpm) made by Tokyo Instrument Co.

The viscosity of the application fluid measured at 25° C. using RFS Fluid Spectrometer made by Rheometrix Far-East Co., was 1500, 220, 70, 40 and 20 (mPa·s) at shear speed of 0.1, 1, 10. 100 and 1000 (1/sec), respectively.

<<Preparation of Emulsion Layer (Photosensitive Layer) Application Fluid-2>>

The emulsion layer (photosensitive layer) application fluid-2 was prepared with thorough mixing by the same method as preparing the emulsion layer (photosensitive layer) application fluid-1, and was directly sent to a coating die for application, except that a mixture of 111 g of the silver halide emulsion C and 47 g of the silver halide emulsion D was added immediately before application in place of adding a mixture of 111 g of the silver halide emulsion A and 47 g of the silver halide emulsion B in the emulsion layer (photosensitive layer) application fluid-1.

<<Preparation of the Emulsion Layer (Photosensitive Layer) Coating Fluids 3 to 10>>

The emulsion layer application fluids 3 and 5 to 10 were prepared by the same method as preparing the emulsion layer application fluid-2, and the emulsion layer application fluid-4 was prepared by the same method as preparing the emulsion layer application fluid-1, and each emulsion layer application fluid was directly sent to a coating die for application, except that the organic acid silver salt dispersions described in the samples 3 to 10 in Table 2 was used for the organic acid silver salt dispersion A, and the mercapto compounds (MMBI and PHMT) and mercapto compounds (1 to 17) added in preparing the silver halide emulsion were changed to those in the samples 3 to 10 in Table 2 with the timing of addition in the table.

<<Preparation of Emulsion Layer (Photosensitive Layer) Application Fluid-19>>

Sequentially added were 1000 g of the organic acid silver salt dispersion F obtained above, 104 ml of water, 30 g of the pigment-1 dispersion, 21 g of the organic polyhalogen compound-2 dispersion, 69 g of the organic polyhalogen compound-3 dispersion, 173 g of the phthalazine compound-1 dispersion, 1082 g of the SBR latex (Tg 23° C.), 258 g of the reducing agent complex-3 dispersion and 9 g of the aqueous mercapto compound (1-17) solution. The emulsion layer (photosensitive layer) application fluid-19 was prepared by adding 108 g of the silver halide emulsion C and 50 g of the silver halide emulsion D with thorough stirring.

<<Preparation of Emulsion Layer (Photosensitive Layer) Application Fluid-29>>

Sequentially added were 1000 g of the organic acid silver salt dispersion F obtained above, 95 ml of water, 73 g of the reducing agent-4 dispersion, 68 g of the reducing agent-5 dispersion, 30 g of the pigment-1 dispersion, 21 g of the organic polyhalogen compound-2 dispersion, 69 g of the organic polyhalogen compound-3 dispersion, 173 g of the phthalazine compound-1 solution, 1082 g of the SBR core/shell type latex (core Tg 20° C./shell Tg 30° C.; weight ratio 70/30) solution, 124 g of the hydrogen bonding compound-1 dispersion, and 9 g of the mercapto compound (1-17) solution. The emulsion layer (photosensitive layer) application fluid-29 was prepared by adding 90 g of the silver halide mixed emulsion C and 68 g of the silver halide mixed emulsion D with thorough stirring.

<<Preparation of Emulsion Intermediate Layer Application Fluid>>

Mixed were 772 g of 10% aqueous solution of polyvinyl alcohol PVA-205 (made by Kuraray Co., Ltd.), 5.3 g of 20% by mass of dispersion of the pigment, a mixture prepared by adding 2 ml of an aqueous 5% by mass solution of aerosol OT (made by American Cyanamid Co.) into 226 g of methyl methacrylate/styrene/butyl acrylate/hydroxymethyl methacrylate/acrylic acid copolymer (copolymerization ratio of 64/9/20/5/2 in weight ratio), 10.5 ml of 20% by mass of aqueous diammonium phthalate, and the intermediate layer application fluid was prepared by adding water into the mixture so that the total weight becomes 880 g, and by adjusting pH to 7.5 with NaOH. The application fluid was sent to a coating die with an application area density of 10 ml/m².

The viscosity of the application fluid was 21 mPa·s at 40° C. as measured with a B-type viscometer (No. 1 rotor, 60 rpm).

<<Preparation of Application Fluid of Protective First Layer of Emulsion Face>>

Inert gelatin (64 g) was dissolved in water, and 80 g of a 27.5% by mass solution of methyl methacrylate/styrene/butyl acrylate/hydroxyethyl methacrylate/acrylic acid copolymer latex (copolymerization ratio 64/9/20/5/2 in weight ratio) 23 ml of 10% by mass methanol solution of phthalic acid, 23 ml of 10% by mass aqueous solution of 4-methyl phthalic acid, 28 ml of 0.5 mole/l sulfuric acid, 5 ml of 5% by mass aqueous solution of aerosol OT (made by American Cyanamid Co.), 0.5 g of phenoxyethanol, and 0.1 g of benzoisothiazolinone were added to the aqueous solution. The application fluid was prepared by adding water to a total weight of 750 g, and 26 ml of 4% by mass solution of chromium alum was added and mixed with a static mixer immediately before application. The mixture was sent to a coating die with an area density of 18.6 ml/m².

The viscosity of the application fluid was 17 mPa·s at 40° C. as measured with a B-type viscometer (No. 1 rotor, 60 rpm).

<Preparation of Application Fluid of Protective Second Layer of Emulsion Face>>

Inert gelatin (80 g) was dissolved in water, and 102 g of a 27.5% by mass solution of methyl methacrylate/styrene/butyl acrylate/hydroxyethyl methacrylate/acrylic acid copolymer latex (copolymerization ratio 64/9/20/5/2 in weight ratio), 3.2 ml of 5% by mass solution of a fluorine based surfactant (F-1: N-perfluorooctyl sulfonyl-N-propylalanine potassium salt), 32 ml of 2% by mass aqueous solution of a fluorine based surfactant (F-2: polyethyleneglycol mono(N-perfluorooctylsulfonyl-N-propyl-2-aminoethyl)ether [mean degree of polymerization of ethylene oxide=15]), 23 ml of 5% by mass aqueous solution of aerosol OT (made by American Cyanamid Co.), 4 g of polymethyl methacrylate fine particles (average particle diameter 0.7 μm), 21 g of polymethyl methacrylate fine particles (average particle diameter 4.5 μm), 16 g of 4-methylphthalic acid, 4.8 g of phthalic acid, 44 ml of 0.5 mole/L of sulfuric acid and 10 mg of benzoisothiazolinone were added to the aqueous solution. The application fluid was prepared by adding water to a total weight of 650 g, and 445 ml of an aqueous solution comprising 4% by mass of chromium alum and 67% by mass of phthalic acid was added and mixed with a static mixer immediately before application as an application fluid of the surface protective layer. The mixture was sent to a coating die with an area density of 8.3 ml/m².

The viscosity of the application fluid was 9 mPa·s at 40° C. as measured with a B-type viscometer (No. 1 rotor, 60 rpm).

[Preparation of Heat Developable Image Recording Material]

<<Preparation of Heat Developable Image Recording Materials 1 to 10>>

An application fluid of the halation preventive layer and an application fluid of the back face protective layer were simultaneously applied on the back face side of the undercoat substrate so that the amount of application of the solid fraction of the fine solid dye particles is 0.04 g/m² in the halation preventive layer, and the amount of application of gelatin is 1.7 g/m² in the back face protective layer. The back layer was formed after drying.

A sample of the heat developable image recording material was prepared by simultaneously applying the emulsion layer (photosensitive layer), intermediate layer, protective first layer and protective second layer on the undercoat layer of the opposed face to the back face in this order by a slide beads application method. The emulsion layer and intermediate layer were applied by adjusting the temperature at 31° C., the protective first layer was applied by adjusting the temperature at 36° C., and the protective second layer was applied by adjusting the temperature at 37° C.

The heat developable image recording materials prepared using the emulsion layer (photosensitive layer) application fluids 1 to 10 were used as the heat developable image recording materials 1 to 10 (samples 1 to 10). The amount of application (g/m²) of each compound in each emulsion layer was as follows:

| | |
|---|---|
| organic acid silver salt dispersion (Table 2) | 6.19 |
| reducing agent-1 | 0.67 |
| reducing agent-2 | 0.54 |
| pigment (C. I. Pigment Blue 60) | 0.032 |
| organic polyhalogen compound-1 | 0.46 |
| organic polyhalogen compound-1 | 0.25 |
| phthalazine compound-1 | 0.21 |
| SBR latex | 11.1 |
| mercapto compound | 0.002 |
| silver halide (as Ag) | 0.145 |

The drying condition was as follows.

The coating speed was 160 m/min., the space between the tip of the coating die and the substrate was 0.10 to 0.30 mm, and the pressure of he vacuum chamber was adjusted to be 196 to 882 Pa lower than the atmospheric pressure.

Electrification was Quenched by Ion Flow Before Application

After cooling the application fluid in a chilling zone by blowing dry air of 10 to 20° C. as measured with a dry-bulb thermometer, the application fluid was transported by non-contact transportation, and was dried with dry air flow in a coiled type non-contact drying chamber at a dry-bulb temperature of 23 to 45° C. and wet-bulb temperature of 15 to 21° C.

After drying, the temperature and relative humidity were adjusted to 25° C. and 40 to 60%, respectively, and the film surface was heated at 70 to 90° C., followed by cooling to 25° C.

The degree of matting of the heat developable image recording material prepared was 550 second and 130 second for the photosensitive layer side and back face side, respectively, as Beck smoothness. The pH value of the film surface at the photosensitive layer side was 6.0.

<Evaluation of Preservative Property of Inert Material>

The heat developable image recording material was preserved in an atmosphere of 60° C. and 40% RH, and was exposed and developed (using four panel heaters with a hating program of 112° C., 119° C., 121° C., and 121° C. for 24 seconds in total) using Fuji Medical Dry Laser Imager FM-DP L (equipped with a semiconductor laser with a maximum output energy 60 mW (IIIB)). Variations of sensitivity (fog+logarithm of inversion of the exposed luminous energy at an image density of 1.0) and Dₘᵢₙ (ΔDₘᵢₙ) were determined. The results are shown in Table 2.

It was shown that decrease of the preservative property of the inert material and increase of fogging were small in the heat developable image recording material

TABLE 2

| | | Organic acid | | | Sensitivity change | ΔDₘᵢₙ |
|---|---|---|---|---|---|---|
| Sample | | silver salt | | | (after preservation) | (after preservation) |
| No. | | dispersion | Mercapto compound | Timing of addition | (60° C. 40% 2d) | (60° C. 40% 2d) |
| 1 | Comparative | A | MMBI + PHMT + T | During chemical | 53 | Δ0.07 |
| | example | | | sensitization | | |
| 2 | Comparative | A | (1-17) + T | During chemical | 54 | Δ0.04 |
| | example | | | sensitization | | |
| 3 | Comparative | B | (1-17) + T | During chemical | 65 | Δ0.04 |
| | example | | | sensitization | | |
| 4 | Example | C | MMBI + PHMT + T | During chemical | 89 | Δ0.06 |
| | | | | sensitization | | |
| 5 | Example | C | (1-17) + T | During chemical | 90 | Δ0.02 |
| | | | | sensitization | | |
| 6 | Example | C | (1-17) + T | At completion of | 87 | Δ0.03 |
| | | | | chemical sensitization | | |
| 7 | Example | D | (1-17) + T | During chemical | 91 | Δ0.02 |
| | | | | sensitization | | |
| 8 | Example | E | (1-17) + T | During chemical | 95 | Δ0.02 |
| | | | | sensitization | | |
| 9 | Example | F | (1-17) + T | During chemical | 98 | Δ0.02 |
| | | | | sensitization | | |
| 10 | Example | G | (1-17) + T | During chemical | 99 | Δ0.01 |
| | | | | sensitization | | |

* The sensitivity was defined to be 100 before preservation, and Fog value indicates increment from before preservation

### Example 2

<<Preparation of Heat Developable Image Recording Material-19>>

The heat developable image recording material-19 was prepared by the same method as in the heat developable image recording material-9, except that the emulsion layer (photosensitive layer) application fluid-9 was changed to the emulsion layer application fluid-19, and the yellow pigment compound 15 was eliminated from the halation preventive layer.

The amount of application (g/m²) of each compound in the emulsion layer was as follows.

| | |
|---|---|
| organic acid silver salt dispersion F | 6.19 |
| pigment (C. I. Pigment Blue 60) | 0.036 |
| organic polyhalogen compound-2 | 0.13 |
| organic polyhalogen compound-3 | 0.41 |
| phthalazine compound-1 | 0.21 |
| SBR latex | 11.1 |
| reducing agent complex-3 | 1.54 |
| mercapto compound (1-17) | 0.002 |
| silver halide (as Ag) | 0.10 |

The heat developable image recording materials-11 to 18 and 20 were prepared by the same method as in the heat developable image recording material-19, except that the organic acid silver salt dispersion F of the heat developable image recording material-19 was changed to the organic acid silver salt dispersions A to G shown in the samples 11 to 18 and 20 in Table 2, and the timing for adding the mercapto compound was changed as shown in Table 2.

The preservative property of the inert material was evaluated as in Example 1.

As shown in Table 3, good results as in Example 1 were obtained with respect to decrease of sensitivity and increase of fogging.

TABLE 3

| | | Organic acid | | | Sensitivity change | ΔDₘᵢₙ |
|---|---|---|---|---|---|---|
| Sample | | silver salt | | | (after preservation) | (after preservation) |
| No. | | dispersion | Mercapto compound | Timing of addition | (60° C. 40% 2d) | (60° C. 40% 2d) |
| 11 | Comparative | A | MMBI + PHMT | During chemical | 70 | Δ0.05 |
| | example | | | sensitization | | |
| 12 | Comparative | A | (1-17) | During chemical | 64 | Δ0.02 |
| | example | | | sensitization | | |
| 13 | Comparative | B | (1-17) | During chemical | 68 | Δ0.02 |
| | example | | | sensitization | | |
| 14 | Example | C | MMBI + PHMT | During chemical | 94 | Δ0.04 |
| | | | | sensitization | | |
| 15 | Example | C | (1-17) | During chemical | 95 | Δ0.02 |
| | | | | sensitization | | |
| 16 | Example | C | (1-17) | At completion of | 92 | Δ0.02 |
| | | | | chemical sensitization | | |
| 17 | Example | D | (1-17) | During chemical | 95 | Δ0.01 |
| | | | | sensitization | | |
| 18 | Example | E | (1-17) | During chemical | 96 | Δ0.02 |
| | | | | sensitization | | |
| 19 | Example | F | (1-17) | During chemical | 98 | Δ0.01 |
| | | | | sensitization | | |
| 20 | Example | G | (1-17) | During chemical | 99 | Δ0.01 |
| | | | | sensitization | | |

* The sensitivity was defined to be 100 before preservation, and Fog value indicates increment from before preservation

### Example 3

<<Preparation of Heat Developable Image Recording Material-29>>

The emulsion layer (photosensitive layer) application fluid-9 in the heat developable image recording material-9 was changed to the emulsion layer (photosensitive layer) application fluid-29, and the yellow pigment compound 15 was eliminated from the halation preventive layer. The fluorine based surfactants F-1, F-2, F-3 and F-4 in the protective second layer and back face protective layer were changed to F-5, F-6, F-7 and F-8, respectively, with the same weight. The heat developable image recording material-29 was prepared by the same method as in the heat developable image recording material-9 except the conditions above.

The amount of application (g/m²) of each compound in the emulsion layer was shown in Table 4.

| | |
|---|---|
| organic silver halide dispersion F | 5.57 |
| pigment (C. I. Pigment Blue 60) | 0.032 |
| reducing agent-4 | 0.40 |
| reducing agent-5 | 0.36 |
| organic polyhalogen compound-2 | 0.12 |
| organic polyhalogen compound-3 | 0.37 |
| phthalazine compound-1 | 0.19 |
| SBR latex | 10.0 |
| hydrogen bonding compound-1 | 0.59 |
| mercapto compound (1-17) | 0.002 |
| silver halide (as Ag) | 0.09 |

The heat developable image recording material-21 to 28 and 30 were prepared by the same method as in the heat developable image recording material-29, except that the organic acid silver salt dispersions A to G shown in the samples 21 to 28 in Table 3 were use in place of the organic acid silver salt dispersion F in the heat developable image recording material-29, and the timing for adding the mercapto compound was also changed as shown in Table 2.

Preservative properties of the neat samples were evaluated by the same method as in Example 1.

As shown in Table 4, good results as in Example 1 were obtained with respect to sensitivity decrease and gof increase during preservation of the neat material.

TABLE 4

| | | Organic acid | | | Sensitivity change | ΔDₘᵢₙ |
|---|---|---|---|---|---|---|
| Sample | | silver salt | | | (after preservation) | (after preservation) |
| No. | | dispersion | Mercapto compound | Timing of addition | (60° C. 40% 2d) | (60° C. 40% 2d) |
| 21 | Comparative | A | MMBI + PHMT | During chemical | 82 | Δ0.04 |
| | example | | | sensitization | | |
| 22 | Comparative | A | (1-17) | During chemical | 76 | Δ0.02 |
| | example | | | sensitization | | |
| 23 | Comparative | B | (1-17) | During chemical | 79 | Δ0.02 |
| | example | | | sensitization | | |
| 24 | Example | C | MMBI + PHMT | During chemical | 95 | Δ0.04 |
| | | | | sensitization | | |
| 25 | Example | C | (1-17) | During chemical | 96 | Δ0.01 |
| | | | | sensitization | | |
| 26 | Example | C | (1-17) | At completion of | 94 | Δ0.01 |
| | | | | chemical sensitization | | |
| 27 | Example | D | (1-17) | During chemical | 96 | Δ0.00 |
| | | | | sensitization | | |
| 28 | Example | E | (1-17) | During chemical | 97 | Δ0.01 |
| | | | | sensitization | | |
| 29 | Example | F | (1-17) | During chemical | 99 | Δ0.01 |
| | | | | sensitization | | |
| 30 | Example | G | (1-17) | During chemical | 101 | Δ0.00 |
| | | | | sensitization | | |

* The sensitivity was defined to be 100 before preservation, and Fog value indicates increment from before preservation

Chemical structures of the compounds used in the examples of the invention in the first aspect are shown below:

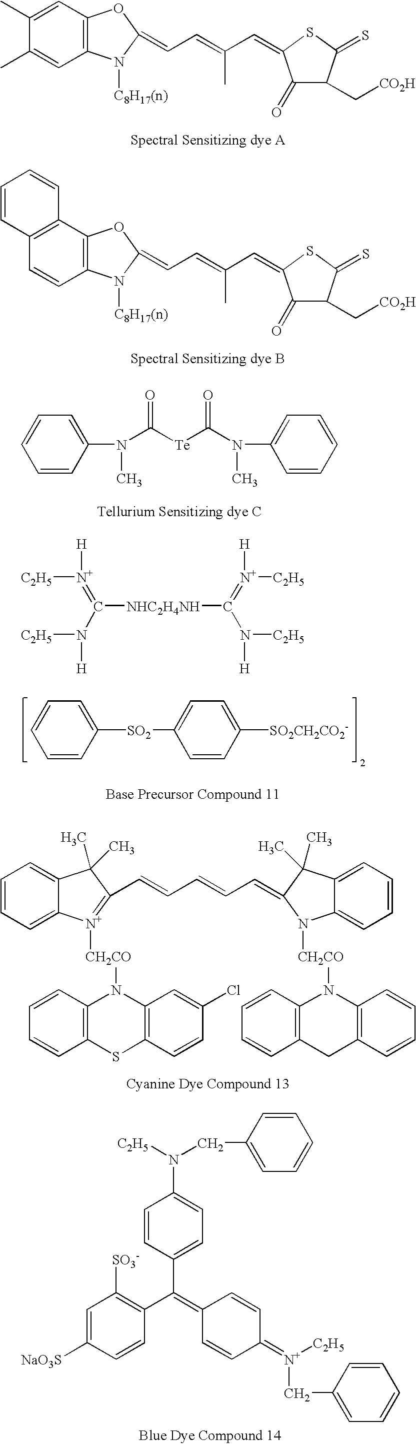

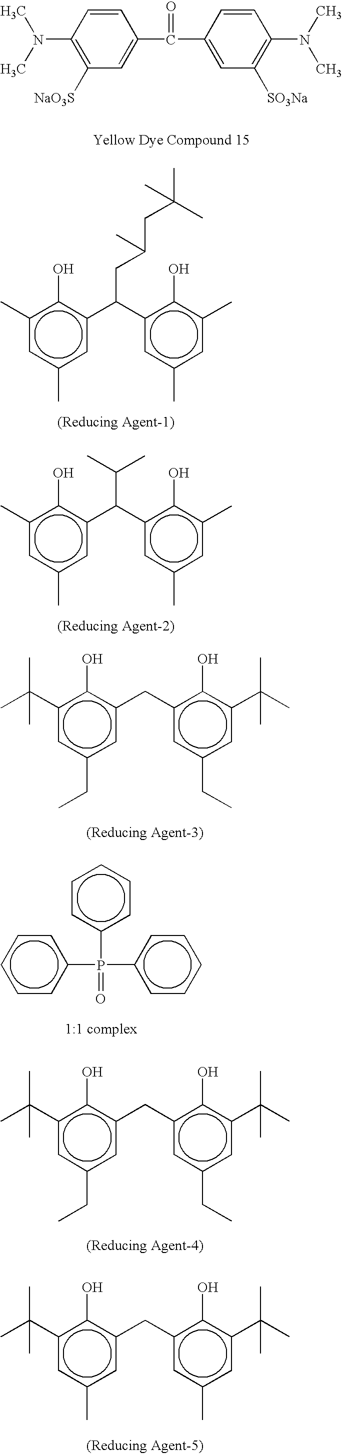

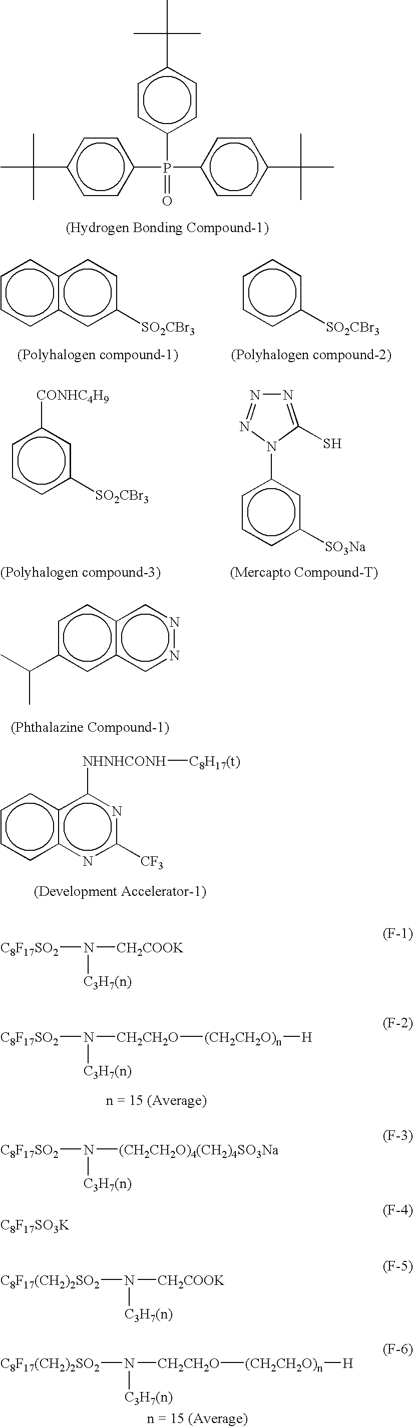

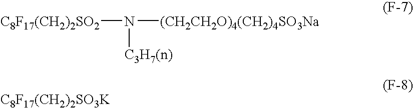

The invention provides a heat developable image recording material having sufficiently high sensitivity and maximum image density with excellent preservative property of the inert material.

### Example 4

The PET substrate was manufactured by the same method as in Example 1.

The undercoat substrate was manufactured by the same method as in Example 1.

The back face application fluid was prepared by the same method as in Example 1.

The application fluid of the back face protective layer was manufactured by the same method as in Example 1.

The silver halide emulsion 1 of the emulsion layer (photosensitive layer) application fluid was prepared by the same method as in Example 1.

<<Preparation of Silver Halide Emulsion 2>>

The silver halide emulsion 2 was prepared by the same method as in the silver halide emulsion 1, except that the temperate of 30° C. of the liquid for forming the particles was changed to 47° C., the solution B was prepared by diluting 15.9 g of potassium bromide to a volume of 97.4 ml with distilled water, the solution D was prepared by diluting 45.8 g of potassium bromide to a volume of 400 ml with distilled water, the solution C was added in 30 minutes, and potassium hexacyano iron (III) was eliminated. The particles were precipitated, desalted, washed with water and dispersed by the same method as in the silver halide emulsion 1. The silver halide emulsion 2 was obtained by spectral sensitization and chemical sensitization by the same method as in the silver halide emulsion 1, and by adding 5-methyl-2-mercaptobenzimidazole and 1-phenyl-2-heptyl-5-mercapto-1,3,4-triazole, except that the amount of addition of the methanol solution of the spectral sensitizing dye A and spectral sensitizing dye B in 1:1 molar ratio was changed to 7.5×10⁻⁴ mole per one mole of silver as a sum of the spectral sensitizing dyes A and B, the amount of addition of the tellurium sensitizer B was changed to 1.1×10⁻⁴ mole per one mole of silver, and the amount of addition of 1-phenyl-2-heptyl-5-mercapto-1,3,4-triazole was changed to 3.3×10⁻³ mole per one mole of silver. The emulsion particles of the silver halide emulsion 2 were cubic particles of pure silver bromide having the average equivalent-circle diameter of 0.080 μm and the variation coefficient of the equivalent-circle diameter of 20%.

<<Preparation of Silver Halide Emulsion 3>>

The silver halide emulsion 3 was prepared by the same method as in the silver halide emulsion 1, except that the temperate of 30° C. of the liquid for forming the particles was changed to 27° C. The particles were precipitated, desalted, washed with water and dispersed by the same method as in the silver halide emulsion 1. The silver halide emulsion 3 was obtained by the same method as in the emulsion 1, except that the amount of addition of the spectral sensitizing dyes A and B in a solid dispersion (in an aqueous gelatin solution) containing the spectral sensitizing dyes A and B in 1:1 molar ratio was changed to 6×10⁻³ mole per one mole of silver as a sum of the spectral sensitizing dyes A and B, and the amount of addition of the tellurium sensitizer B was changed to 5.2×10⁻⁴ mole per per mole of silver. The emulsion particles in the silver halide emulsion 3 had an average equivalent-circle diameter of 0.034 μm, and a variation coefficient of the equivalent-circle diameter of 20%, and contained 3.5 mol % of iodine uniformly distributed in the silver bromide particles.

<<Preparation of the Silver Halide Mixed Emulsion A (for Application Fluid)>>

Dissolved were 70% by mass of the silver halide emulsion 1, 15% by mass of the silver halide emulsion 2 and 15% by mass of the silver halide emulsion 3, and benzothiazolium iodide was added in a proportion of 7×10⁻³ per one mole of silver as 1% by mass aqueous solution. Water was further added so that the content of the silver halide is 38.2 g per 1 kg of the application mixed emulsion as converted into Ag.

<<Preparation of Organic Acid Silver Salt Dispersions A to G>>

Mixed in the composition shown in Table 5 were 258.5 mole of organic acid silver salt, 423 L of distilled water, 49.2 L of 5 mole/L aqueous NaOH solution and 120 L of t-butanol. The mixture was allowed to react at 75° C. with mixing for 1 hour to obtain an organic acid sodium solution.

Separately prepared were 206.2 L (pH 4.0) of aqueous solution of 40.4 kg of silver nitrate, and the solution was kept at 10° C. A reaction vessel containing 635 L of distilled water and 30 L of t-butanol was kept at 30° C., and the total volumes of the silver behenate solution and aqueous silver nitrate were added, respectively, at a constant flow rate for 93 minutes and 15 seconds and 90 seconds, respectively.

Only the aqueous silver nitrate solution was added for 11 minutes from the beginning of addition of the aqueous silver nitrate solution, followed by starting the organic acid sodium solution to add, and only the organic acid sodium solution was added for 14 minutes and 15 seconds after completing the aqueous silver nitrate solution to add.

The reaction temperature within the reaction vessel during the addition was controlled as described in Table 1, and the external temperature was controlled so that the liquid temperature is constant. The piping system for adding the organic acid sodium solution was kept constant by circulating warm water at the external space of the dual wall pipe so that the liquid temperature of the outlet at the tip of the nozzle is kept at 75° C. The piping system for adding the aqueous silver nitrate solution was also kept at a constant temperature by circulating cold water in the external space of the dual wall pipe. The positions for adding the organic acid sodium solution and aqueous silver nitrate solution were disposed to be symmetrical, respectively, relative to the central axis of the stirrer. The elevations of the tip of the nozzles were adjusted so as to avoid contact with the reaction solution.

TABLE 5

| Dispersion of organic | Silver | Silver | Silver | Silver |
|---|---|---|---|---|
| acid silver salt | stearate | arachidate | behenate | lignocerate |
| A | 5.0 | 6.0 | 87.0 | 2.0 |
| B | 1.5 | 8.5 | 87.0 | 3.0 |
| C | 1.0 | 6.0 | 91.0 | 2.0 |
| D | 1.5 | 7.0 | 91.0 | 1.5 |
| E | 1.0 | 3.0 | 95.0 | 1.0 |
| F | 0.5 | 2.0 | 95.0 | 2.5 |
| G | 0.0 | 0.7 | 97.5 | 1.8 |

Reaction temperature in reaction vessel: 30° C.

(Ripening/Centrifugal Filtration)

After adding the organic acid sodium solution, the solution was continues to stir for 20 minutes at the same temperature, followed by increasing the temperature to 35° C. in 30 minutes with ripening for 210 minutes thereafter. After ripening, the solid fraction was filtered off by centrifugal filtration, and the filtrate was washed with water until conductivity of the filtered water reduces to 30 μS/cm. The wet cake was made to be a slurry by adding pure water followed by filtration, and this procedure was repeated 3 times in order to facilitate conductivity to decrease. The wet cake of the organic silver was centrifuged at a centrifugal force of 700G for 1 hour. G is represented by 1.119×10⁻⁵×radius of vessel (cm)×rotational speed (rpm)². The solid fraction of the wet cake of the organic silver thus obtained was 44% (measured by drying 1 g of the wet cake at 110° C. for 2 hours).

(Preliminary Dispersion)

To the wet cake corresponding to 260 kg of the dried solid fraction, 19.3 kg of polyvinyl alcohol (trade name: PVA-217) and water was added to a total weight of 1000 kg, and the mixture was formed into a slurry using a dissolver blade, and was further preliminarily dispersed using a pipe line mixer (type PM-10 made by Mizuho Industries Co.).

(Final Dispersion)

The solution after the preliminary dispersion was processed 3 times by adjusting the pressure of the dispersion machine (trade name: Micro-fluidizer M-610, made by Micro-Fluidex International Corporation, Z-type interaction chamber was used) to 1260 kg/cm² to obtain a silver behenate dispersion. The characteristic values of the dispersion were the same as those after washing with water. The dispersion temperature was adjusted at 18° C. by attaching interaction chambers at the front and rear faces of a coil type heat exchanger, and by controlling the temperature of coolant.

The reducing agent-1 dispersion was prepared by the same method as in Example 1.

The reducing agent-2 dispersion was prepared by the same method as in Example 1.

The reducing agent-3 dispersion was prepared by the same method as in Example 1.

The reducing agent-4 dispersion was prepared by the same method as in Example 1.

The reducing agent-5 dispersion was prepared by the same method as in Example 1.

<<Preparation of Reducing Agent Complex-6 Dispersion>>

The reducing agent complex-6 dispersion was prepared by the same method as preparing reducing agent complex-3 dispersion, except that the 1:1 complex of 2,2′-methylenebis-(4-ethyl-6-t-butylphenol) and triphenyl phosphine oxide in preparation of the reducing agent complex-3 dispersion was changed to a 1:1 complex of 2,2′-methylenebis-(4-ethyl-6-t-butylphenol) and tri(4-methylphenyl)phosphine oxide.

<<Preparation of Reducing Agent Complex-7 Dispersion>>

The reducing agent complex-7 dispersion was prepared by the same method as preparing reducing agent complex-3 dispersion, except that the 1:1 complex of 2,2′-methylenebis-(4-ethyl-6-t-butylphenol) and triphenyl phosphine oxide in preparation of the reducing agent complex-3 dispersion was changed to a 1:1 complex of 2,2′-methylenebis-(4-ethyl-6-t-butylphenol) and tri(4-t-butylphenyl)phosphine oxide.

<<Preparation of Hydrogen Bonding Compound-1 Dispersion>>

Added with thorough stirring to form a slurry were 10 kg of water into 10 kg of the hydrogen bonding compound-1 (triphenyl phosphine oxide)and 20 kg of 10% by mass of aqueous solution of modified polyvinyl alcohol (Poval MP203 made by Kuraray Co., Ltd.).

The slurry was sent with a diaphragm pump, and dispersed with a horizontal sand mill (UVM-2 made by Imex Co.) for 3 hours and 30 minutes. The concentration was adjusted thereafter to 22% by mass by adding 0.2 g of sodium benzoinchiazolinone and water to obtain the hydrogen bonding compound-1 dispersion.

The median diameter of the reducing agent particles contained in the reducing agent dispersion thus obtained was 0.40 μm, and the maximum particle diameter was 1.7 μm The hydrogen bonding compound dispersion obtained was filtered with a polypropylene filter with a pore size of 3.0 μm, and foreign substances such as dust were removed.

<<Preparation of Hydrogen Bonding Compound-2 Dispersion>>

The hydrogen bonding compound-2 dispersion was obtained by the same method as preparing the hydrogen bonding compound-1 dispersion, except that the hydrogen bonding compound-1 (triphenyl phosphine oxide) was replaced with the hydrogen bonding compound-2 (tri(4-t-butylphenyl)phosphine oxide).

The median diameter of the reducing agent particles contained in the reducing agent dispersion thus obtained was 0.35 μm, and the maximum particle diameter was 1.5 μm.

The organic polyhalogen compound-1 dispersion was prepared by the same method as in Example 1.

The organic polyhalogen compound-2 dispersion was prepared by the same method as in Example 1.

The organic polyhalogen compound-3 dispersion was prepared by the same method as in Example 1.

The phthalazine compound-1 solution was prepared by the same method as in Example 1.

The mercapto compound-1 solution was prepared by the same method as in Example 1.

The pigment-1 dispersion was prepared by the same method as in Example 1.

The SBR latex solution was prepared by the same method as in Example 1.

<<Preparation of Emulsion Layer (Photosensitive Layer) Application Fluid-15>>

As shown in Table 6, 1000 g of the organic acid silver salt dispersion C obtained above, 125 ml of water, 113 g of the reducing agent-4 dispersion, 91 g of the hydrogen bonding compound-1 dispersion, 17 g of pigment-1 dispersion, 82 g of the organic polyhalogen compound-1 dispersion, 40 g of the organic polyhalogen compound-2 dispersion, 173 g of the phthalazine compound-1 solution, 1082 g of the SBR latex solution (Tg: 20.5° C.) and 9 g of the aqueous mercapto compound-1 solution were sequentially added. After obtaining the emulsion layer (photosensitive layer) application fluid by adding 158 g of the silver halide mixed emulsion A with thorough stirring, the solution was directly sent to a coating die for application.

The viscosity of the emulsion layer (photosensitive layer) application fluid-1 was 85 mPa·s as measured with a B-type viscometer (No. 1 rotor, 60 rpm) made by Tokyo Instrument Co.

The viscosity of the application fluid measured at 25° C. using RFS Fluid Spectrometer made by Rheometrix Far-East Co., was 1500, 220, 70, 40 and 20 (mPa·s) at shear speed of 0.1, 1, 10. 100 and 1000 (1/sec), respectively.

<<Preparation of Emulsion Layer (Photosensitive Layer) Application Fluids-11 to 14, 16 to 19 and 22 to 29>>

The application fluids were prepared by the same method as in the emulsion layer (photosensitive layer) application fluid-15, except that the compositions in Tables 6 and 7 were used.

TABLE 6

| | | | | |
|---|---|---|---|---|
| Organic acid | | | Hydrogen | Organic |
| silver salt | Reducing | Reducing | bonding | polyhalogen |

| | | | | |
|---|---|---|---|---|
| dispersion | agent | agent complex | compound | compound |

| Sample | | | Amount of | | Amount of | | Amount of | | Amount of | | Amount of |
|---|---|---|---|---|---|---|---|---|---|---|---|
| No. | | Kind | addition (g) | Kind | addition (g) | Kind | addition (g) | Kind | addition (g) | Kind | addition (g) |
| 11 | Comparative | A | 1000 | 4 | 113 | — | — | — | — | 1 | 82 |
| | example | | | | | | | | | 2 | 40 |
| 12 | Comparative | A | 1000 | 4 | 113 | — | — | 1 | 91 | 1 | 82 |
| | example | | | | | | | | | 2 | 40 |
| 13 | Comparative | B | 1000 | 4 | 113 | — | — | 1 | 91 | 1 | 82 |
| | example | | | | | | | | | 2 | 40 |
| 14 | Comparative | C | 1000 | 4 | 113 | — | — | — | — | 1 | 82 |
| | example | | | | | | | | | 2 | 40 |
| 15 | Example | C | 1000 | 4 | 113 | — | — | 1 | 91 | 1 | 82 |
| | | | | | | | | | | 2 | 40 |
| 16 | Example | D | 1000 | 4 | 113 | — | — | 1 | 91 | 1 | 82 |
| | | | | | | | | | | 2 | 40 |
| 17 | Example | E | 1000 | 4 | 113 | — | — | 1 | 91 | 1 | 82 |
| | | | | | | | | | | 2 | 40 |
| 18 | Example | F | 1000 | 4 | 113 | — | — | 1 | 91 | 1 | 82 |
| | | | | | | | | | | 2 | 40 |
| 19 | Example | G | 1000 | 4 | 113 | — | — | 1 | 91 | 1 | 82 |
| | | | | | | | | | | 2 | 40 |
| 20 | Example | F | 1000 | — | — | 3 | 258 | — | — | 2 | 21 |
| | | | | | | | | | | 3 | 69 |
| 21 | Example | F | 1000 | 4 | 73 | — | — | 2 | 124 | 2 | 21 |
| | | | | 5 | 68 | | | | | 3 | 69 |
| | | Phthaladin | | Mercapto | | | | | | Silver halide | |
| | | compound | | compound | | Pigment | | SBR latex | | mixed emulsion A | |
| Sample | | | Amount of | | Amount of | | Amount of | | Amount of | | Amount of |
| No. | | Kind | addition (g) | Kind | addition (g) | Kind | addition (g) | Kind | addition (g) | Kind | addition (g) |
| 11 | Comparative | 1 | 173 | 1 | 9 | 1 | 27 | *1 | 1082 | A | 158 |
| | Example | | | | | | | | | | |
| 12 | Comparative | 1 | 173 | 1 | 9 | 1 | 27 | *1 | 1082 | A | 158 |
| | Example | | | | | | | | | | |
| 13 | Comparative | 1 | 173 | 1 | 9 | 1 | 27 | *1 | 1082 | A | 158 |
| | Example | | | | | | | | | | |
| 14 | Comparative | 1 | 173 | 1 | 9 | 1 | 27 | *1 | 1082 | A | 158 |
| | Example | | | | | | | | | | |
| 15 | Example | 1 | 173 | 1 | 9 | 1 | 27 | *1 | 1082 | A | 158 |
| 16 | Example | 1 | 173 | 1 | 9 | 1 | 27 | *1 | 1082 | A | 158 |
| 17 | Example | 1 | 173 | 1 | 9 | 1 | 27 | *1 | 1082 | A | 158 |
| 18 | Example | 1 | 173 | 1 | 9 | 1 | 27 | *1 | 1082 | A | 158 |
| 19 | Example | 1 | 173 | 1 | 9 | 1 | 27 | *1 | 1082 | A | 158 |
| 20 | Example | 1 | 173 | 1 | 9 | 1 | 30 | *1 | 1082 | A | 158 |
| 21 | Example | 1 | 173 | 1 | 9 | 1 | 30 | *1 | 1082 | A | 158 |

*1 SBR latex (Tg: 20.5° C.)
*2 SBR latex (Tg: 23° C.)
*3 SBR core/shell type latex (core (Tg: 20.5° C.)/shell (Tg: 30° C.) = 70:30 in mass ratio)

TABLE 7

| | | Organic acid | | | | Organic | | | | | |
|---|---|---|---|---|---|---|---|---|---|---|---|
| | | silver salt | | Reducing agent | | polyhalogen | | Phthalazine | | Mercapto | |
| | | dispersion | | complex | | compound | | compound | | compound | |
| Sample | | | Amount of | | Amount of | | Amount of | | Amount of | | Amount of |
| No. | | Kind | addition (g) | Kind | addition (g) | Kind | addition (g) | Kind | addition (g) | Kind | addition (g) |
| 22 | Comparative | C | 1000 | — | — | 1 | 82 | 1 | 173 | 1 | 9 |
| | example | | | | | 2 | 40 | | | | |
| 23 | Comparative | C | 1000 | — | — | 1 | 82 | 1 | 173 | 1 | 9 |
| | example | | | | | 2 | 40 | | | | |
| 24 | Example | C | 1000 | 3 | 241 | 1 | 82 | 1 | 173 | 1 | 9 |
| | | | | | | 2 | 40 | | | | |
| 25 | Example | C | 1000 | 6 | 241 | 1 | 82 | 1 | 173 | 1 | 9 |
| | | | | | | 2 | 40 | | | | |
| 26 | Example | C | 1000 | 7 | 241 | 1 | 82 | 1 | 173 | 1 | 9 |
| | | | | | | 2 | 40 | | | | |
| 27 | Example | G | 1000 | 3 | 241 | 1 | 82 | 1 | 173 | 1 | 9 |
| | | | | | | 2 | 40 | | | | |
| 28 | Example | G | 1000 | 6 | 241 | 1 | 82 | 1 | 173 | 1 | 9 |
| | | | | | | 2 | 40 | | | | |
| 29 | Example | G | 1000 | 7 | 241 | 1 | 82 | 1 | 173 | 1 | 9 |
| | | | | | | 2 | 40 | | | | |

| | | | | | | Silver halide | |
|---|---|---|---|---|---|---|---|
| | | Pigment | | SBR latex | | mixed emulsion A | |
| Sample | | | Amount of | | Amount of | | Amount of |
| No. | | Kind | addition (g) | Kind | addition (g) | Kind | addition (g) |
| 22 | Comparative | 1 | 27 | *1 | 1082 | A | 158 |
| | Example | | | | | | |
| 23 | Comparative | 1 | 27 | *1 | 1082 | A | 158 |
| | Example | | | | | | |
| 24 | Example | 1 | 27 | *1 | 1082 | A | 158 |
| 25 | Example | 1 | 27 | *1 | 1082 | A | 158 |
| 26 | Example | 1 | 27 | *1 | 1082 | A | 158 |
| 27 | Example | 1 | 27 | *1 | 1082 | A | 158 |
| 28 | Example | 1 | 27 | *1 | 1082 | A | 158 |
| 29 | Example | 1 | 27 | *1 | 1082 | A | 158 |

*1 SBR latex (Tg: 20.50° C.)
*2 SBR latex (Tg: 23° C.)
*3 SBR core/shell type latex (core (Tg: 20.5° C.)/ shell (Tg: 30° C.) = 70:30 in mass ratio)

<<Preparation of Emulsion Layer (Photosensitive Layer) Application Fluid-20>>

Successively added were 1000 g of the organic acid silver salt dispersion F obtained above, 104 ml of water, 30 g of the pigment-1 dispersion, 21 g of the organic polyhalogen compound-2 dispersion, 60 g of the organic polyhalogen compound-3 dispersion, 173 g of the phthalazine compound-1 solution, 1082 g of the SBR latex (Tg: 23° C.) solution, 258 g of the reducing agent complex-3 dispersion, and 9 g of the mercapto compound-1 solution, and 110 g of the silver halide mixed emulsion A was added with thorough stirring immediately before application. The emulsion layer application fluid was directly sent to a coating die for application.

<<Preparation of Emulsion Layer (Photosensitive Layer) Application Fluid-21>>

Successively added were 1000 g of the organic acid silver salt dispersion F obtained above, 95 ml of water, 73 g of the reducing agent-4 dispersion, 68 g of the reducing agent-5 dispersion, 30 g of the pigment-1 dispersion, 21 g of the organic polyhalogen compound-2 dispersion, 69 g of the organic polyhalogen compound-3 dispersion, 173 g of the phthalazine compound-1 solution, 1082 g of the SBR core-shell type latex (core (Tg: 20° C.):shell (Tg: 30° C.)=70/30 weight ratio) solution, 124 g of the hydrogen bonding compound-2 dispersion, and 9 g of the mercapto compound-1 solution, and 110 g of the silver halide mixed emulsion A was added with thorough stirring immediately before application. The emulsion layer application fluid was directly sent to a coating die for application.

The application fluid of the emulsion face intermediate layer was prepared as in Example 1.

The application fluid of the emulsion face protective layer was prepared as in Example 1.

The heat developable photosensitive material was prepared as in Example 1.

The heat developable photosensitive materials-11 to 19 and 22 to 29 were prepared as in Example 1.

The amount of application (g/m²) of each compound in the emulsion layer is as shown in Tables 8 and 9.

The application and drying conditions were the same as in Example 1.

The degree of matting of the heat developable image recording material prepared was 550 second and 130 second for the photosensitive layer side and back face side, respectively, as Beck smoothness. The pH value of the film surface at the photosensitive layer side was 6.0.

(Preparation of Heat Developable Photosensitive Material-20)

The heat developable photosensitive material-2 was prepared by the same method as preparing the heat developable photosensitive material-1, except that the emulsion layer application fluid-1 for the heat developable photosensitive material-1 was changed to the emulsion layer application fluid-2, and the yellow dye compound 15 was eliminated from the halation preventive layer.

The amount of application (g/m²) of each compound in the emulsion layer is as shown in Table 8.

(Preparation of Heat Developable Photosensitive Material-21)

The heat developable photosensitive material-3 was prepared by the same method as preparing the heat developable photosensitive material-1, except that the emulsion layer application fluid-11 for the heat developable photosensitive material-11 was changed to the emulsion layer application fluid-3, and the yellow dye compound 15 was eliminated from the halation preventive layer. The fluorine based surfactants F-1, F-2, F-3 and F-4 in the protective second layer and back face protective layer were changed to the same weight of F-5, F-6, F-7 and F-8.

The amount of application (g/m²) of each compound in the emulsion layer is as shown in Table 8.

TABLE 8

| | | Organic acid | | | | | | Hydrogen | | Organic | |
|---|---|---|---|---|---|---|---|---|---|---|---|
| | | silver salt | | Reducing agent | | | | bonding | | polyhalogen | |
| | | dispersion | | Reducing agent | | complex | | compound | | compound | |
| | | | Amount of | | Amount of | | Amount of | | Amount of | | Amount of |
| Sample | | | application | | application | | application | | application | | application |
| No. | | Kind | (g/m²) | Kind | (g/m²) | Kind | (g/m²) | Kind | (g/m²) | Kind | (g/m²) |
| 11 | Comparative | A | 1.33 | 4 | 0.6 | — | — | — | — | 1 | 0.4 |
| | example | | | | | | | | | 2 | 0.22 |
| 12 | Comparative | A | 1.33 | 4 | 0.6 | — | — | 1 | 91 | 1 | 0.4 |
| | example | | | | | | | | | 2 | 0.22 |
| 13 | Comparative | B | 1.33 | 4 | 0.6 | — | — | 1 | 91 | 1 | 0.4 |
| | example | | | | | | | | | 2 | 0.22 |
| 14 | Comparative | C | 1.33 | 4 | 0.6 | — | — | — | — | 1 | 0.4 |
| | example | | | | | | | | | 2 | 0.22 |
| 15 | Example | C | 1.33 | 4 | 0.6 | — | — | 1 | 91 | 1 | 0.4 |
| | | | | | | | | | | 2 | 0.22 |
| 16 | Example | D | 1.33 | 4 | 0.6 | — | — | 1 | 91 | 1 | 0.4 |
| | | | | | | | | | | 2 | 0.22 |
| 17 | Example | E | 1.33 | 4 | 0.6 | — | — | 1 | 91 | 1 | 0.4 |
| | | | | | | | | | | 2 | 0.22 |
| 18 | Example | F | 1.33 | 4 | 0.6 | — | — | 1 | 91 | 1 | 0.4 |
| | | | | | | | | | | 2 | 0.22 |
| 19 | Example | G | 1.33 | 4 | 0.6 | — | — | 1 | 91 | 1 | 0.4 |
| | | | | | | | | | | 2 | 0.22 |
| 20 | Example | F | 1.33 | — | — | 3 | 1.36 | — | — | 2 | 0.12 |
| | | | | | | | | | | 3 | 0.34 |
| 21 | Example | F | 1.33 | 4 | 0.39 | — | — | 2 | 124 | 2 | 0.12 |
| | | | | 5 | 0.36 | | | | | 3 | 0.34 |
| | | Phthalazine | | Mercapto | | | | | | Silver halide | |
| | | compound | | compound | | Pigment | | SBR latex | | (as Ag) | |
| | | | Amount of | | Amount of | | Amount of | | Amount of | | Amount of |
| Sample | | | application | | application | | application | | application | | application |
| No. | | Kind | (g/m²) | Kind | (g/m²) | Kind | (g/m²) | Kind | (g/m²) | Kind | (g) |
| 11 | Comparative | 1 | 0.18 | 1 | 0.0013 | 1 | 0.0034 | *1 | 9.86 | A | 0.13 |
| 12 | Comparative | 1 | 0.18 | 1 | 0.0013 | 1 | 0.0034 | *1 | 9.86 | A | 0.13 |
| 13 | Comparative | 1 | 0.18 | 1 | 0.0013 | 1 | 0.0034 | *1 | 9.86 | A | 0.13 |
| 14 | Comparative | 1 | 0.18 | 1 | 0.0013 | 1 | 0.0034 | *1 | 9.86 | A | 0.13 |
| 15 | Example | 1 | 0.18 | 1 | 0.0013 | 1 | 0.0034 | *1 | 9.86 | A | 0.13 |
| 16 | Example | 1 | 0.18 | 1 | 0.0013 | 1 | 0.0034 | *1 | 9.86 | A | 0.13 |
| 17 | Example | 1 | 0.18 | 1 | 0.0013 | 1 | 0.0034 | *1 | 9.86 | A | 0.13 |
| 18 | Example | 1 | 0.18 | 1 | 0.0013 | 1 | 0.0034 | *1 | 9.86 | A | 0.13 |
| 19 | Example | 1 | 0.18 | 1 | 0.0013 | 1 | 0.0034 | *1 | 9.86 | A | 0.13 |
| 20 | Example | 1 | 0.18 | 1 | 0.0013 | 1 | 0.0038 | *2 | 9.86 | A | 0.09 |
| 21 | Example | 1 | 0.18 | 1 | 0.0013 | 1 | 0.0038 | *3 | 9.86 | A | 0.09 |

*1 SBR latex (Tg: 20.5° C.)
*2 SBR latex (Tg: 23° C.)
*3 SBR core/shell type latex (core (Tg: 20.5° C.)/ shell (Tg: 30° C.) = 70:30 in mass ratio)

TABLE 9

| | | Organic acid | | | | Organic | | | | | |
|---|---|---|---|---|---|---|---|---|---|---|---|
| | | silver salt | | Reducing agent | | polyhalogen | | Phthalazine | | Mercapto | |
| | | dispersion | | complex | | compound | | compound | | compound | |
| | | | Amount of | | Amount of | | Amount of | | Amount of | | Amount of |
| Sample | | | application | | application | | application | | application | | application |
| No. | | Kind | (g/m²) | Kind | (g/m²) | Kind | (g/m²) | Kind | (g/m²) | Kind | (g/m²) |
| 22 | Comparative | C | 1.33 | — | — | 1 | 0.4 | 1 | 0.18 | 1 | 0.0013 |
| | example | | | | | 2 | 0.22 | | | | |
| 23 | Comparative | C | 1.33 | — | — | 1 | 0.4 | 1 | 0.18 | 1 | 0.0013 |
| | example | | | | | 2 | 0.22 | | | | |
| 24 | Example | C | 1.33 | 3 | 1.2 | 1 | 0.4 | 1 | 0.18 | 1 | 0.0013 |
| | | | | | | 2 | 0.22 | | | | |
| 25 | Example | C | 1.33 | 6 | 1.2 | 1 | 0.4 | 1 | 0.18 | 1 | 0.0013 |
| | | | | | | 2 | 0.22 | | | | |
| 26 | Example | C | 1.33 | 7 | 1.2 | 1 | 0.4 | 1 | 0.18 | 1 | 0.0013 |
| | | | | | | 2 | 0.22 | | | | |
| 27 | Example | G | 1.33 | 3 | 1.2 | 1 | 0.4 | 1 | 0.18 | 1 | 0.0013 |
| | | | | | | 2 | 0.22 | | | | |
| 28 | Example | G | 1.33 | 6 | 1.2 | 1 | 0.4 | 1 | 0.18 | 1 | 0.0013 |
| | | | | | | 2 | 0.22 | | | | |
| 29 | Example | G | 1.33 | 7 | 1.2 | 1 | 0.4 | 1 | 0.18 | 1 | 0.0013 |
| | | | | | | 2 | 0.22 | | | | |

| | | | | | | Silver halide | |
|---|---|---|---|---|---|---|---|
| | | Pigment | | SBR latex | | (as Ag) | |
| | | | Amount of | | Amount of | | Amount of |
| Sample | | | application | | application | | application |
| No. | | Kind | (g/m²) | Kind | (g/m²) | Kind | (g) |
| 22 | Comparative | 1 | 0.034 | *1 | 9.86 | A | 0.13 |
| | Example | | | | | | |
| 23 | Comparative | 1 | 0.034 | *1 | 9.86 | A | 0.13 |
| | Example | | | | | | |
| 24 | Example | 1 | 0.034 | *1 | 9.86 | A | 0.13 |
| 25 | Example | 1 | 0.034 | *1 | 9.86 | A | 0.13 |
| 26 | Example | 1 | 0.034 | *1 | 9.86 | A | 0.13 |
| 27 | Example | 1 | 0.034 | *1 | 9.86 | A | 0.13 |
| 28 | Example | 1 | 0.034 | *1 | 9.86 | A | 0.13 |
| 29 | Example | 1 | 0.034 | *1 | 9.86 | A | 0.13 |

*1 SBR latex (Tg: 20.5° C.)
*2 SBR latex (Tg: 23° C.)
*3 SBR core/shell type latex (core (Tg: 20.5° C.)/ shell (Tg: 30° C.) = 70:30 in mass ratio)

The chemical structures of the compounds used in the examples of the invention in the second aspect are shown below:

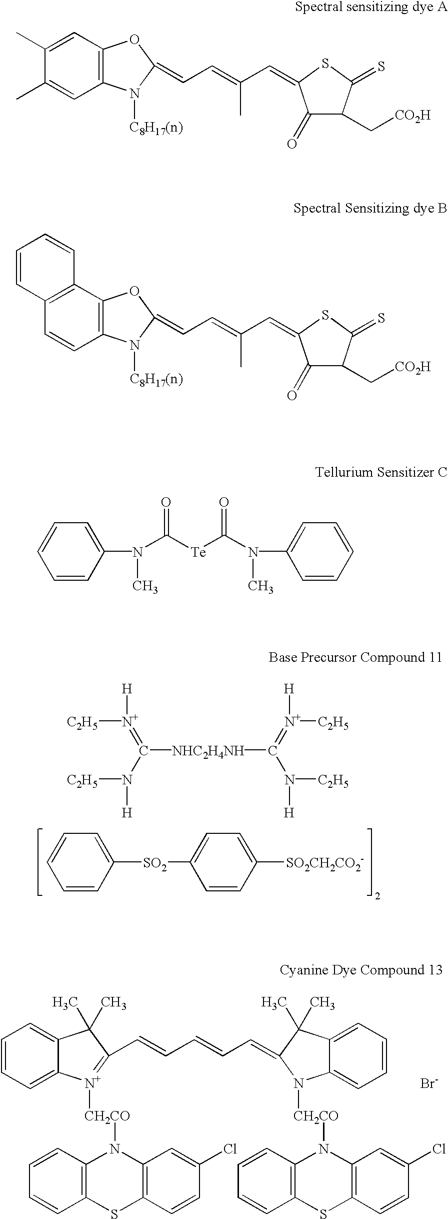

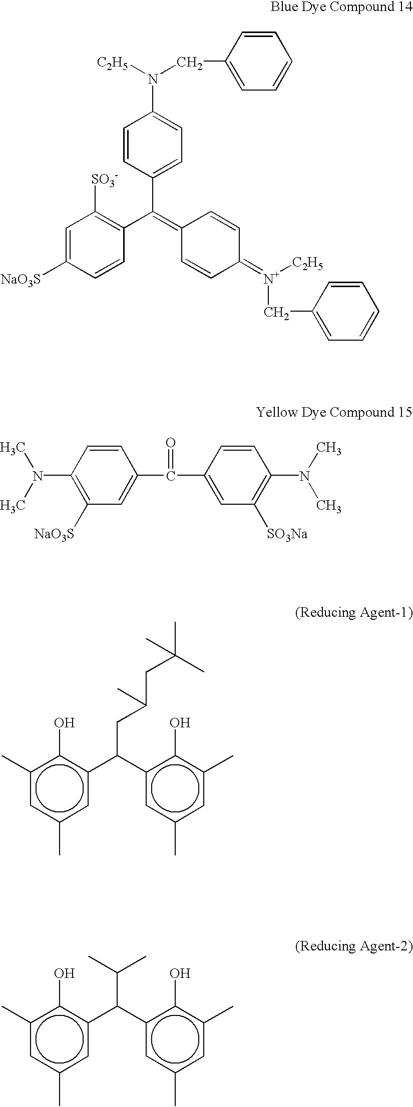

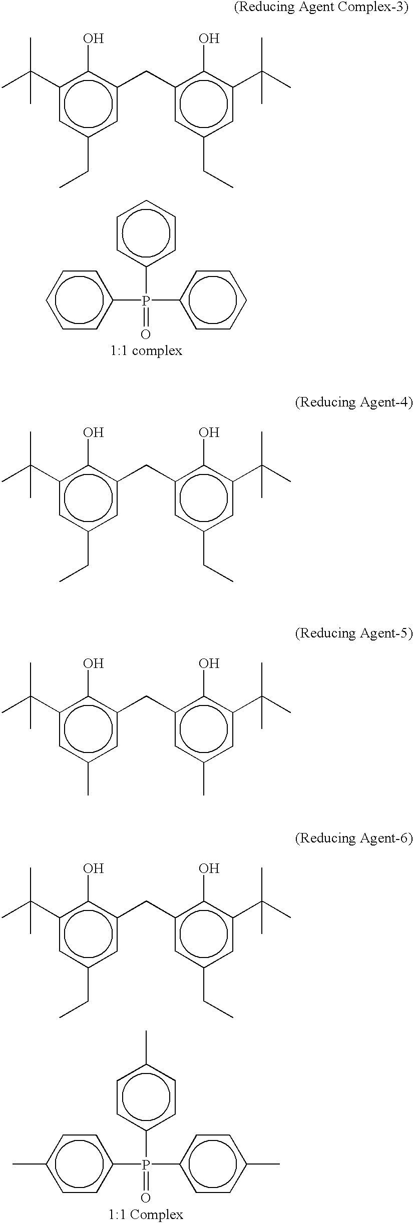

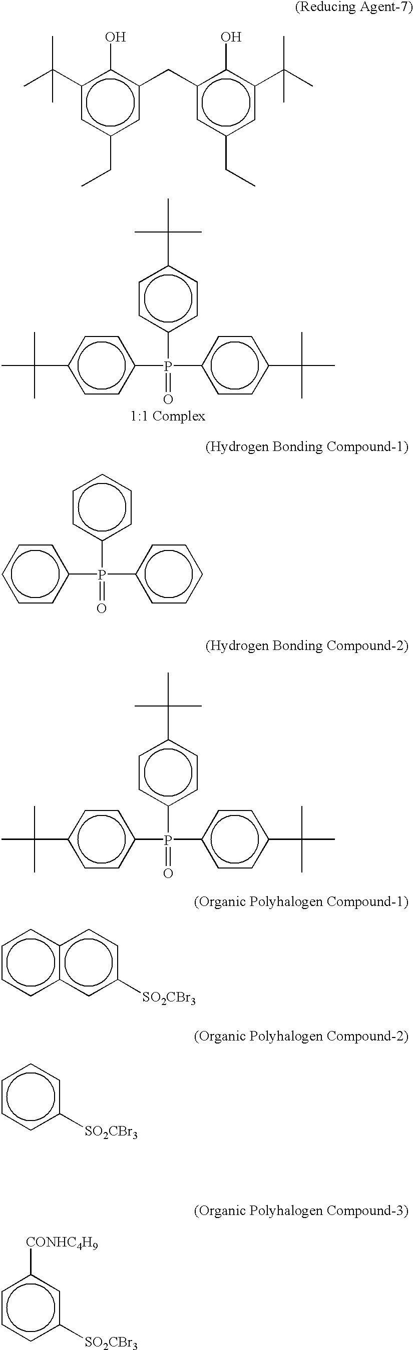

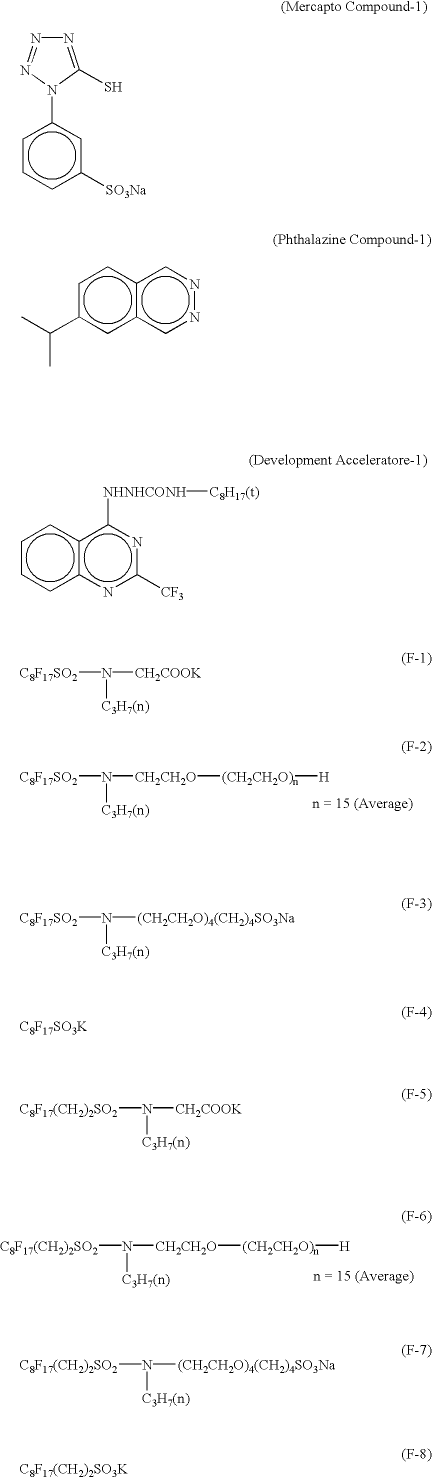

Evaluation of Photographic Performance

The photographic material was exposed and heat-developed (heated with four panels set at 112° C., 119° C., 121° C., and 121° C. for 24 seconds) with Fiji Medical Dry laser Imager (equipped with a semiconductor laser at 660 nm with a maximum output of 60 mW (111B)), and the image obtained was evaluated with a densitometer. The results are shown in Tables 8 and 9.

Evaluation of Image Preservative Property

After exposing and heat-developed (heated with four panels set at 112° C., 119° C., 121° C., and 121° C. for 24 seconds) the photographic material with Fiji Medical Dry laser Imager (equipped with a semiconductor laser at 660 nm with a maximum output of 60 mW (111B)), the material was sufficiently irradiated with light, sealed in a light-shielding bag after adjusting the atmosphere at 70% RH for 3 hours, and was left stand for 24 hours at 60° C. The rate of change of Dₘᵢₙ is shown in Tables 10 and 11.

TABLE 10

| | | | Rate of change of image |
|---|---|---|---|
| Sample No. | | Dₘᵢₙ | preservative property |
| 11 | Comparative example | 102 | 100 |
| 12 | Comparative example | 98 | 88 |
| 13 | Comparative example | 99 | 84 |
| 14 | Comparative example | 100 | 90 |
| 15 | Example | 96 | 35 |
| 16 | Example | 96 | 48 |
| 17 | Example | 95 | 20 |
| 18 | Example | 97 | 10 |
| 19 | Example | 96 | 0 |
| 20 | Example | 96 | 5 |
| 21 | Example | 94 | 0 |

* The sample No. 14 is used as a standard with the Dₘᵢₙ value of 100.

TABLE 11

| | | | Rate of change of image |
|---|---|---|---|
| Sample No. | | Dₘᵢₙ | preservative property |
| 22 | Comparative example | 99 | 80 |
| 23 | Comparative example | 100 | 90 |
| 24 | Example | 93 | 20 |
| 25 | Example | 95 | 30 |
| 26 | Example | 92 | 22 |
| 27 | Example | 94 | 8 |
| 28 | Example | 96 | 0 |
| 29 | Example | 93 | 2 |

* The sample No. 23 is used as a standard with the Dₘᵢₙ value of 100.

The invention provides a heat developable photosensitive material having low minimum density (Dₘᵢₙ) as well as being excellent in image preservative property,

### Example 5

The PET substrate was prepared and subjected to corona treatment in the same manner as in Example 1.

(Preparation of undercoat substrate)

| | |
|---|---|
| (1) Preparation of undercoat application fluid | |
| Recipe (i) (for photosensitive layer side undercoat layer) | |
| Pesresin A-520 (30% by mass solution) made by Takamatsu | 59 g |
| Oil & Fat Co., Ltd. | |
| polyethylene monoglycol monononylpehnyl ether | 5.4 g |
| (mean ethylene oxide number = 8.5) | |
| MP-1000 (polymer fine particles, average particle | 0.91 g |
| diameter 0.4 μm) made by Soken Chemical and Engineering | |
| Co., Ltd. | |
| distilled water | 935 ml |
| Recipe (ii) (for back face first layer) | |
| styrene-butadiene copolymer latex | 158 g |
| (solid fraction 40% by mass, styrene/butadiene weight | |
| ratio = 68/32) | |
| sodium 2,4-dichloro-6-hydroxy-S-triazine (8% by mass | 20 g |
| aqueous solution) | |
| 1% by mass aqueous solution of sodium laurylbenzene | 10 ml |
| sulfonate | |
| distilled water | 854 ml |
| Recipe (iii) (for back face second layer) | |
| SnO2/SbO (mass ratio 9/1, average particle diameter 0.038 | 140 g |
| μm, 17% by mass dispersion) | |
| gelatin (10% by mass aqueous solution) | 89.2 g |
| metrose TC-5 (2% by mass aqueous solution) made by | 8.6 g |
| Shin-Etsu Chemical Co., Ltd. | |
| MP-1000 made by Soken Chemical and Engineering Co., | 0.01 g |
| Ltd. | |
| 1% by mass aqueous solution of sodium dodecylbenzene | 10 ml |
| sulfonate | |
| NaOH (1% by mass) | 6 ml |
| Proxel (made by ICI) | 1 ml |
| distilled water | 805 ml |

After subjecting both faces of the biaxially drawn polyethylene terephthalate substrate with a thickness of 175 μm to corona discharge treatment, the undercoat application fluid of the recipe (i) was applied on one face (photosensitive layer face) with an amount of wet coating of 6.6 ml/m² (per one face) with a wire bar, followed by drying at 180° C. for 5 minutes. Then, the undercoat application fluid of the recipe (ii) was applied on the other face (back face) with an amount of wet coating of 5.7 ml/m² with a wire bar followed by drying at 180° C. for 5 minutes. Furthermore, the application fluid of the recipe (iii) was applied on the back face with an amount of wet coating of 7.7 ml/m² with a wire bar followed by drying at 180° C. for 6 minutes.

(Preparation of Back Face Application Fluid)

(Preparation of Solid Fine Particle Dispersion Solution (a) of Base Precursor)

Mixed to a total weight of 5.0 kg by adding water were 1.5 kg of the base precursor compound-1, 225 g of surfactant (trade name Demol N made by Kao Corporation), 937.5 g of diphenyl sulfone and 15 g of parahydroxy benzoic acid butyl ester (trade name Meckins made by Ueno Pharmaceutical Co.). The mixed solution was dispersed with beads using a horizontal sand mill (UVM-2 made by I. mecs Co.). The mixed solution was sent into UVM-2 filled with zirconia beads with an average diameter of 0.5 mm using a diaphragm pump, and was dispersed until a desired average particle diameter is obtained under an inner pressure of 50 Pa or more.

The dispersion was dispersed until the absorbance ratio between the absorbance of the dispersion at 450 nm and absorbance of the dispersion at 650 nm (D450/D650) becomes 2.2 or more.

The dispersion obtained was diluted with distilled water so that the concentration of the base precursor becomes 20% by weight, and was filtered with a polypropylene filter with a mean pore size of 3 μm for removing dusts before practical use.

(Preparation of Dispersion Fluid of Slid Fine Particles of Dye)

Mixed with distilled water to a total weight of 60 kg were 6.0 kg of the cyanine dye compound-1, 3.0 kg of sodium p-dodecylbenzene sulfonate, 0.6 kg of the surfactant (Demol made by Kao Corporation) and 0.15 kg of a defoaming agent (trade name Surfinol 104E made by Nisshin Chemicals Co., Ltd.). The mixed solution was dispersed with 0.5 mm zirconia beads using a horizontal sand mill (UVM-2 made by I.mecs Co.).

The dispersion was dispersed until the absorbance ratio between the absorbance of the dispersion at 650 nm and absorbance of the dispersion at 750 nm (D650/D750) becomes 5.0 or more.

The dispersion obtained was diluted with distilled water so that the concentration of the cyanine dye becomes 6% by mass, and was filtered with a polypropylene filter with a mean pore size of 1 μm for removing dusts before practical use.

(Preparation of Halation Preventive Layer Application Fluid)

Mixed and adjusted to a total volume of 8183 ml to prepare the application fluid of the halation preventive layer were 30 g of gelatin, 24.5 g of polyacrylamide, 2.2 g of 1 mol/L sodium hydroxide, 2.4 g of monodisperse fine particles of polymethyl methacrylate (average particle size 8 μm, standard deviation of particle size 0.4), 0.08 g of benzoisothiazolinone, 35.9 g of the dispersion solution of the solid fine particles of the dye, 74.2 g of the dispersion solution of the solid fine particles of the base precursor, 0.6 g of sodium polyethylene sulfonate, 0.21 g of the blue dye compound-1, 0.15 g of the yellow dye compound, and 8.3 g of the acrylic acid/ethyl acrylate copolymer latex (copolymerization ratio 5/95), thereby preparing the halation prevention layer application fluid.

(Preparation of Application Fluid of Back Face Protective Layer)

The vessel was warmed at 40° C., and 40 g of gelatin, 1.5 g of liquid paraffin in the liquid paraffin emulsion, 35 mg of benzoisothiazolinone, 6.8 g of 1 mole/L sodium hydroxide, 0.5 g of sodium t-octylphenoxyethoxyethane sulfonate, 0.27 g of sodium polystyrene sulfonate, 37 mg of fluorine based surfactant (F-1: potassium N-perluorooctylsulfonyl-N-propylalanine), 150 mg of fluorine based surfactant (F-2: polyethyleneglycol mono(N-perfluorooctylsulfonyl-N-popyl-2-aminoethyl) ether [mean degree of polymerization of ethylene oxide: 15]), 64 mg of fluorine based surfactant (F-3), 32 mg of fluorine based surfactant, 6.0 g of acrylic acid/ethyl acrylate copolymer (copolymerization weight ratio 5/95) and 2.0 g of N,N-ethylenebis(vinylsulfone actamide) were mixed. The mixture was diluted to 10 liter with water to form the application fluid of the back face protective layer.

(Preparation of Silver Halide Emulsion)

<<Preparation of Silver Halide Emulsion-1>>

Added in 1421 ml of distilled water was 3.1 ml of 1% by mass potassium bromide solution, and 3.5 ml of 0.5 mol/L sulfuric acid and 31.7 g of gelatin modified with phthalic acid. The solution was kept at 30° C. with stirring in a stainless steel reaction vessel, Solution A prepared by diluting 22.22 g of silver nitrate to 95.4 ml by adding distilled water, and solution B prepared by diluting 15.3 g of potassium iodide and 0.8 g of potassium iodide to 97.4 ml by adding distilled water were added in 45 seconds at a constant flow rate. Then, 10 ml of 3.5% by mass aqueous hydrogen peroxide solution was added, followed by adding 10.8 ml of 10% by mass of aqueous benzoimidazole solution. Then, solution C prepared by diluting 51.86 g of silver nitrate to 317.5 ml by adding distilled water, and solution D prepared by diluting 44.2 g of potassium bromide and 2.2 g of potassium iodide to 400 ml by adding distilled water were added in 20 minutes at a constant flow rate, wherein solution D was added by a controlled double jet method while maintaining pAg at 8.1. Hexachloro iridium (III) potassium slat was added after 10 minutes of start of addition of solutions C and D so that the amount of iridium becomes 1×10⁻⁴ mole per one mole of silver. Hexacyano iron (II) potassium was added after 5 seconds of completion of addition of solution C so that the amount of iron becomes 3×10⁻⁴ mole per one mole of silver. pH of the solution was adjusted to 3.8 using 0.5 mol/L sulfuric acid solution and, after stopping to stir, particles were precipitated followed by desalting and washing with water. The pH of the emulsion was adjusted to 5.9 using 1 mol/L sodium hydroxide, obtaining a silver halide dispersion with pAg of 8.0.

The temperature of the silver halide dispersion was kept at 38° C., and 5 ml of 0.34% by mass methanol solution of 2-benzoisothiazoline-3-one was added. After 40 minutes, a methanol solution containing spectral sensitizing dyes A and B in 1:1 molar ratio was added so that the combined amount of the sensitizing dyes A and B becomes 1.2×10⁻³ per one mole of silver, and the temperature of the solution was raised to 47° C. after one minute. 20 minutes after the increase of the temperature, a methanol solution of sodium benzene thiosulfonate was added in a proportion of 7.6×10⁻⁵ per one mole of silver and, after 5 minutes, a methanol solution of tellurium sensitizer C was added in a proportion of 2.9×10⁻⁴ mole per one mole of silver, followed by ripening for 91 minutes. Further added was 1.3 ml of a 0.8% by mass of methanol solution of N,N′-dihydroxy-N″-diethylamine and, after additional 4 minutes, a methanol solution of 5-methyl-2-mercaptobenzimidazole and a methanol solution of 1-phenyl-2-heptyl-5-mercapto-1,3,4-triazole were added in the proportions of 4.8×10⁻³ mole and 5.4×10⁻³ mole, respectively, per one mole of silver, thereby preparing the silver halide emulsion-1.

The particles in the silver halide emulsion had an average equivalent-circle diameter of 0.042 μm, and a variation coefficient of the equivalent-circle diameter of 20%, and contained 3.5 mol % of iodine uniformly distributed in the silver bromide particles. The particle size or the like was determined using an electron microscope from the average particle size of 1000 particles. The proportion of the [100] face in the particles was found to be 80% using a Kubelka-Munk method.

<<Preparation of Silver Halide Emulsion-2>>

The silver halide emulsion-2 was prepared by the same method as in the silver halide emulsion-1, except that the temperature of the solution for forming the particles was changed from 30° C. to 47° C., dilution of solution B of 15.9 g of potassium bromide was changed to 97.4 ml using distilled water, dilution of solution D of 45.8 g of potassium bromide was changed to 400 ml using distilled water, and the time period for adding solution C was changed to 30 minutes while eliminating potassium hexacyano iron (II). Precipitation, desalting and washing with water were carried out as in the silver halide emulsion-1. Spectral sensitization, chemical sensitization, and addition of 5-methyl-2-mercaptobenzoimidazole and 1-phenyl-2-heptyl-5-mercapto-1,3,4-triazole were preformed as in the emulsion-1, except that addition of the methanol solution of the spectral sensitizing dyes A and B in 1:1 molar ratio was changed to 7.5×10⁻⁴ mole per one mole of silver as a sum of the sensitizing dyes A and B, addition of the tellurium sensitizer C was changed to 1.1×10⁻⁴ mole per one mole of silver, and addition of 1-phenyl-2-heptyl-5-mercapto-1,3,4-triazole was changed to 3.3×10⁻³ mole per one mole of silver, thereby obtaining the silver halide emulsion-2. The emulsion particles of the silver halide emulsion-2 were cubic particles of pure silver bromide with an average equivalent-circle diameter of 0.080 μm and a variation coefficient of the equivalent-circle diameter of 20%.

<<Preparation of Silver Halide Emulsion-3>>

The silver halide emulsion-3 was prepared by the same method as in preparing the silver halide emulsion-1, except that the temperature of the solution for forming the particles was changed from 30° C. to 27° C. Precipitation, desalting and washing with water were performed as in the silver halide emulsion-1. The silver halide emulsion-3 was obtained by the same method as in the emulsion-1, except that addition of the solid dispersion (in aqueous gelatin solution) of the sensitizing dyes A and B in 1:1 molar ratio was changed to 6×10⁻³ mole per one mole of silver as a sum of the sensitizing dyes A and B, addition of the tellurium sensitizer C was changed to 5.2×10⁻⁴ mole per one mole of silver, and 5×10⁻⁴ mole of bromoauric acid per one mole of silver and 2×10⁻³ mole of potassium thiocyanate per one mole of silver were added 3 minutes after addition of the tellurium sensitizer. The particles in the silver halide emulsion had an average equivalent-circle diameter of 0.034 μm, and a variation coefficient of the equivalent-circle diameter of 20%, and contained 3.5 mol % of iodine uniformly distributed in the silver bromide particles.

<<Preparation of Mixed Emulsion A for Application Fluid>>

Dissolved were 70% by mass of silver halide emulsion-1, 15% by mass of silver halide emulsion-2 and 15% by mass of silver halide emulsion-3, and 1% by mass of aqueous benzothiazolium iodide solution was added in a proportion of 7×10⁻³ mole per one mole of silver. Water was further added so that the content of the silver halide becomes 38.2 g as converted into silver per 1 kg of the application fluid of the mixed emulsion.

<<Preparation of Organic Acid Silver Salt Dispersions A to J>>

<Purification of Behenic Acid A>

Mixed with 1200 kg of isopropyl alcohol was 100 kg of behenic acid made by Henkel Co. (trade name Edenor C22-85R), dissolved at 50° C. and, after filtration with a 10 μm filter, the solution was cooled to 30° C. for recrystallization. The cooling speed for recrystallization was controlled to 3° C./hour. The crystals obtained were filtered by centrifugation, rinsed with 100 kg of isopropyl alcohol, and recrystallization was repeated twice. The initial precipitate at the early stage of recrystallization was filtered to remove lignoceric acid followed by drying. The content of behenic acid was found to be 99.99% from the GC-FID measurement after esterification of the crystalline product obtained. The content of erucic acid was 0.000001%.

<Purification of Behenic Acid B>

Mixed with 1200 kg of isopropyl alcohol was 100 kg of behenic acid made by Henkel Co. (trade name Edenor C22-85R), dissolved at 50° C. and, after filtration with a 10 μm filter, the solution was cooled to 30° C. for recrystallization. The cooling speed for recrystallization was controlled to 3° C./hour. The crystals obtained were filtered by centrifugation, rinsed with 100 kg of isopropyl alcohol, and recrystallization was repeated twice, followed by recrystallization. The content of behenic acid was found to be 97.5% and the content of lignoceric acid was found to be 2% from the GC-FID measurement after esterification of the crystalline product obtained. The content of erucic acid was 0.000001%.

<Purification of Arachidic Acid>

Mixed with 1200 kg of isopropyl alcohol was 100 kg of arachidic acid made by Tokyo Kasei Kogyo Co., dissolved at 50° C. and, after filtration with a 10 μm filter, the solution was cooled to 20° C. for recrystallization. The cooling speed for recrystallization was controlled to 3° C./hour. The crystals obtained were filtered by centrifugation, rinsed with 100 kg of isopropyl alcohol, and recrystallization was repeated twice. The initial precipitate at the early stage of recrystallization was filtered to remove carboxylic acids having longer chain length than arachidic acid, followed by drying. The content of arachidic acid was found to be 99.99% from the GC-FID measurement after esterification of the crystalline product obtained. The content of erucic acid was 0.000001%.

<Purification of Stearic Acid>

Mixed with 1200 kg of isopropyl alcohol was 100 kg of stearic acid made by Tokyo Kasei Kogyo Co., displved at 50° C. and, after filtration with a 10 μm filter, the solution was cooled to 20° C. for recrystallization. The cooling speed for recrystallization was controlled to 3° C./hour. The crystals obtained were filtered by centrifugation, rinsed with 100 kg of isopropyl alcohol, and recrystallization was repeated twice. The initial precipitate at the early stage of recrystallization was filtered to remove carboxylic acids having longer chain length than stearic acid, followed by drying. The content of stearic acid was found to be 99.99% from the GC-FID measurement after esterification of the crystalline product obtained. The content of erucic acid was 0.000001%.

<Preparation of Organic Acid Silver Salt Dispersions A to J>

Mixed with 258 mole of organic acids as a combination of behenic acid A, behenic acid B, arachidic acid, stearic acid and erucic acid made by Tokyo Kasei Kogyo Co. with the composition shown in Table 12 were 422 L of distilled water, 49.2 L of 5 mol/L aqueous solution of NaOH and 120 L of t-butyl alcohol. The mixture was allowed to react at 75° C. for 1 hour to obtain a solution of the organic acid sodium salts. Separately prepared was 206.2 L of aqueous solution (pH 4.0) of 40.4 Kg of silver nitrate, which was warmed at 10° C. A vessel containing 635 L of distilled water and 30 L of t-butyl alcohol was kept at 30° C., and the total amount of the organic acid sodium solution and the total amount of the aqueous silver nitrate solution were added in 93 minutes and 15 seconds and 90 minutes, respectively, at a constant flow rate. Only the aqueous silver nitrate solution was added in 11 minutes after initiation of the aqueous silver nitrate solution, addition of the organic acid sodium solution was initiated thereafter, and only the organic acid sodium solution was added in the last 14 minutes and 15 seconds after completing addition of the aqueous silver nitrate solution. The temperature in the reaction vessel was kept at 30° C., and external temperature was controlled so as to maintain a constant temperature of the reaction solution. The temperature in the piping system for the organic acid sodium solution was kept constant by circulating warm water in the outer space of the double wall pipe, and the liquid temperature of the outlet at the tip of the nozzle was adjusted to 75° C. The temperature of the piping system of the aqueous silver nitrate solution was also kept constant by circulating cooled water in the outer space of the double wall pipe. The possessions for adding the organic acid sodium solution and aqueous silver nitrate solution were disposed to be symmetrical relative to the central axis of the stirrer with their elevations adjusted not to touch the reaction solution.

After completing addition of the organic acid sodium solution, the solution was continued to be stirred for 20 minutes while keeping the temperature, which was raised to 35° C. for 30 minutes, and the precipitate was ripened for 210 minutes thereafter. The solid fraction was filtered off by centrifugal filtration, and was washed with water until conductivity of the filtered water decreases to 70 μS/cm, thereby obtaining the organic acid silver salt. The solid fraction obtained was stored as a wet cake without drying.

The shape of the organic acid silver salt particle prepared was as shown in Table 13.

Added to the wet cake corresponding to 260 kg of solid fraction was 19.3 kg of polyvinyl alcohol (trade name: PVA-217) and water to a total weight of 1000 kg. The suspended solution was formed into a slurry with a dissolver blade, followed by preliminary dispersion with a pipe line mixer (PM-10 made by Mizuho Industries Co.).

The solution after the preliminary dispersion was processed 3 times with a dispersion apparatus (trade name: Micro-Fluidizer M610 made by Micro-Fluidex International Co., equipped with Z-type interaction chamber) by adjusting the pressure at 1150 kg/cm², thereby obtaining the organic acid silver salt dispersion. Coil type heat exchangers were attached at the front and rear sides, respectively, for cooling, and the dispersion temperature was adjusted at 18° C. by controlling the temperature of the coolant.

The organic acid silver salt dispersions A to J were obtained as described above.

(Preparation of Reducing Agent Dispersion)

<<Preparation of Reducing Agent Complex-1 Dispersion>>

A slurry was prepared by adding 10 kg of water with thorough stirring into 10 kg of the reducing agent complex-1 (1:1 complex of 6,6′-di-t-butyl-4,4¹-dimethyl-2,2′-butylidenediphenol and triphenyl phosphine oxide), 0.12 kg of triphenyl phosphine oxide and 16 kg of 10% by mass aqueous solution of polyvinyl alcohol (Poval MP203 made by Kuraray Co., Ltd.). The slurry was sent with a diaphragm pump and, after dispersing for 4 hours and 30 minutes using a horizontal sand mill (UVM-2 made by I.mecs Co.) filled with zirconia beads with an average diameter of 0.5 mm, the concentration of the reducing agent complex was adjusted to 22% by mass by adding 0.2 g of sodium benzoisothiazolinone and water, thereby obtaining the reducing agent complex-1 dispersion. The reducing agent complex particles contained in the reducing agent complex dispersion had a median diameter of 0.45 μm and a maximum particle diameter of 1.45 μm. The educing agent complex dispersion obtained was filtered with a polypropylene filter with a pore diameter of 3.0 μm to remove foreign substances such as dusts.

<<Preparation of Reducing Agent-2 Dispersion>>

A slurry was prepared by adding 10 kg of water with thorough stirring into 10 kg of the reducing agent-2 (6.6°-di-t-butyl-4,4′-dimethyl-2,2′-butylidenediphenol and triphenyl phosphine oxide) and 16 kg of 10% by mass aqueous solution of polyvinyl alcohol (Poval MP203 made by Kuraray Co., Ltd.). The slurry was sent with a diaphragm pump and, after dispersing for 4 hours and 30 minutes using a horizontal sand mill (UVM-2 made by I.mecs Co.) filled with zirconia beads with an average diameter of 0.5 mm, the concentration of the reducing agent complex was adjusted to 25% by mass by adding 0.2 g of sodium benzoisothiazolinone and water. The reducing agent-2 dispersion was obtained by heat-treating the dispersion solution at 60° C. for 5 hours. The reducing agent complex particles contained in the reducing agent dispersion had a median diameter of 0.40 μm and a maximum particle diameter of 1.5 μm. The reducing agent dispersion obtained was filtered with a polypropylene filter with a pore diameter of 3.0 μm to remove foreign substances such as dusts.

<<Preparation of Hydrogen Bonding Compound-1 Dispersion>>

A slurry was obtained by adding 10 kg of water with thorough stirring into 10 kg of the hydrogen bonding compound-1 (tri(4-t-butylphenyl)phosphine oxide) and 16 kg of 10% by mass aqueous solution of modified polyvinyl alcohol (Poval MP203 made by Kuraray Co., Ltd.). The slurry was sent with a diaphragm pump and, after dispersing for 3 hours and 30 minutes using a horizontal sand mill (UVM-2 made by I.mecs Co.) filled with zirconia beads with an average diameter of 0.5 mm, the concentration of the hydrogen bonding compound was adjusted to 25% by mass by adding 0.2 g of sodium benzoisothiazolinone and water. The hydrogen bonding compound-1 dispersion was obtained by heat-treating the dispersion solution at 80° C. for 1 hour. The hydrogen bonding compound particles contained in the hydrogen bonding compound dispersion had a median diameter of 0.35 μm and a maximum particle diameter of 1.5 μm. The hydrogen bonding compound dispersion obtained was filtered with a polypropylene filter with a pore diameter of 3.0 μm to remove foreign substances such as dusts.

<<Preparation of Development Accerelator-1 Dispersion>>

A slurry was obtained by adding 10 kg of water with thorough stirring into 10 kg of development accelerator-1 and 20 kg of 10% by mass aqueous solution of modified polyvinyl alcohol (Poval MP203 made by Kuraray Co., Ltd.) The slurry was sent with a diaphragm pump and, after dispersing for 3 hours and 30 minutes using a horizontal sand mill (UVM-2 made by Imex Co.) filled with zirconia beads with an average diameter of 0.5 mm, the concentration of the development accelerator was adjusted to 20% by mass by adding 0.2 g of sodium benzoisothiazolinone and water, thereby obtaining the development accelerator-1 dispersion. The development accelerator particles contained in the development accelerator dispersion had a median diameter of 0.48 μm and a maximum particle diameter of 1.4 μm. The hydrogen bonding compound dispersion obtained was filtered with a polypropylene filter with a pore diameter of 3.0 μm to remove foreign substances such as dusts.

Solid dispersions of the development accelerator-2, development accelerator-3 and color controlling agent-1 were dispersed by the same method as in dispersing the development accelerator-1, obtaining 20% by mass dispersions.

(Preparation of polyhalogen compound)

<<Preparation of organic Polyhalogen Compound-1 Dispersion>>

A slurry was obtained by adding 14 kg of water with thorough stirring into 10 kg of the organic polyhalogen compound-1 (tribromomethanesulfonyl benzene), 10 kg of 20% by mass aqueous solution of modified polyvinyl alcohol (Poval MP203 made by Kuraray Co., Ltd.) and 0.4 kg of 20% by mass aqueous solution of sodium triisopropyl naphthalene sulfonate. The slurry was sent with a diaphragm pump and, after dispersing for 5 hours using a horizontal sand mill (UVM-2 made by Imex Co.) filled with zirconia beads with an average diameter of 0.5 mm, the concentration of the organic polyhalogen compound was adjusted to 26% by mass by adding 0.2 g of sodium benzoisothiazolinone and water, thereby obtaining the organic polyhalogen compound-1 dispersion. The organic polyhalogen compound particles contained in the organic polyhalogen compound dispersion had a median diameter of 0.41 μm and a maximum particle diameter of 2.0 μm. The organic polyhalogen compound dispersion obtained was filtered with a polypropylene filter with a pore diameter of 10.0 μm to remove foreign substances such as dusts.

<<Preparation of Organic Polyhalogen Compound-2 Dispersion>>

A slurry was obtained by adding with trough mixing 10 kg of the organic polyhalogen compound-2 (N-butyl-3-tribromomethanesulfonyl benzamide), 20 kg of 10% by mass aqueous solution of modified polyvinyl alcohol (Poval MP203 made by Kuraray Co., Ltd.) and 0.4 kg of 20% by mass aqueous solution of sodium triisopropyl naphthalene sulfonate. The slurry was sent with a diaphragm pump and, after dispersing for 5 hours using a horizontal sand mill (UVM-2 made by Imex Co.) filled with zirconia beads with an average diameter of 0.5 mm, the concentration of the organic polyhalogen compound was adjusted to 30% by mass by adding 0.2 g of sodium benzoisothiazolinone and water. The dispersion solution was warmed at 40° C. for 5 hours, thereby obtaining the organic polyhalogen compound-2 dispersion. The organic polyhalogen compound particles contained in the organic polyhalogen compound dispersion had a median diameter of 0.40 μm and a maximum particle diameter of 1.3 μm. The organic polyhalogen compound dispersion obtained was filtered with a polypropylene filter with a pore diameter of 3.0 μm to remove foreign substances such as dusts.

<<Preparation of Phthalazine Compound-1 Solution>>

Dissolved into 174.57 kg of water was 8 kg of modified polyvinyl alcohol (MP203 made by Kuraray Co., Ltd.), followed by adding 3.15 kg of 20% by mass aqueous solution of sodium triisopropyl naphthalene sulfonate and 14.28 kg of 70% by mass aqueous solution of phthalazine compound-1 (6-isopropyl phthalazine), thereby preparing 5% by mass aqueous solution of the phthalazine compound-1.

(Preparation of Mercapto Compound)

<<Preparation of Aqueous Mercapto Compound-1 Solution)>>

A 0.7% by mass aqueous solution was prepared by dissolving 7 g of the mercapto compopund-1 (sodium 1-(3-sulfophenyl)-5-mercaptotetrazole) in 993 g of water.

<<Preparation of Aqueous Mercapto Compound-2 Solution>>

A 2.0% by mass aqueous solution was prepared by dissolving 20 g of the mercapto compopund-2 (sodium 1-(3-methylureide)-5-mercaptotetrazole) in 980 g of water.

<<Preparation of Pigment-1 Dispersion>>

A slurry was prepared by adding with thorough mixing 64 g of C. I. Pigment blue 60, 6.4 g of Demol N (made by Kao Corporation) and 250 g of water. The mixture was placed in a vessel together with 800 g of zirconia beads with an average diameter of 0.5 mm, and dispersed for 25 hours in a dispersing apparatus (¼G sand grinder mill made by Imex Co.) to obtain the pigment-1 dispersion. The pigment particles contained in the pigment-1 dispersion thus obtained had an average particle diameter of 0.21 μm.

<<Preparation of SBR Latex Solution>>

SBR latex with Tg of 22° C. was prepared as follows.

After emulsion polymerization of 70.0% by mass of styrene, 27.0% by mass of butadiene and 3.0% by mass of acrylic acid using ammonium persulfate as a polymerization initiator and an anionic surfactant as a emulsifying agent, the product was aged at 80° C. for 8 hours. The product was cooled to 40° C. thereafter, pH was adjusted to 7.0 with aqueous ammonia, and Sundet BL (made by Sanyo Chemical Industries Ltd.) was added to a proportion of 0.22%. Then, pH was adjusted to 8.3 by adding 5% aqueous sodium hydroxide solution with additional pH adjustment to 8.4 with aqueous ammonia. The molar ratio between the Na⁺ ion and NH₄⁺ ion used was 1:2.3. Subsequently, 0.15 ml of 7% aqueous solution of sodium benzoisothiazolinone was added to 1 kg of the solution, thereby preparing the SBR latex solution. (SBR latex: -St(70.0)-Bu(27.0)-AA(3.0) latex)

Tg−22° C.; average particle diameter−0.1 μm; equilibrium moisture content at 25° C. and 60% RH−0.6% by mass; ionic conductivity−4.2 mS/cm (the ionic conductance of the neat latex solution (43% by mass) was measured at 25° C. using a conductivity meter CM-30S made by DKK-TOA Corporation); pH 8.4

The SBR latex having a different proportion of styrene and butadiene may be prepared by the same method by appropriately changing the proportion.

<<Preparation of Emulsion Layer (Photosensitive Layer) Application Fluid-1>>

Sequentially added were 1000 g of the fatty acid silver salt dispersion obtained above, 276 ml of water, 33.2 g of the pigment-1 dispersion, 21 g of the organic polyhalogen compound-1 dispersion, 58 g of the organic polyhalogen compound-2 dispersion, 173 g of the phthalazine compound-1 dispersion, 1082 g of the SBR latex (Tg 22° C.) solution, 299 g of the reducing agent-1 dispersion, 6 g of the development acceleratore-1 dispersion, 9 ml of the mercapto compound-1 solution and 27 ml of the mercapto compound-2 solution. The emulsion layer application fluid prepared by adding 117 g of the silver halide mixed emulsion A immediately before application with thorough stirring was directly sent to a coating die for application.

The viscosity of the emulsion layer application fluid was measured with a B-type viscometer made by Tokyo Instrument Co., obtaining a viscosity of 25 mPa's at 40° C. (No. 1 rotor, 60 rpm).

The viscosity of the application fluid measured at 25° C. using RFS Fluid Spectrometer made by Rheometrix Far-East Co., was 230, 60, 46, 24 and 20 (mPa·s) at shear speed of 0.1, 1, 10. 100 and 1000 (1/sec), respectively.

The content of zirconium per 1 g of silver in the application fluid was 0.38 mg.

<<Preparation of Emulsion Layer (Photosensitive Layer) Application Fluid-2>>

Sequentially added were 1000 g of the fatty acid silver salt dispersion obtained above, 276 ml of water, 32.8 g of the pigment-1 dispersion, 21 g of the organic polyhalogen compound-1 dispersion, 58 g of the organic polyhalogen compound-2 dispersion, 173 g of the phthalazine compound-1 dispersion, 1082 g of the SBR latex (Tg 20° C.) solution, 155 g of the reducing agent-2 dispersion, 55 g of the hydrogen bonding compound-1 dispersion, 6 g of the development acceleratore-1 dispersion, 2 g of the development accelerator-2 dispersion, 3 g of the development accelerator-3 dispersion, 2 g of the color control agent-1 dispersion and 6 ml of the aqueous mercapto compound-2 solution. The emulsion layer application fluid prepared by adding 117 g of the silver halide mixed emulsion A immediately before application with thorough stirring was directly sent to a coating die for application.

The viscosity of the emulsion layer application fluid was measured with a B-type viscometer made by Tokyo Instrument Co., obtaining a viscosity of 40 mPa's at 40° C. (No. 1 rotor, 60 rpm).

The viscosity of the application fluid measured at 25° C. using RFS Fluid Spectrometer made by Rheometrix Far-East Co., was 530, 144, 96, 51 and 28 (mPa·s) at shear speed of 0.1, 1, 10. 100 and 1000 (1/sec), respectively.

The content of zirconium per 1 g of silver in the application fluid was 0.25 mg.

<<Preparation of Application Fluid of Emulsion Face Intermediate Layer>>

Added into 1000 g of polyvinyl alcohol PVA-205 (made by Kuraray Co.), 272 g of 5% by mass dispersion of a pigment, and 4200 ml of 19% by mass solution of methyl methacrylate/styrene/butyl acrylate/hydroxyethyl methacrylate/acrylic acid copolymer latex (copolymerization ratio 64/9/20/5/2) were 27 ml of 5% by mass aqueous solution of aerosol OT (made by American Cyanamid Co.) and 135 ml of 20% by mass aqueous solution of diammonium phthalate with addition of water to a total weight of 10000 g. The solution was adjusted to pH 7.5 with NaOH, and was sent to a coating die at an area density of 9.1 ml/m².

The viscosity of the application fluid was 58 mPa·s at 40° C. as measured with a B-type viscometer (No. 1 rotor, 60 rpm).

<<Preparation of Application Fluid of Emulsion Face Protective First Layer>>

Dissolved was 64 g of inert gelatin, and 80 g of 27.5% by mass solution of methyl methacrylate/styrene/butyl acrylate/hydroxyethyl methacrylate/acrylic acid copolymer latex (copolymerization ratio 64/9/20/5/2), 23 ml of 10% by mass methanol solution of phthalic acid, 23 ml of 10% by mass aqueous solution of 4-methyl phthalic acid, 28 ml of 0.5 mol/L sulfuric acid, 5 ml of 5% by mass of aqueous solution of aerosol OT (made by American Cyanamid Co.), 0.5 g of phenoxy ethanol and 0.1 g of benzoisothiazolinone were added with addition of water to a total weight of 750 g. A solution of 4% by mass of chromium alum (26 ml) was added and mixed with a static mixer immediately before application, and this solution was sent to a coating die in a area density of 18.6 ml/m².

The viscosity of the application fluid was 20 mPa·s at 40° C. as measured with a B-type viscometer (No. 1 rotor, 60 rpm).

<<Preparation of Application Fluid of Emulsion Face Protective Second Layer>>

Dissolved was 80 g of inert gelatin, and 102 g of 27.5% by mass solution of methyl methacrylate/styrene/butyl acrylate/hydroxyethyl methacrylate/acrylic acid copolymer latex (copolymerization ratio 64/9/20/5/2), 3.2 ml of 5% by mass solution of the fluorine based surfactant (F-1: N-perfluorooctylsulfonyl-N-propylalanine potassium salt), 32 ml of 2% by mass solution of the fluorine based surfactant (F-2: polyethyleneglycol mono(N-perfluorooctylsulfonyl-N-propyl-2-aminoethyl)ether [mean degree of polymerization of ethylene oxide=15]), 23 ml of 5% by mass of aqueous solution of aerosol OT (made by American Cyanamid Co.), 4 g of polymethyl methacrylate fine particles (average particle diameter 0.7 μm), 21 g of polymethyl methacrylate fine particles (average particle diameter 4.5 μm), 1.6 g of 4-methyl phthalic acid, 4.8 g of phthalic acid, 44 ml of 0.5 mol/L sulfuric acid, and 10 mg of benzoisothiazolinone were added with addition of water to a total weight of 650 g. An aqueous solution (455 ml) containing 4% by mass of chromium alum and 0.67% by mass of phthalic acid were added and mixed with a static mixer immediately before application, and this solution was sent to a coating die in a area density of 8.3 ml/m².

The viscosity of the application fluid was 19 mPa·s at 40° C. as measured with a B-type viscometer (No. 1 rotor, 60 rpm).

<<Preparation of Heat Developable Photosensitive Materials 1A to 1J>>

Simultaneously applied were the anti-halation layer application fluid and application fluid of the back face protective layer on the back face side of the undercoat substrate, so that the amounts of application of gelatin become 0.44 g/m² and 1.7 g/m², respectively. The application layers were dried to from the back layers.

The emulsion layer, intermediate layer, protective first layer and protective second layer were simultaneously coated in this order by a slide beads application method to form the samples of the heat developable photosensitive materials. The temperatures were adjusted at 31° C. for the emulsion layer and intermediate layer, at 36° C. for the protective first layer, and at 37° C. for the protective second layer.

The amount of application (g/m²) of each compound in the emulsion layer was as follows:

| | |
|---|---|
| organic acid silvers A-J (as Ag) | 1.34 |
| pigment (C. I. Pigment Blue 60) | 0.036 |
| polyhalogen compound-1 | 0.12 |
| polyhalogen compound-2 | 0.37 |
| phthalazine compound-1 | 0.19 |
| SBR latex | 9.67 |
| reducing agent complex-1 | 1.41 |
| development accelerator-1 | 0.024 |
| mercapto compound-1 | 0.002 |
| mercapto compound-2 | 0.012 |
| silver halide (as Ag) | 0.091 |

The application and drying conditions are as follows:

The application speed was 160 m/min; the space between the tip of the coating die and the substrate was 0.10 to 0.30 mm; and the pressure of the vacuum chamber was set 196 to 882 Pa lower than the atmospheric pressure. Electrification of the substrate was removed by ion blowing before application.

The application fluid on the substrate was cooled with an air flow at a dry bulb temperature of 10 to 20° C. in the chilling zone. The substrate was transferred by non-contact convey method, dried in a coil type non-contact drying chamber, and was dried with a dry air flow at a dry bulb temperature of 23 to 45° C. and wet bulb temperature of 15 to 21° C.

After drying and humidity control at 40 to 60% RH, the surface of the substrate was heated at 70 to 90° C., followed by cooling the surface of the substrate at 25° C.

The degree of matting of the heat developable image recording material prepared was 550 second and 130 second for the photosensitive layer side and back face side, respectively, as Beck smoothness. The pH value of the film surface at the photosensitive layer side was 6.0.

<<Preparation of Heat Developable Photosensitive Material 2A to 2J>>

The heat developable photosensitive material-2 was prepared by the same method as preparing the heat developable photosensitive material-1, except that the emulsion layer application fluid-1 was changed to the emulsion layer application fluid-2, the yellow dye compound-1 was eliminated from the halation preventive layer, and the fluorine based surfactants on the back face protective layer and emulsion face protective layer were changed from F-1, F-2, F-3 and F-4 to F-5, F-6, F-7 and F-8.

The amount of application (g/m²) of each compound in the emulsion layer was as follows:

| | |
|---|---|
| organic acid silvers A-J (as Ag) | 1.34 |
| pigment (C. I. Pigment Blue 60) | 0.036 |
| polyhalogen compound-1 | 0.12 |
| polyhalogen compound-2 | 0.37 |
| phthalazine compound-1 | 0.19 |
| SBR latex | 9.67 |
| reducing agent-2 | 0.81 |
| hydrogen bonding compound-1 | 0.30 |
| development accelerator-1 | 0.024 |
| development accelerator-2 | 0.010 |
| development accelerator-3 | 0.015 |
| color controlling agent-1 | 0.010 |
| mercapto compound-2 | 0.002 |
| silver halide (as Ag) | 0.091 |

The chemical structures of the compounds used in the examples of the invention in the third aspect are shown below:

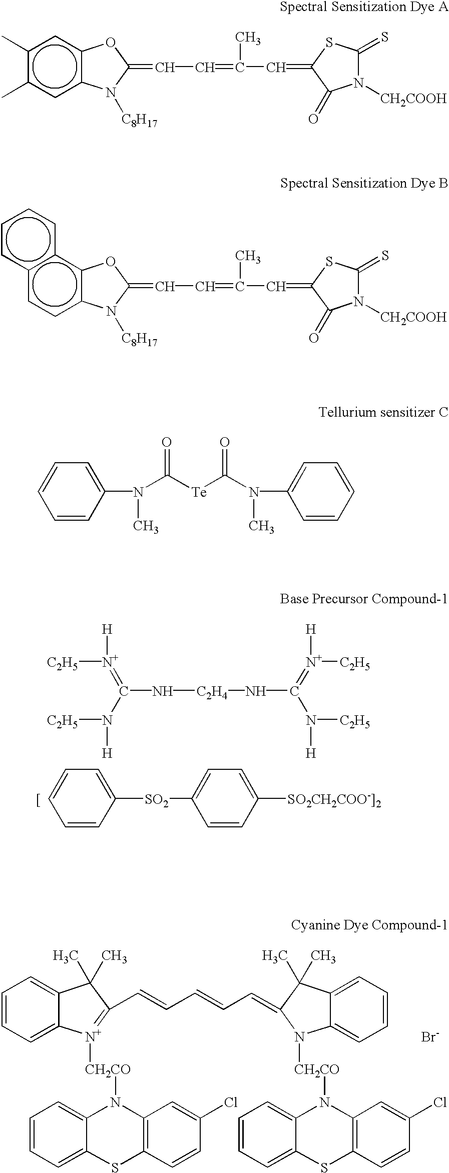

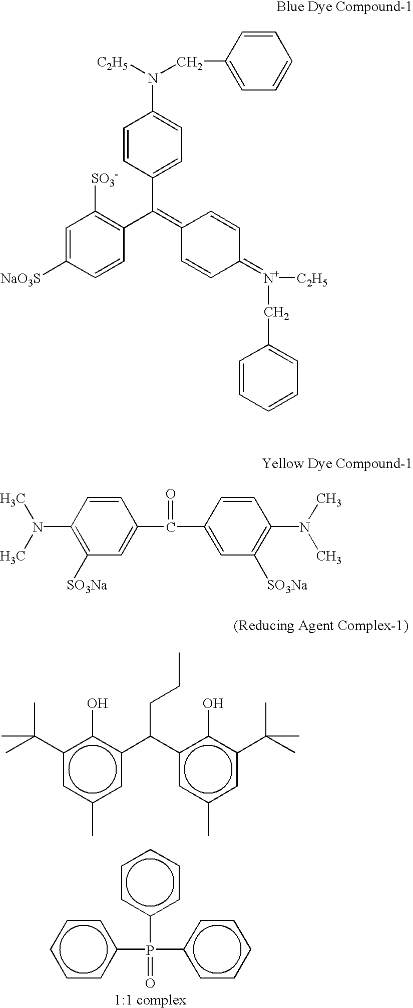

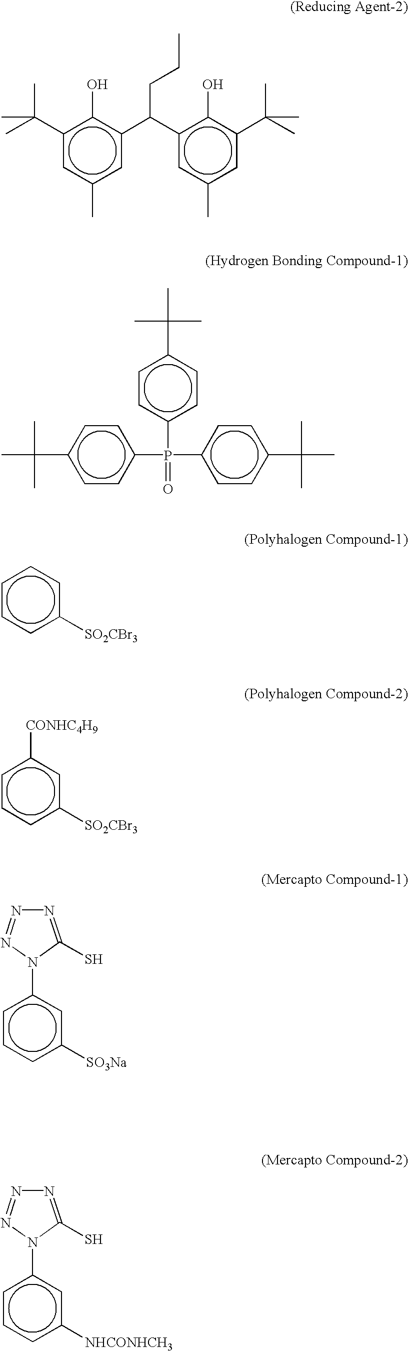

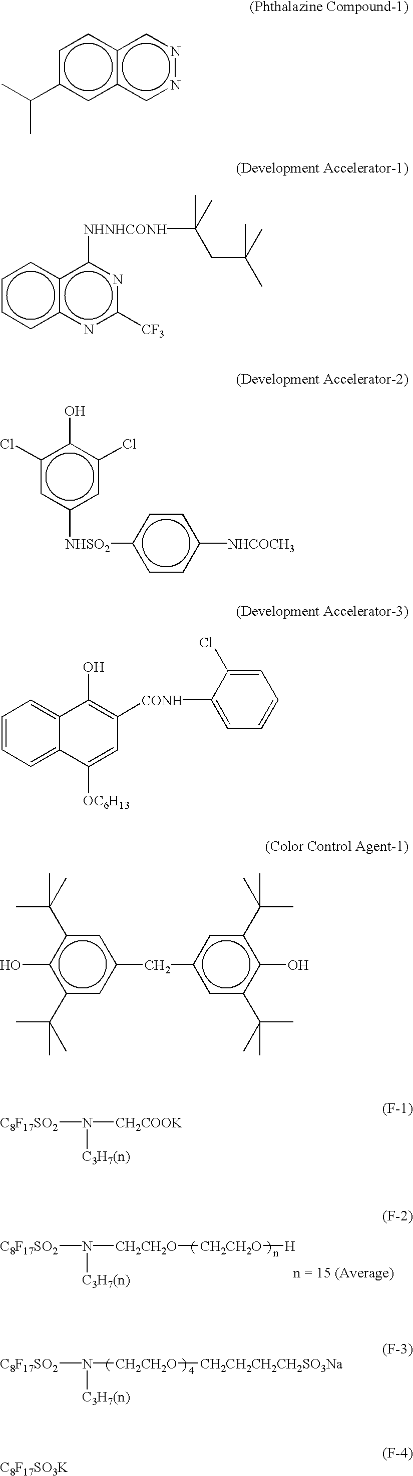

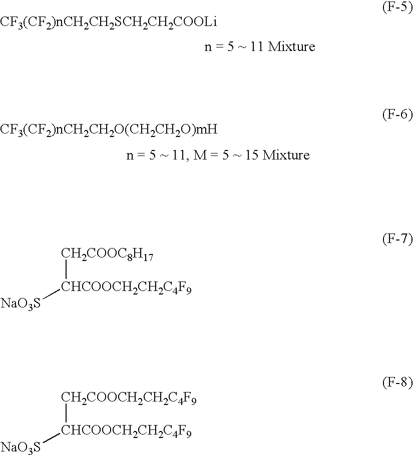

(Evaluation of Photographic Performance)

The samples obtained were cut into a half-size, and packaged in the following package material under an environment of 25° C. and 50% RH. The samples were evaluated as follows after preservation at room temperature for two weeks.

(Package Material)

PET 10 μm/PE 12 μm/aluminum foil 9 μm/polyethylene containing 3% carbon 50 μm; oxygen permeability: 0.02 ml/atm·m²·25° C.·day; moisture permeability 0.10 g/atm·m²·25° C.·day

The heat developable image recording materials were exposed and heat-developed (using four panel heaters with a hating program of 112° C., 119° C., 121° C., and 121° C. for 24 seconds in total for the heat developable photosensitive material-1, 14 seconds in total for the heat developable photosensitive material-2) using Fuji Medical Dry laser Imager FM-DP L (equipped with a semiconductor laser with a maximum output energy 60 mw (IIIB)). The images obtained was evaluated with a densitometer. The sensitivity is indicated by relative values by taking the sensitivity of the heat developable photosensitive material 1D as 100.

(Evaluation of Image Preservative Property 1)

The heat developable dried material after development was hung for 8 hours on a hanger illuminated with a light of a luminance of 1000 Lux in an environment of 25° C. and 60% RH. The photographic property was evaluated by changes of Dₘᵢₙ thereafter measured by a densitometer. No change of the image density was evaluated as 100, and a change of doubled density was evaluated as 200. The results are shown in Table 14.

(Evaluation of Image Preservative Property 2)

The heat developable dried material after development was hung for 10 minutes on a hanger illuminated with a light of a luminance of 1000 Lux in an environment of 25° C. and 60% RH, was sealed in a moisture proof-light shielding bag, and allowed to stand still for 3 days at 60° C. The photographic property was evaluated by changes of Dₘᵢₙ thereafter measured by a densitometer. The image was evaluated by the rate of change before hanging on the hunger and after standing for three days. No change of the image was evaluated as 100, and a change of doubled density was evaluated as 200. The results are shown in Table 14.

TABLE 12

| Organic acid | | | | | | | |
|---|---|---|---|---|---|---|---|
| silver | Stearic acid | Arachidic acid | Behenic acid | Lignoceric acid | Erucic acid | Erucic acid/behenic acid | |
| A | 0 | 0 | 98 | 2 | Less than | Less than | Comparative |
| | | | | | 0.000001 | 0.000001 | example |
| B | 0 | 0 | 98 | 2 | 0.00002 | 0.000020 | Example |
| C | 0 | 0 | 98 | 2 | 0.002 | 0.002041 | Example |
| D | 0 | 0 | 97.99 | 2 | 001 | 0.010205 | Example |
| E | 0 | 0 | 97.7 | 2 | 0.3 | 0.307062 | Example |
| F | 0 | 0 | 97.5 | 2 | 0.5 | 0.512821 | Comparative |
| | | | | | | | example |
| G | 0 | 0 | 99.99 | 0 | 0.01 | 0.010001 | Example |
| H | 20 | 31 | 47.99 | 1 | 0.01 | 0.020838 | Example |
| I | 15 | 23 | 60.49 | 1.5 | 0.01 | 0.016532 | Example |
| J | 1 | 5 | 91.99 | 2 | 0.01 | 0.010871 | Example |

Erucic acid used was made by Tokyo Kasei Kogyo Co., Ltd.

TABLE 13

| | | | | Equivalent- | |
|---|---|---|---|---|---|
| | | | | circle | Size |
| Organic acid | | | | diameter | variation |
| silver | a (μm) | b (μm) | c (μm) | (μm) | coefficient (%) |
| A | 0.25 | 0.6 | 0.7 | 0.54 | 10 |
| B | 0.25 | 0.6 | 0.7 | 0.54 | 10 |
| C | 0.26 | 0.6 | 0.7 | 0.54 | 11 |
| D | 0.26 | 0.6 | 0.7 | 0.54 | 11 |
| E | 0.27 | 0.59 | 0.7 | 0.54 | 11 |
| F | 0.28 | 0.58 | 0.69 | 0.55 | 12 |
| G | 0.28 | 0.62 | 0.65 | 0.52 | 8 |
| H | 0.1 | 0.12 | 2.3 | 0.6 | 25 |
| I | 0.15 | 0.2 | 1.6 | 0.58 | 21 |
| J | 0.19 | 0.4 | 0.9 | 0.5 | 15 |

TABLE 14

| | | Image preservative | Image preservative |
|---|---|---|---|
| Photo- | | property 1 | property 2 |
| sensitive | | Rate of change | Rate of change |
| material | Sensitivity | of Dₘᵢₙ (%) | of Dₘᵢₙ (%) |
| 1A | 65 | 102 | 103 |
| 1B | 93 | 102 | 103 |
| 1C | 98 | 102 | 103 |
| 1D | 100 | 102 | 103 |
| 1E | 104 | 103 | 105 |
| 1F | 107 | 125 | 243 |
| 1G | 99 | 100 | 100 |
| 1H | 110 | 110 | 129 |
| 1I | 107 | 107 | 117 |
| 1J | 104 | 103 | 104 |
| 2A | 91 | 105 | 104 |
| 2B | 98 | 105 | 104 |
| 2C | 103 | 105 | 104 |
| 2D | 105 | 105 | 104 |
| 2E | 109 | 107 | 105 |
| 2F | 112 | 140 | 268 |
| 2G | 104 | 102 | 102 |
| 2H | 116 | 115 | 136 |
| 2I | 112 | 110 | 122 |
| 2J | 109 | 105 | 106 |

Sensitivity was relatively evaluated by taking 1D as 100.

The values of “a”, “b” and “c” were defined in the order of the shorter edge length when the shape of the lepidoblastic organic acid silver salt particle is approximated by a parallelepiped under an electron microscope.

The equivalent-circle diameter as well as the size variation coefficient were measured using a diffraction particle size analyzer “SALD-2000J” made by Shimadzu Co.

The results shown in Table 14 clearly shows that a heat developable photosensitive material compatible both in sensitivity and image preservative property can be obtained by using a proper amount of erucic acid.

Accordingly, the invention provides a heat developable photosensitive material with small increase of fog by heat and light after development while requiring no cautions against light and heat in handling.

What is claimed is:

1. A heat developable image recording material comprising a photosensitive silver halide, a reducing agent for silver ions, a binder and non-photosensitive organic silver salt particles on one side of the surface of a substrate, wherein a content of silver behenate in the non-photosensitive organic silver salt particles is 90 mol % to 100 mol %, and at least one kind of mercapto compound is contained in the surface of the substrate at the same side as a layer having the photosensitive silver halide.

2. The heat developable image recording material according to claim 1, wherein at least one kind of the mercapto compound is contained in the layer containing photosensitive silver halide.

3. The heat developable image recording material according to claim 1, wherein the at least one kind of mercapto compound is represented by the following general formula (1): 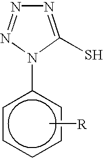
wherein, in the general formula (1), R represents a hydrogen atom, an alkyl group, an aralkyl group, an alkoxy group, an alkyl- or aryl-substituted amino group, an amide group, a sulfonamide group, a ureide group, a urethane group, an aryloxy group, a sulfamoyl group, a carbamoyl group, anaryl group, analkylthio group, an arylthio group, a hydroxyl group, an alkylcarbonyl group, a halogen atom, a cyano group or a phosphoramide group.

4. The heat developable image recording material according to claim 1, wherein the content of silver behenate in the non-photosensitive organic silver salt particles is 94 mol % to 100 mol %.

5. The heat developable image recording material according to claim 1, wherein the content of silver behenate in the non-photosensitive organic silver salt particles is 96 mol % to 100 mol %.

6. The heat developable image recording material according to claim 1, wherein a content of silver stearate in the non-photosensitive organic silver salt particles is 1 mol %.

7. The heat developable image recording material according to claim 1, wherein a content of silver arachidinate in the non-photosensitive organic silver salt particles is 6 mol %.

8. The heat developable image recording material according to claim 1, wherein the reducing agent for silver ions is represented by the following general formula (2): 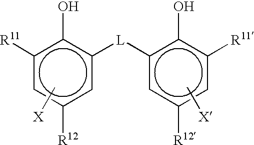
wherein, in the general formula (2), R¹¹ and R^{11′} each independently represent an alkyl group with a carbon number of 1 to 20; R¹² and R^{12′} each independently represent a hydrogen atom or a substituent capable of substituting to a benzene ring; L represents a —S— group or —CHR¹³— group; R¹³ represents a hydrogen atom or an alkyl group with a carbon number of 1 to 20; and X and X′ each independently represent a hydrogen atom or a substituent capable of substituting to a benzene ring.

9. The heat developable image recording material according to claim 1, wherein the non-photosensitive organic silver salt particles are prepared by adding a solution containing silver ions and a solution of an organic acid alkali metal salt or suspension thereof into sealed mixing means.

10. The heat developable image recording material according to claim 1, wherein the non-photosensitive organic silver salt particles are desalted by an ultrafiltration method.

11. A heat developable photosensitive material comprising a photosensitive silver halide, a reducing agent for silver ions, a binder and non-photosensitive organic silver salt particles on one side of the surface of a substrate, wherein a content of silver behenate in the non-photosensitive organic silver salt particles is 90 mol % to 100 mol %, the photosensitive material comprising a compound represented by the following general formula (3): 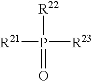
wherein, in the general formula (3), R²¹, R²² and R²³ each independently represent a substituted or non-substituted alkyl group, aryl group, alkoxy group, aryloxy group, amino group or heterocyclic group; and, when any of the substituent when any of R²¹, R²² and R²³ have a substituent, the substituent comprises a halogen atom, an alkyl group, an aryl group, an alkoxy group, an amino group, an acyl group, an acyloxy group, an alkylthio group, an arylthio group, a sulfonamide group, an acyloxy group, an oxycarbonyl group, a carbamoyl group, a sulfamoyl group, a sulfonyl group or a phosphoryl group.

12. The heat developable photosensitive material according to claim 11, wherein a content of silver stearate in the non-photosensitive organic silver salt particles is 1 mol %.

13. The heat developable photosensitive material according to claim 11, wherein a content of silver arachidate in the non-photosensitive organic silver salt particles is 6 mol %.

14. The heat developable photosensitive material according to claim 11, wherein a content of silver behenate is 95 mol % to 100 mol %.

15. The heat developable photosensitive material according to claim 11, wherein the content of silver behenate is 97 mol % to 100 mol %.

16. The heat developable photosensitive material according to claim 11, wherein the non-photosensitive organic silver salt particles are prepared at a reaction temperature of 60° C.

17. The heat developable photosensitive material according to claim 11, wherein the non-photosensitive organic silver salt particles are prepared by adding a silver nitrate solution, and a solution of an organic acid alkali metal salt or suspension thereof into a sealed mixing vessel.

18. The heat developable photosensitive material according to claim 11, wherein the non-photosensitive organic silver salt particles are desalted by an ultrafiltration method.

19. A heat developable photosensitive material comprising a photosensitive silver halide, a reducing agent for silver ions, a binder and non-photosensitive organic silver salt particles on one side of the surface of a substrate, wherein the non-photosensitive organic silver salt particles are prepared from organic acids including at least behenic acid and erucic acid, and a content of the erucic acid is 0.000001 mol % to 0.4 mol % relative to the behenic acid.

20. The heat developable photosensitive material according to claim 19, wherein the content of the erucic acid is 0.00001 mol % to 0.1 mol % relative to the behenic acid.

21. The heat developable photosensitive material according to claim 19, wherein a content of the behenic acid is 50 mol % to 99.99 mol % relative to the organic acids.

22. The heat developable photosensitive material according to claim 19, wherein a content of the behenic acid is 90 mol % to 99.99 mol % relative to the organic acids.

23. The heat developable photosensitive material according to claim 19, wherein a content of the behenic acid is 95 mol % to 99.99 mol % relative to the organic acids.

24. The heat developable photosensitive material according to claim 19, wherein an amount of silver contained in the heat developable photosensitive material is 0.1 g/m² to 5.0 g/m² as measured on the basis of amount of silver atoms.
